(19) United States
(12) Patent Application Publication
(10) Pub. No.: US 2016/0232614 A1
(43) Pub. Date: Aug. 11, 2016

(54) TARGET DATE ANALYZER SERVER SYSTEM AND METHOD

(71) Applicant: THE PRINCIPAL FINANCIAL GROUP, Des Moines, IA (US)

(72) Inventors: Jeff Vorwerk, Altoona, IA (US); Jeff Broders, Norwalk, IA (US); Jeff Tyler, Des Moines, IA (US)

(21) Appl. No.: 15/018,586

(22) Filed: Feb. 8, 2016

Related U.S. Application Data
(60) Provisional application No. 62/113,278, filed on Feb. 6, 2015.

(51) Int. Cl. G06Q 40/06

(52) U.S. Cl. CPC G06Q 40/06

(57) ABSTRACT

Some embodiments provide an investment plan analysis server system that delivers personalized content including an investment comparison derived from a provider device and delivered to a local or consumer device. Information can be retrieved from a user using a wireless or wired communication interface that can include a client's asset range and participant profile, participant demographics, participant's average savings balance, tolerance for risk, manager diversification, and/or active or passive investment preference. Additional information can be similarly received and processed by a target date analysis server that includes a retirement glide path type, retirement glide path risk, manager diversification, fund performance, investment vehicle type, share class or investment return rate, active or passive investment preference, investment product history, investment product vintage. Based on the second plurality of information, a third plurality of information can be processed and displayed as personalized content using financial data from a remote server system.

### RELATED APPLICATIONS

This application claims priority from U.S. Provisional Application No. 62/113,278, filed on Feb. 6, 2015, the entire contents of which are incorporated herein by reference.

### BACKGROUND

As retirement plan participants approach retirement, their goals change from saving to protecting their savings and creating income to last throughout retirement. With longevities rising overall, combined with low levels of retirement savings, many plan participants are searching for financial options that provide equity-like gains in the years before retirement, and automated or managed transitions to less volatile, income-producing investments during their years of retirement.

Target date type funds are an investment product based on a defined investment strategy and asset allocation that changes over time based on a pre-determined investment horizon. Their popularity has grown over the past ten years, resulting in most large financial institutions providing a menu of different target date funds with different investment strategies and time horizons. As a result, the process of fund selection and analysis from the large pool of potential target date investment options remains a challenge. Investment professionals generally do not have access to investment tools that enable targeted selection and analysis of the underlying investment performance, risk, and holdings of target date funds. Consequently, the analysis of multiple funds and portfolios of funds with differing investment strategies comparing performance parameters of bundles of target date investments is generally not feasible using these systems.

### SUMMARY

Some embodiments of the invention include an investment plan analysis server system comprising a computing device comprising at least one processor, and a non-transitory computer readable medium, having stored thereon, instructions that when executed by the computing device, cause the computing device to perform at least some operations within a local or consumer device. The operations comprising at least associating the local or consumer device with a provider device, and execution of a browser program to deliver personalized content within a website rendered on the local or consumer device. The personalized content comprises at least one investment comparison derived at least in part from information from the provider device for use in the investment plan. The operations include receiving at least a first selection input from a user through the local or consumer device. The operations also include enabling a first retrieval of at least a portion of a first plurality of information using at least one of a wireless communication interface and a wired communication interface. The first plurality of information comprises a client's asset range and participant profile, participant demographics, participant's average savings balance, tolerance for risk, manager diversification, and/or active or passive investment preference. Further, the operations include creating the personalized content by processing at least a portion of the first plurality of information by a processor to form a target date profile, where at least a portion of the target date profile is displayed as the personalized content on the local or consumer device. The operations also include receiving at least a second selection input from a user through the local or consumer device. Further, based at least in part on the second selection, the operations include enabling a second retrieval of at least a portion of a second plurality of information using at least one of a wireless communication interface and a wired communication interface. The second plurality of information comprises at least one of a retirement glide path type, retirement glide path risk, manager diversification, fund performance, investment vehicle type, share class or investment return rate, active or passive investment preference, investment product history, and/or investment product vintage. The operations also include causing a target date analysis server to perform a target date analysis by processing of at least a portion of the second plurality of information by a processor. The operations also include causing the target date analysis server to process and calculate a third plurality of information by at least in part retrieving financial data from a remote server system based at least in part on at least a portion of the second plurality of information. The operations also include displaying the personalized content by processing at least a portion of the third plurality of information by a processor based at least in part on a user's interaction with the website through the local or consumer device.

In some embodiments of the invention, at least a portion of the second plurality of information includes the first plurality of information. In some embodiments, the personalized content includes at least one investment or investment plan structured or defined by a specified target date.

In some embodiments, the displayed personalized content includes a display including at least one user-selectable or user-removeable investment option. In some embodiments, the at least one user-selectable investment option includes at least one investment or investment plan structured or defined by a specified retirement target date.

In some further embodiments of the invention, at least a portion of the second plurality of information comprises at least one plan name. In some other embodiments, the at least one plan name is configured and arranged to be defined or selected as a favorite plan. Further, some embodiments include at least one plan name or favorite plan that is displayed or selectable from a user dashboard.

In some embodiments of the invention, the user's interaction comprises a selection of a report option, and the personalized content is configured and displayed as a report including at least one asset comparison analysis, the at least one asset comparison analysis comprising at least one of a data chart and a data table.

In some embodiments, the personalized content includes data displayed as a retirement glide path. In some further embodiments, the retirement glide path comprises an equity to fixed-income investment glide path. In some embodiments, the personalized content comprises at least one asset comparison analysis, where the at least one asset comparison analysis comprises a data chart and/or a data table.

In some embodiments, the at least one asset comparison analysis comprises an asset return and risk analysis as a function of time period, where the time period extends to at least one of a three year or a five year period. In some further embodiments, the at least one asset comparison analysis comprises a standard deviation risk analysis as a function of time period, where the time period extends to a three year or a five year period. In some other embodiments, the at least one asset comparison analysis comprises a Sharpe Ratio risk analysis as a function of time period, where the time period extends to a three year or a five year period.

Some embodiments include at least one asset comparison analysis that comprises a total risk to percentage equity analysis. In some further embodiments, the at least one asset comparison comprises an up/down capture of investment return. In other embodiments, the at least one asset comparison comprises a performance summary of at least one investment vehicle. In some further embodiments, the at least one asset comparison comprises a summary of underlying investments of at least one investment vehicle and/or a display of the top ten holdings of at least one investment vehicle.

In some embodiments of the invention, the at least one asset comparison analysis comprises data from the remote server system comparing at least two different investment vehicles. In some other embodiments, the at least one asset comparison analysis comprises data from the remote server system that comprise investment vehicles from at least two different providers.

### DESCRIPTION OF THE DRAWINGS

FIG. 1 illustrates a process flow chart of a target date analyzer server system in accordance with at least one embodiment of the invention.

FIG. 2 shows an example of a welcome screen generated by the target date analyzer server system and method in accordance with some embodiments of the invention.

FIG. 3 shows an example of a dashboard screen generated by the target date analyzer server system and method in accordance with some embodiments of the invention.

FIG. 4 illustrates a create plan screen generated by the target date analyzer server system and method in accordance with some embodiments of the invention.

FIG. 5 illustrates an introduction screen for the target date profiler generated by the target date analyzer server system and method in accordance with some embodiments of the invention.

FIG. 6 illustrates a demographics screen for the target date profiler generated by the target date analyzer server system and method in accordance with some embodiments of the invention.

FIG. 7 illustrates a savings balance screen generated by the target date analyzer server system and method in accordance with some embodiments of the invention.

FIG. 8 illustrates an acceptable volatility screen generated by the target date analyzer server system and method in accordance with some embodiments of the invention.

FIG. 9 illustrates a manager diversification screen generated by the target date analyzer server system and method in accordance with some embodiments of the invention.

FIG. 10 illustrates an active/passive investment strategy screen generated by the target date analyzer server system and method in accordance with some embodiments of the invention.

FIG. 11 illustrates a summary access screen generated by the target date analyzer server system and method in accordance with some embodiments of the invention.

FIG. 12 illustrates an example page from a target date profiler presentation or handout generated by the target date analyzer server system and method in accordance with some embodiments of the invention.

FIG. 13 illustrates a status and proceed screen generated by the target date analyzer server system and method in accordance with some embodiments of the invention.

FIGS. 14, 15A-15D, and 16 illustrate examples of create plan screens generated by the target date analyzer server system and method in accordance with some embodiments of the invention.

FIGS. 17A-17H, and 18-21 illustrate examples of target date filter screens generated by the target date analyzer server system and method in accordance with some embodiments of the invention.

FIG. 22 illustrates a report creation screen generated by the target date analyzer server system and method in accordance with some embodiments of the invention.

FIG. 23 illustrates a report download screen generated by the target date analyzer server system and method in accordance with some embodiments of the invention.

FIG. 24 illustrates an example of a favorites selection screen generated by the target date analyzer server system and method in accordance with some embodiments of the invention.

FIG. 25 illustrates a distribution screen generated by the target date analyzer server system and method in accordance with some embodiments of the invention.

FIG. 26 illustrates an account settings screen generated by the target date analyzer server system and method in accordance with some embodiments of the invention.

FIG. 27 illustrates an asset class selection summary display generated by the target date analyzer server system and method in accordance with some embodiments of the invention.

FIGS. 28-31 illustrate asset class report screens generated by the target date analyzer server system in accordance with some embodiments of the invention.

FIG. 32 illustrates a glide path structure display generated by the target date analyzer server system and method in accordance with some embodiments of the invention.

FIG. 33 illustrates a target date series glide path comparison display screen generated by the target date analyzer server system and method in accordance with some embodiments of the invention.

FIG. 34 illustrates a portfolio construction and implementation screen generated by the target date analyzer server system and method in accordance with some embodiments of the invention.

FIG. 35 illustrates a manager diversification display screen generated by the target date analyzer server system and method in accordance with some embodiments of the invention.

FIG. 36 illustrates a three year performance display screen generated by the target date analyzer server system and method in accordance with some embodiments of the invention.

FIG. 37 illustrates a five year performance display screen generated by the target date analyzer server system and method in accordance with some embodiments of the invention.

FIGS. 38-41 show display screens generated by the target date analyzer server system and method illustrating return and risk data comparisons in accordance with some embodiments of the invention.

FIGS. 42-43 show display screens generated by the target date analyzer server system and method illustrating total risk data comparisons in accordance with some embodiments of the invention.

FIG. 44 illustrates a display screen generated by the target date analyzer server system and method showing plots of three year up/down capture of target date investments in accordance with some embodiments of the invention.

FIG. 45 illustrates a display screen generated by the target date analyzer server system and method showing a summary of three year up/down capture of target date investments in accordance with some embodiments of the invention.

FIG. 46 illustrates a display screen generated by the target date analyzer server system and method showing plots of five year up/down capture of target date investments in accordance with some embodiments of the invention.

FIG. 47 illustrates a display screen generated by the target date analyzer server system and method showing a summary of five year up/down capture of target date investments in accordance with some embodiments of the invention.

FIG. 48 illustrates a performance summary screen generated by the target date analyzer server system and method showing target date investments in accordance with some embodiments of the invention.

FIG. 49 illustrates an executive summary screen of target date investments generated by the target date analyzer server system and method in accordance with some embodiments of the invention.

FIGS. 50-51 illustrate examples of underlying investment performance and risk screens generated by the target date analyzer server system and method in accordance with some embodiments of the invention.

FIG. 52 illustrates an example of a holdings summary display screens generated by the target date analyzer server system and method for target date investments in accordance with some embodiments of the invention.

FIG. 53 illustrates an operations summary display screen generated by the target date analyzer server system and method in accordance with some embodiments of the invention.

FIG. 54 illustrates a computer system useful for performing operations of the target date analyzer system and method in accordance with some embodiments of the invention.

### DETAILED DESCRIPTION

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items. Unless specified or limited otherwise, the terms “mounted,” “connected,” “supported,” and “coupled” and variations thereof are used broadly and encompass both direct and indirect mountings, connections, supports, and couplings. Further, “connected” and “coupled” are not restricted to physical or mechanical connections or couplings.

The following discussion is presented to enable a person skilled in the art to make and use embodiments of the invention. Various modifications to the illustrated embodiments will be readily apparent to those skilled in the art, and the generic principles herein can be applied to other embodiments and applications without departing from embodiments of the invention. Thus, embodiments of the invention are not intended to be limited to embodiments shown, but are to be accorded the widest scope consistent with the principles and features disclosed herein. The following detailed description is to be read with reference to the figures, in which like elements in different figures have like reference numerals. The figures, which are not necessarily to scale, depict selected embodiments and are not intended to limit the scope of embodiments of the invention. Skilled artisans will recognize the examples provided herein have many useful alternatives and fall within the scope of embodiments of the invention.

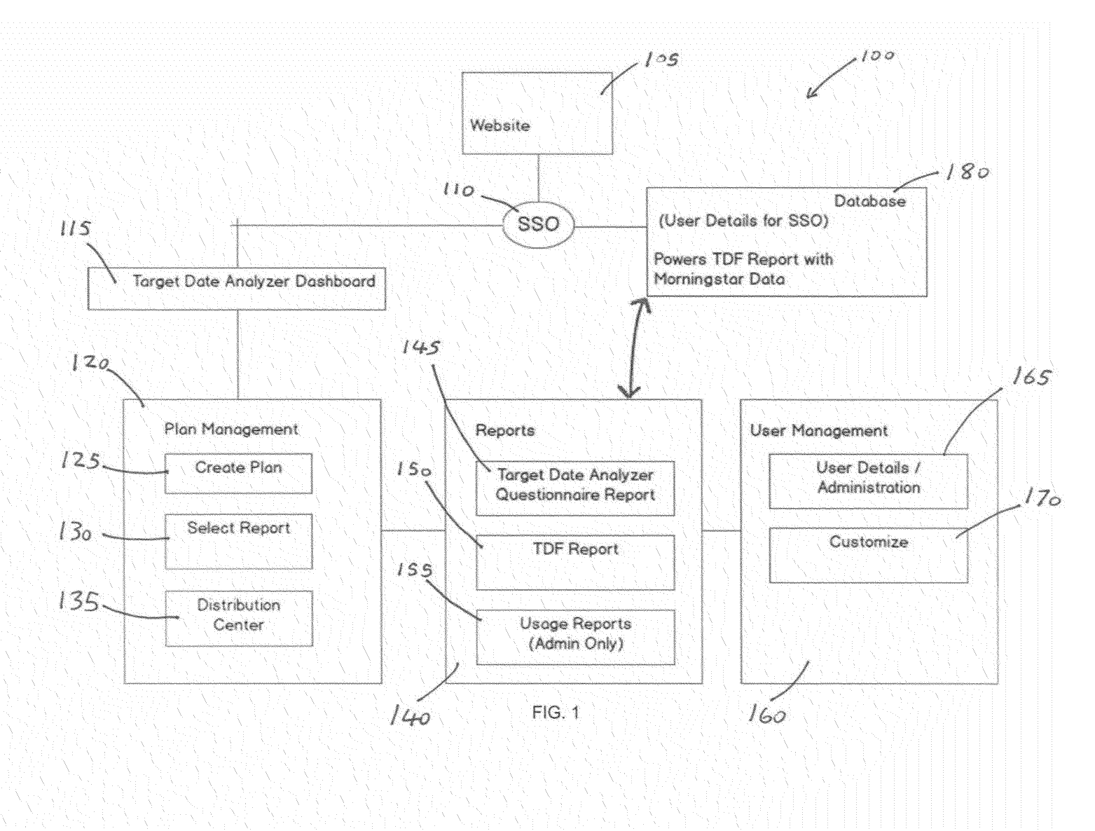

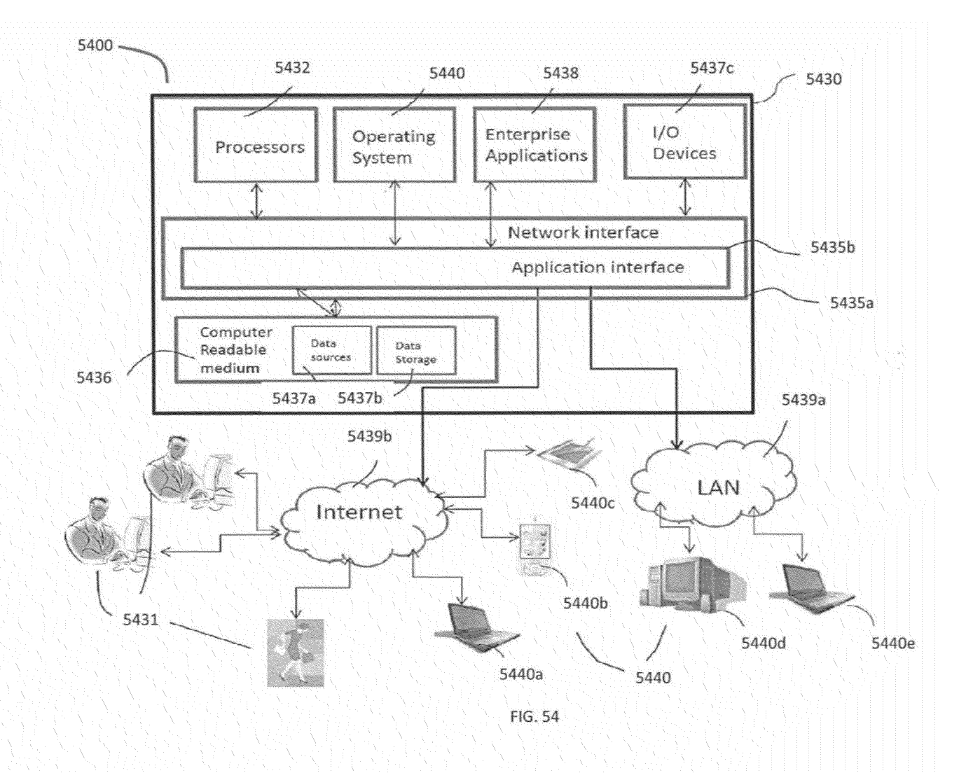

FIG. 1 illustrates a process flow chart 100 of a target date analyzer server system according to one embodiment of the invention. In some embodiments, a user, such as a financial planner or other certified financial professional operating on behalf of a client or prospective client can log into one or more server-operated target date analyzer system through a website 105 or other conventional electronic portal to perform investment research and analysis, perform investment plan management, create investment plans, create plan reports, or perform administrative and/or account updates. As used herein, the term “client” or “clients” can be defined as one or more actual clients (i.e., at least one existing client or plan participant) or at least one prospective client (i.e., at least one potential future client or plan participant.) Further, the client can be any entity, person, or company representing one or more individuals with current or future investable assets. The target date analyzer server system and method can include various modules performing methods to enable the user to create, plan, analyze and report financial data related to target date type investments and investible assets that may interest the client. These target date analyzer server system modules can be accessible through one or more dashboard graphical user interface (hereinafter “GUI”) displays or display screens on a local or consumer device generated by the website 105, and processed using one or more computer systems (e.g., such as computer system 5400 illustrated in FIG. 54).

In some embodiments, the user can log into the target date analyzer server system and method using a single sign-on (“SSO”) connectivity module 110. Once logged in, the user can proceed to a dashboard 115 to begin the process of planning, reporting, and performing administrative functions, or the user access user details through a server database 180. In some embodiments, the target date analyzer server system and method can include plan management module 120, and/or a report module 140, and/or a user management module 160. Any of the modules 120, 140, 160 can perform calculations and store results in non-transitory computer readable media using the computer system 5400. Further, target date plan reports can be created and reports prepared and distributed to a user's local or consumer device based on one or more user-entered variables or selections. For example, in some embodiments, the plan management module 120 can comprise a create plan module 125, select report module 130, and a distribution center module 135. These modules can facilitate the creation, report preparation, and distribution of investment plans to a user. In some embodiments, a reports module 140 can process a target date analyzer and questionnaire report 145, a TDF report 150, and a usage reports for administrative users (shown as 155). Further, a user management module 160 can include user details/administration 165, and various customization modules 170. In some embodiments, using the reports module 140, the user can use the target date analyzer server system and method to prepare target dated investment analysis reports on behalf of a client or prospective client. In some embodiments, using the user management module 160, the user can administer various activities and functions of the target date analyzer and/or customize at least portions of the target date analyzer.

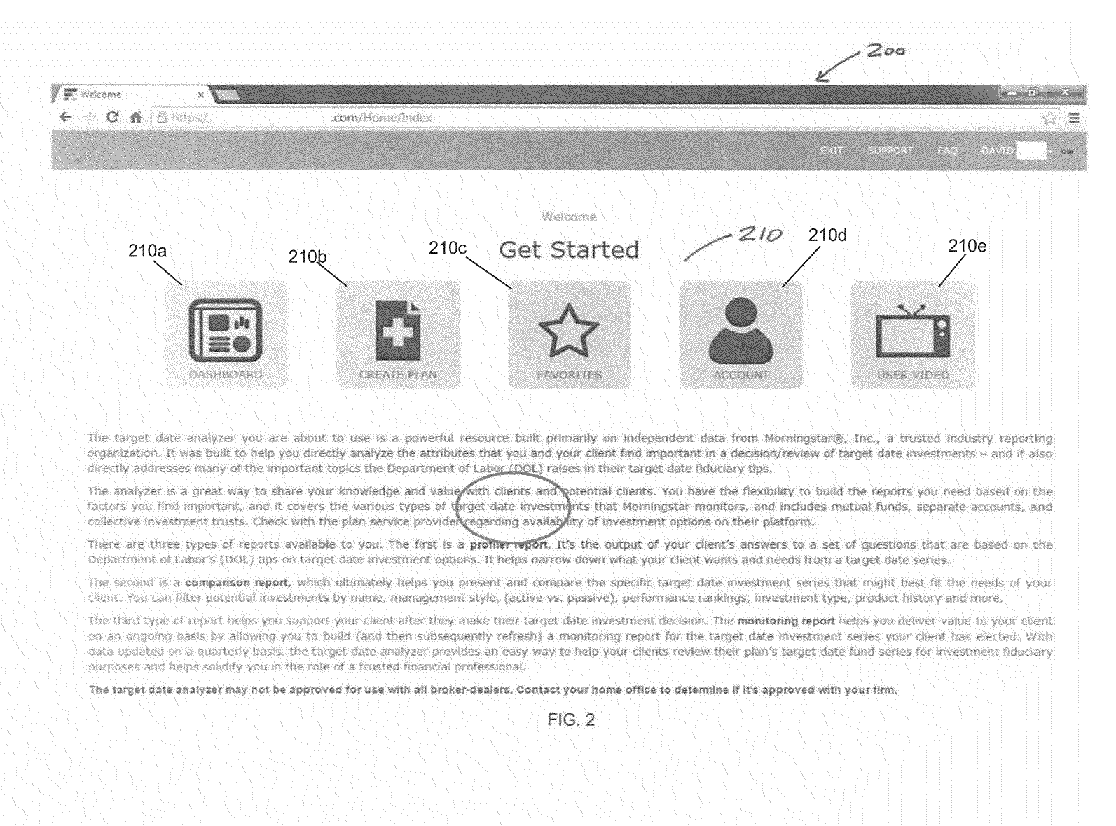

FIG. 2 shows an example of a welcome screen 200 generated by the target date analyzer server system and method. In some embodiments, following the completion of the logon process described earlier, the target date analyzer can display the welcome screen 200 which can include access to various modules and options to enable a user to switch to various functional aspects of the target date analyzer server system and method. For example, in some embodiments, the target date analyzer server system and method can include a plurality of text and/or graphical access icons 210 that can enable a user to access various functions including, but not limited to a dashboard access icon 210a, a create plan access icon 210b, a favorites access icon 210c, an account access icon 210d, and a user video icon 210e.

The dashboard access icon 210a can be used to access and launch a dashboard display. The create plan access icon 210b can be used to create an investment plan using one or more user inputs, selections, or preferences. The favorites access icon 210c can be used to access favorite plans or reports. The account access icon 210d can be used to access and/or set up a user account. The user video icon 210e can be used to access a user video, and/or to produce or compile a video related to an investment plan or investment option. The screen 200 can also include an introduction summary that includes; “The target date analyzer you are about to use is a powerful resource built primarily on independent data from Morningstar®, Inc., a trusted industry reporting organization. It was built to help you directly analyze the attributes that you and your client find important in a decision/review of target date investments—and it also directly addresses many of the important topics the Department of Labor (DOL) raises in their target date fiduciary tips. The analyzer is a great way to share your knowledge and value with clients and potential clients. You have the flexibility to build the reports you need based on the factors you find important, and it covers the various types of target date investments that Morningstar® monitors, and includes mutual funds, separate accounts, and collective investment trusts (“CITs”). Check with the plan service provider regarding availability of investment options on their platform. There are three types of reports available to you. The first is a profiler report. It's the output of your client's answers to a set of questions that are based on the Department of Labor (DOL) tips on target date investment options. It helps narrow down what your client wants and needs from a target date series. The second is a comparison report, which ultimately helps you present and compare the specific target date investment series that might best fit the needs of your client. You can filter potential investments by name, management style (active vs. passive), performance rankings, investment type, product history and more. The third type of report helps you support your client after they make their target date investment decision. The monitoring report helps you deliver value to your client on an ongoing basis by allowing you to build (and then subsequently refresh) a monitoring report for the target date investment series your client has elected. With data updated on a quarterly basis, the target date analyzer provides an easy way to help your clients review their plan's target date fund series for investment fiduciary purposes and helps solidify you in the role of a trusted financial professional. The target date analyzer may not be approved for use with all broker-dealers. Contact your home office to determine if it's approved with your firm.”

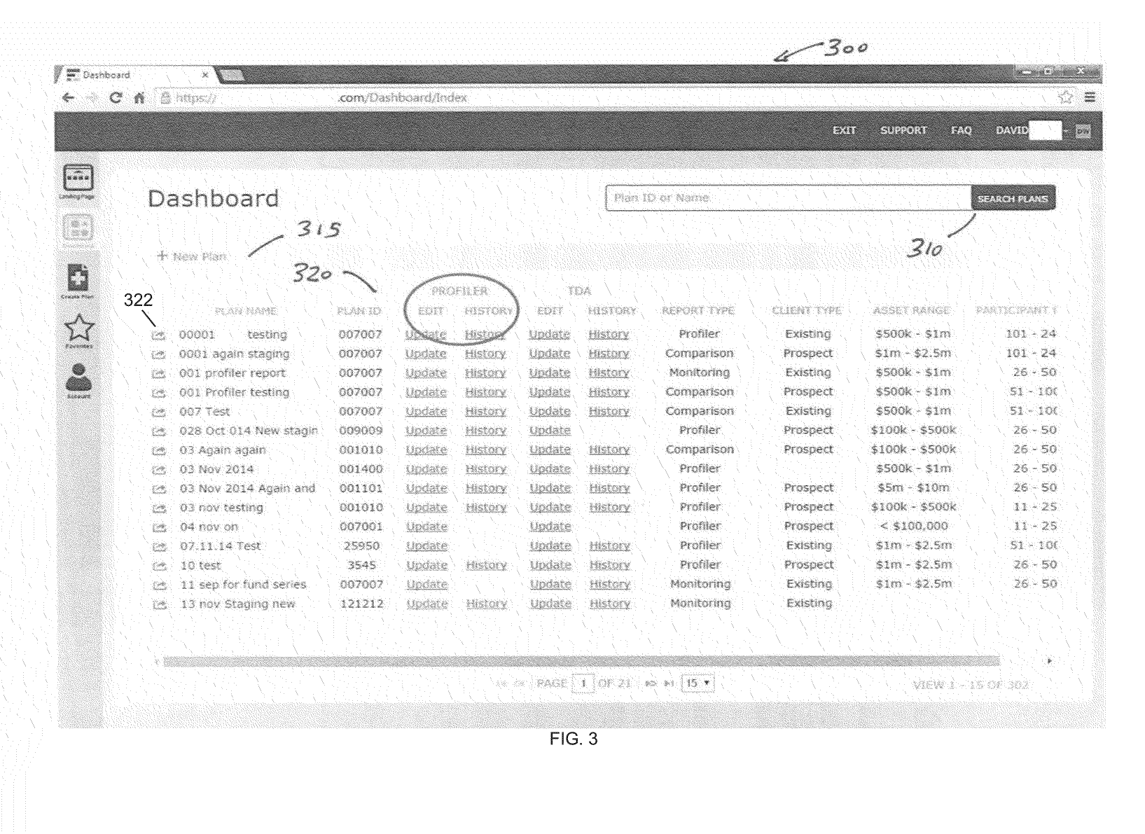

In some embodiments, once a user (e.g., such as a certified financial planner or other financial professional) has established an account (e.g., by accessing icon 210d), the target date analyzer server system and method can direct the user to a dashboard display screen that can display one or more target date plan reports. For example, FIG. 3 shows an example of a dashboard screen 300 generated by the target date analyzer server system and method in accordance with some embodiments of the invention. In some embodiments, the dashboard display screen 300 can list all plan reports the user has created (shown as table 320). Further, the dashboard display screen 300 can enable a user to create a new plan report (e.g., using entry field 315), and/or search for a created plan report using search plan function 310. In some embodiments, the display screen 300 can be used to create and/or display a list of plan reports (‘plan name’), with plan IDs, asset ranges, and participant ranges. In some embodiments, the dashboard can display a share icon (arrow 322) next to the plan name for distributing the reports. In some embodiments, plans can be listed by default by plan name, and the user can re-organize the list by clicking on the header name. This can provide the user with the ability to organize the list in ascending or descending order by plan name (alphabetical order), asset range, and participant range, download date for either report (recent date to latest date or vice versa). In some embodiments, along with the plan name, the target date analyzer server system and method can display a plan ID, a profiler edit and history, report type, and client type (e.g., existing or possible client).

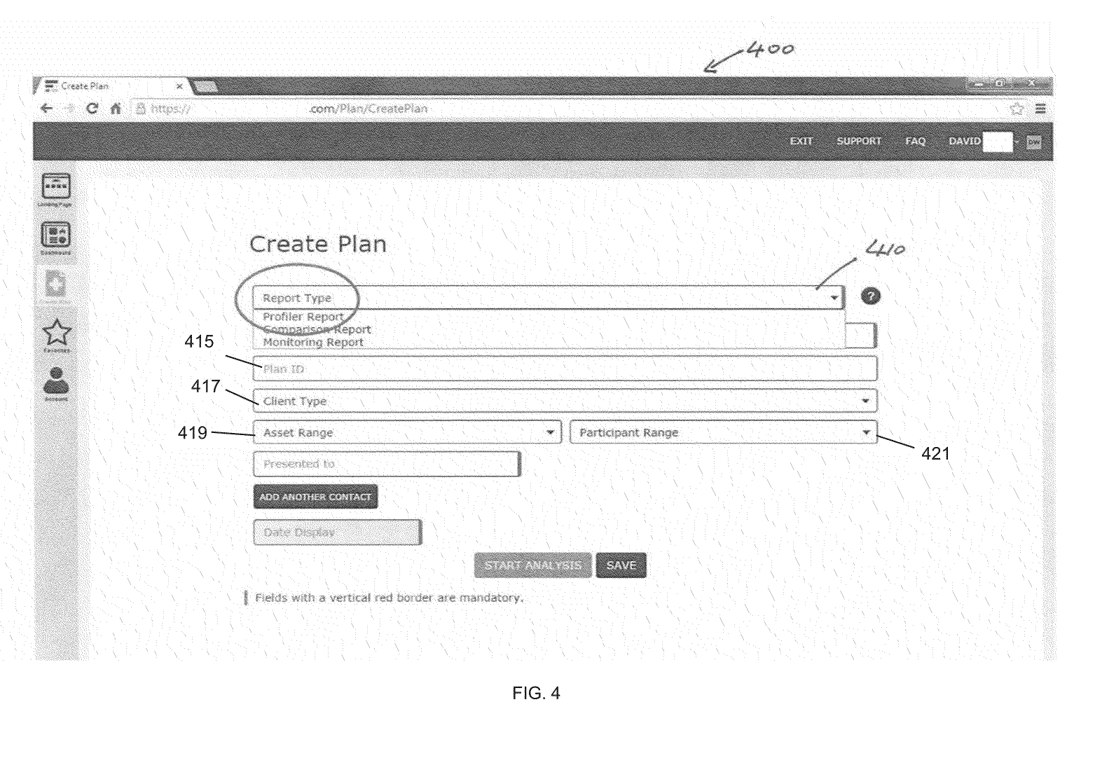

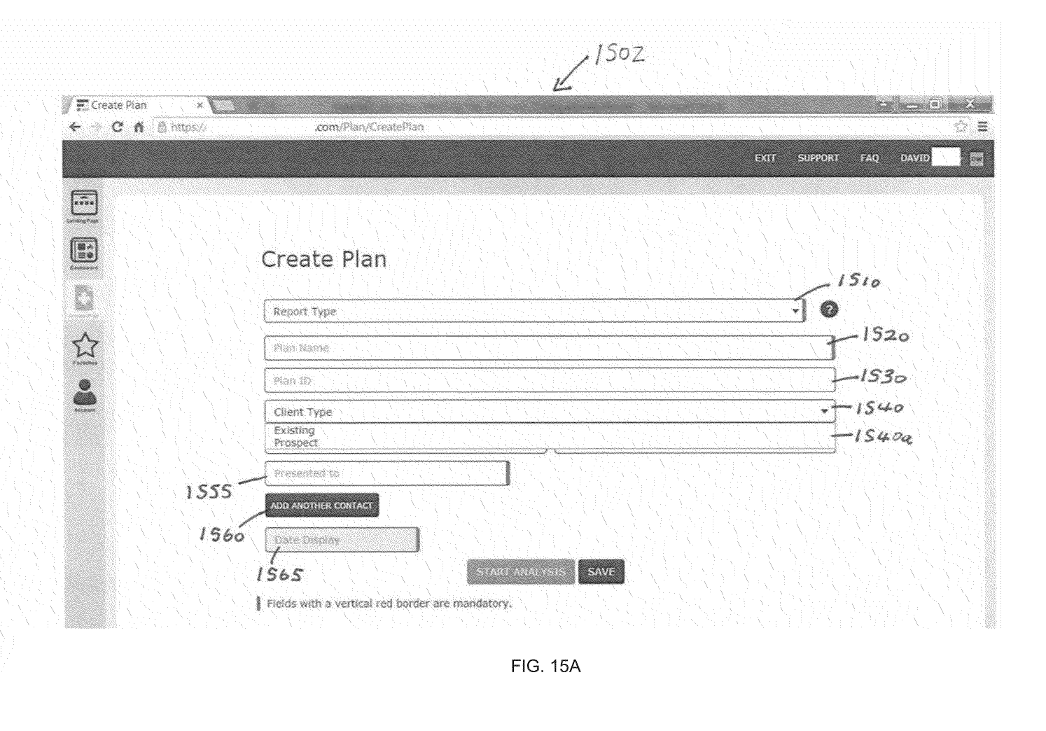

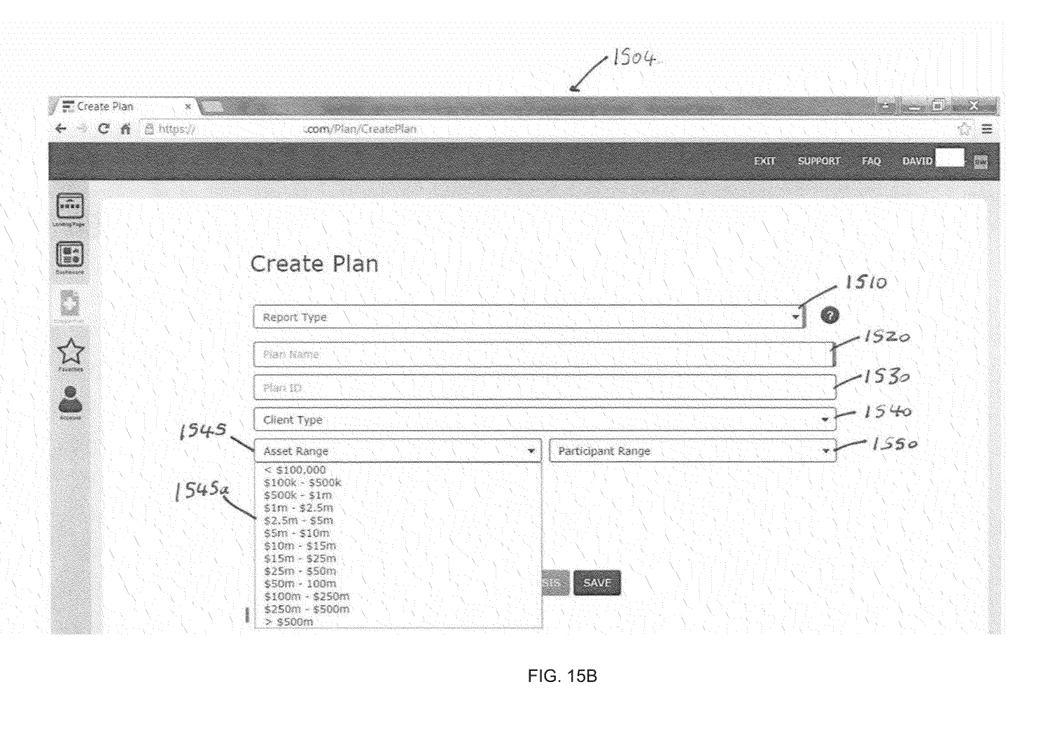

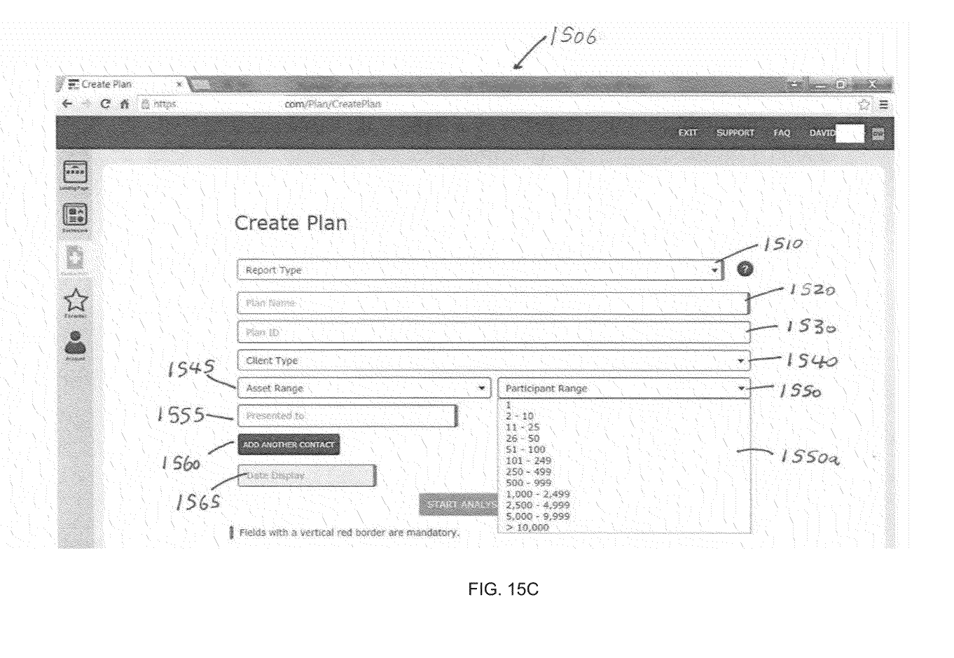

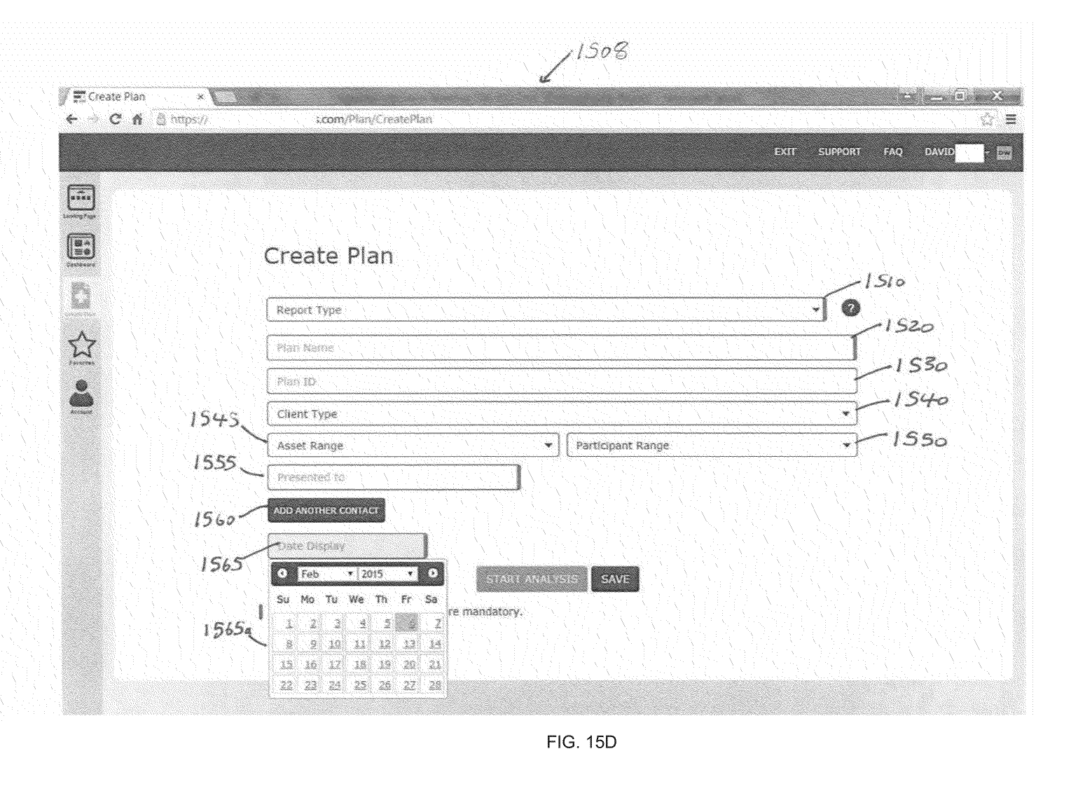

In some embodiments, from the dashboard display screen 300 and/or the welcome screen 200, a user can start a new plan report (e.g., by accessing create plan icon 210b). For example, FIG. 4 illustrates a create plan screen 400 generated by the target date analyzer server system and method in accordance with some embodiments of the invention. In some embodiments, by using the screen 400, the user can create one or more plans for analysis and reporting by the target date analyzer. The user can also select a plan ID 415, the client type 417, the asset range 419, and the participant range 421 by selecting from drop-down menus. Further details of plan creation are described in FIGS. 15A-15D. Other selection processes can be used in some embodiments; for example, in some embodiments, the user can enter data inputs in place of or in addition to selecting from drop-down menus. In some embodiments, the target date analyzer system and method can include type-ahead functions to enable ease of selection of one or more parameters. After a user has made one or more selections or entries in screen 300, the user can launch an analysis and/or can save the plan selections.

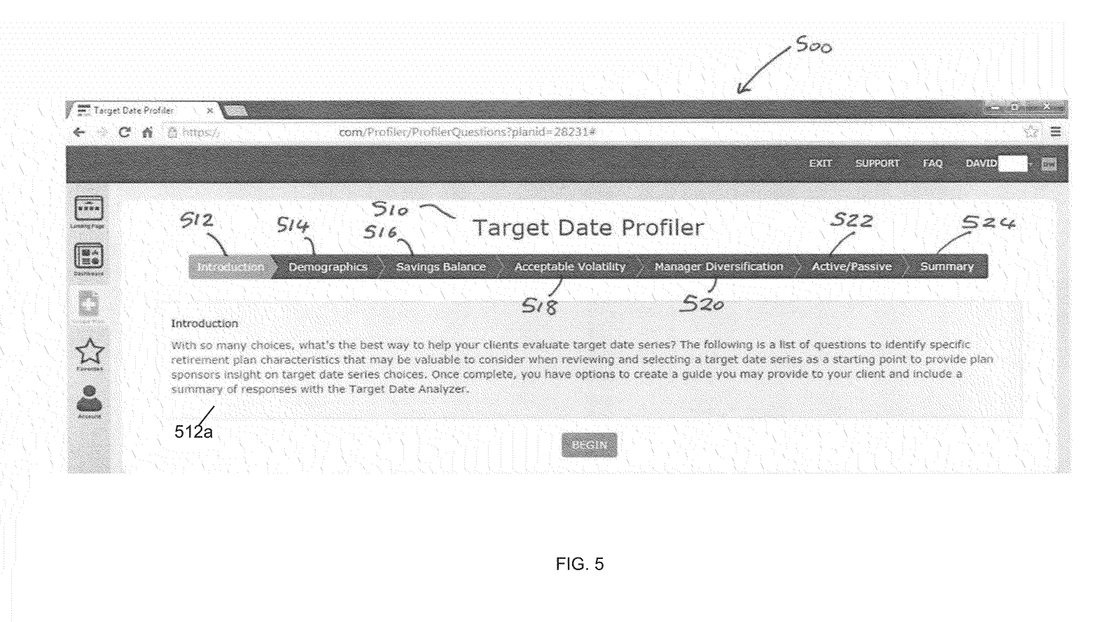

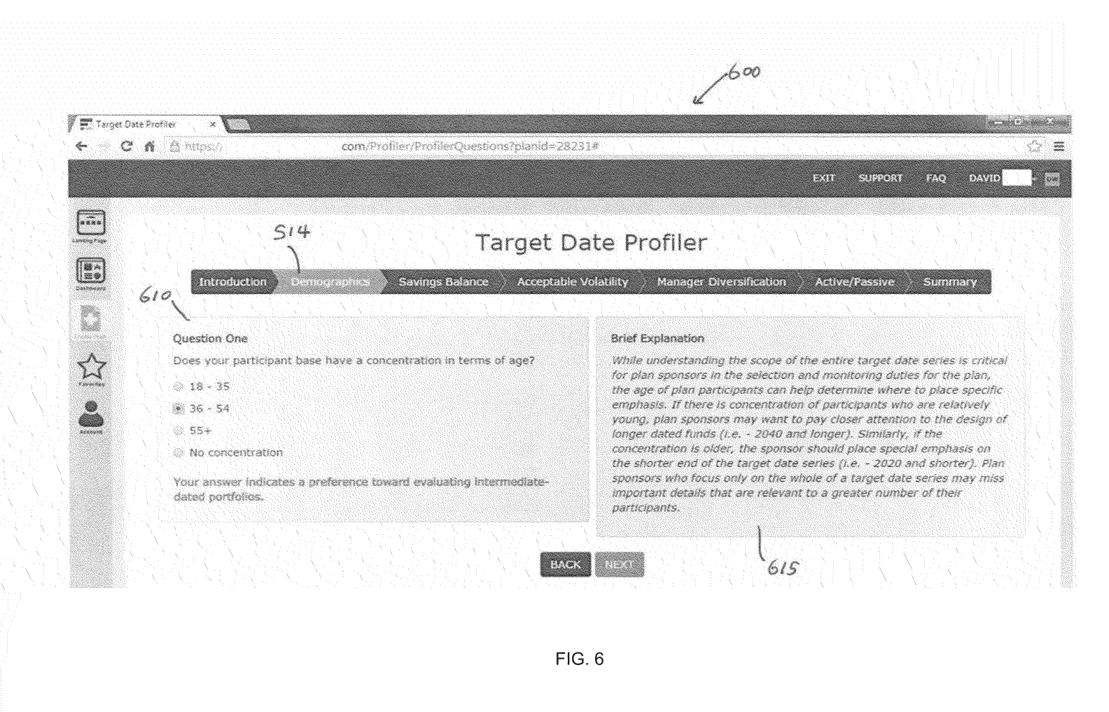

FIG. 5 illustrates an introduction screen 500 for the target date profiler 510 generated by the target date analyzer server system and method in accordance with some embodiments of the invention. Using one or more sections of a target date profiler 510, the user can review an introduction and enter information related to a client. For example, by accessing an introduction section 512, an introduction window 512a can be displayed to the user. Further, the user can enter information by accessing one or more tabs, including, but not limited to, a demographics tab 514, a savings balance tab 516, an acceptable volatility tab 518, a manager diversification tab 520, and/or an active/passive tab 522, and can review one or more summaries using the summary tab 524. For example, following a user access of demographics tab 514, a demographics screen 600 (FIG. 6) can be displayed for the target date profiler 510 generated by the target date analyzer server system and method in accordance with some embodiments of the invention. In some embodiments, using this screen 600, the user can be provided with an option to enter the age or age range of the user's client or plan participant base using question window 610. In some embodiments, the user can receive at least some guidance or explanation using the explanation window 615.

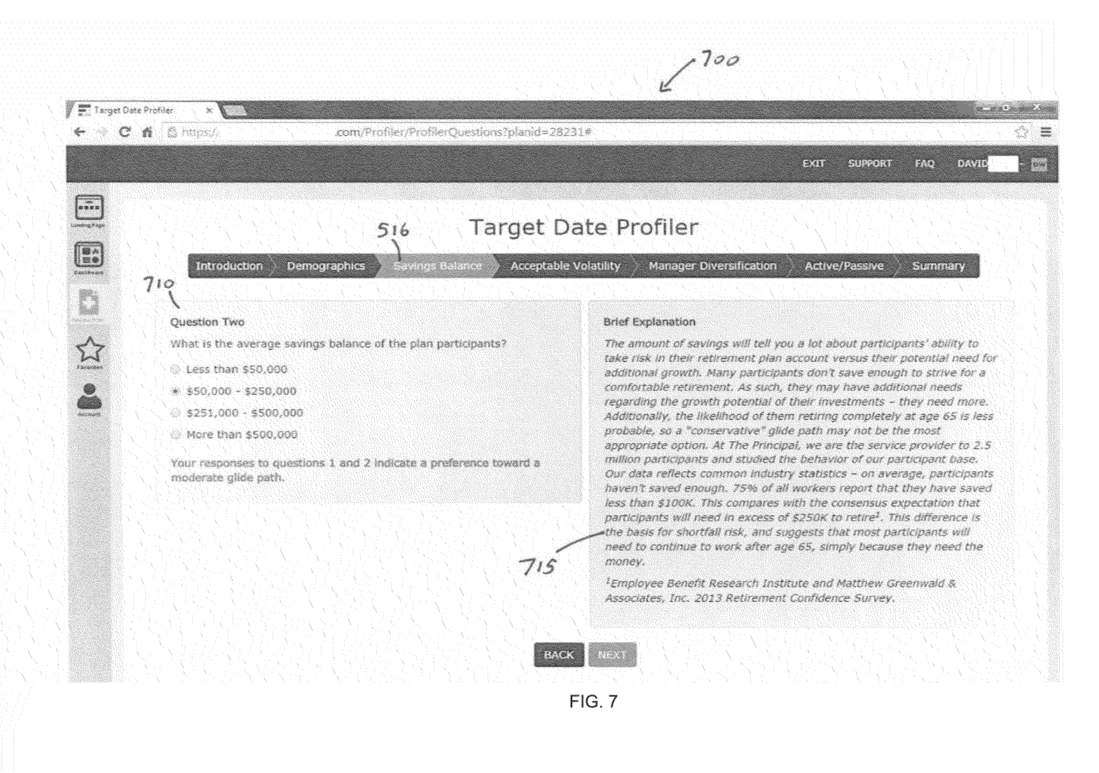

In some embodiments, the user can enter financial information about one or more of the user's client base including the average savings of the plan participant base. For example, FIG. 7 illustrates a savings balance screen 700 generated by the target date analyzer server system and method in accordance with some embodiments of the invention. In some embodiments, this screen can be used by the user to enter a savings balance of one or more clients. For example, using this screen 700, the user can be enabled with an option to enter the average savings of the plan participants of the user's client or plan participant base using question window 710. In some embodiments, the user can receive at least some guidance or explanation using the explanation window 715. In some embodiments, the window 710 can include answer choices including, but not limited to, “less than $50,000”, “$50,000-$250,000”, “$251,000-$500,000”, and/or “More than $500,000”. In some embodiments, the window 710 can include more than one question and more than one set of user-selectable answers.

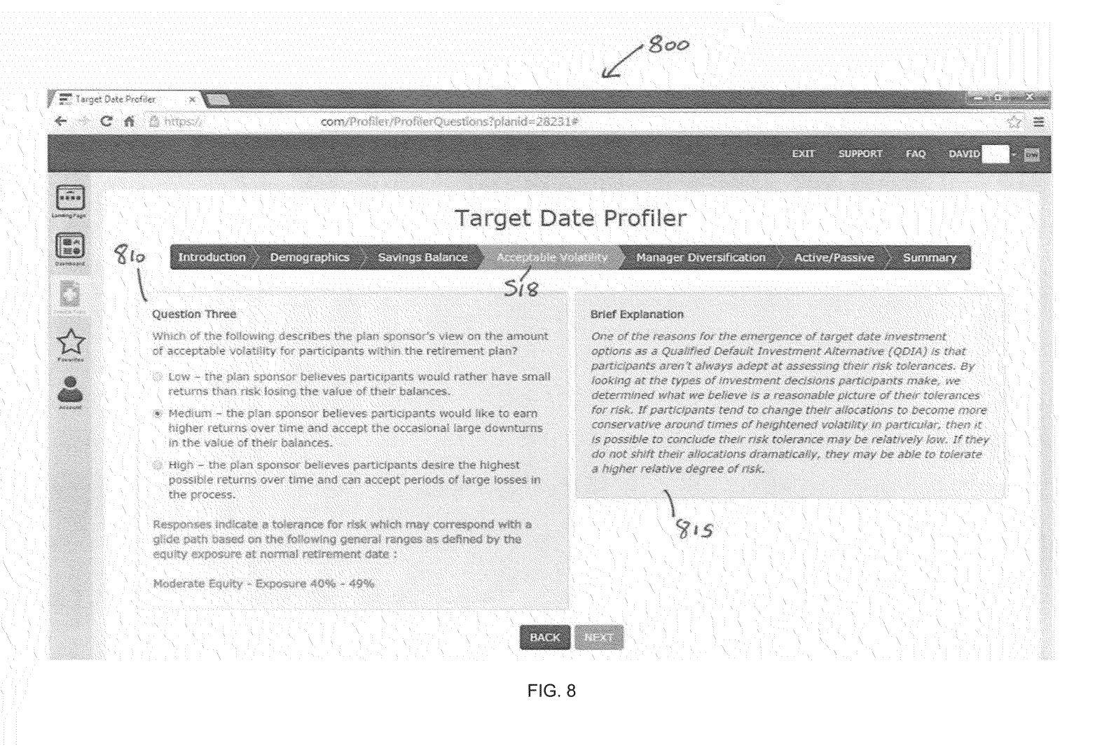

In some embodiments of the invention, the target date analyzer server system and method can enable a user to enter investment preferences. For example, FIG. 8 illustrates an acceptable volatility screen 800 generated by the target date analyzer server system and method in accordance with some embodiments of the invention. Using the question window 810, the user can enter or select an answer to a question related to how a plan sponsor views an acceptable amount of volatility for participants within the retirement plan. Further, the user can receive at least some guidance or explanation using the explanation window 815. In some embodiments, the window 810 can include at least one question and at least one set of user-selectable answers. For example, in some embodiments, the question can comprise “Which of the following describes the plan sponsor's view on the amount of acceptable volatility for participants within the retirement plan?” In some embodiments, the displayed answers can include “Low—the plan sponsor believes participants would rather have small returns than risk losing the value of their balances”, and/or “Medium—the plan sponsor believes participants would like to earn higher returns over time and accept the occasional large downturns”, and/or “High—the plan sponsor believes participants desire the highest possible returns over time and can accept periods of large losses in the process.”

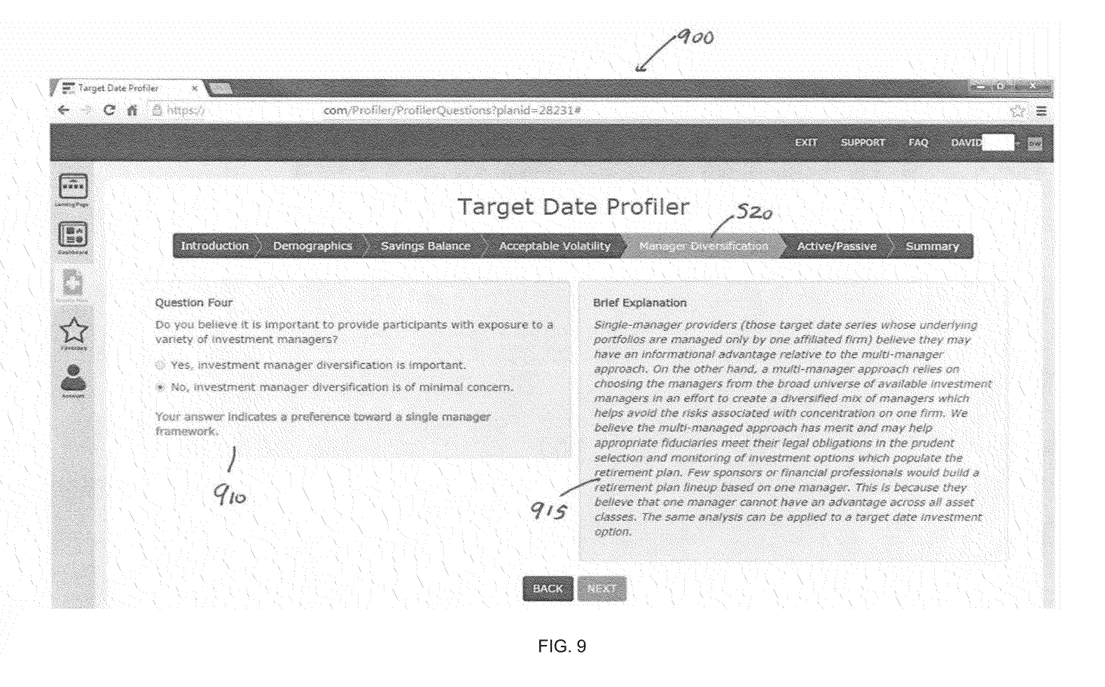

In some embodiments, other investment preferences can be entered by the user. For example, FIG. 9 illustrates a manager diversification screen 900 generated by the target date analyzer server system and method in accordance with some embodiments of the invention. Using this screen 900, the user can enter information related to a client's preference for investment manager diversification. For example, using the question window 910, the user can enter or select an answer to a question related to a client's preference for investment manager diversification within the retirement plan. Further, the user can receive at least some guidance or explanation using the explanation window 915. In some embodiments, the window 910 can display at least one question and at least one answer. In some embodiments, the question can comprise “Do you believe it is important to provide participants with exposure to a variety of investment managers”. In some embodiments, the window 910 can include a yes or no answer choice.

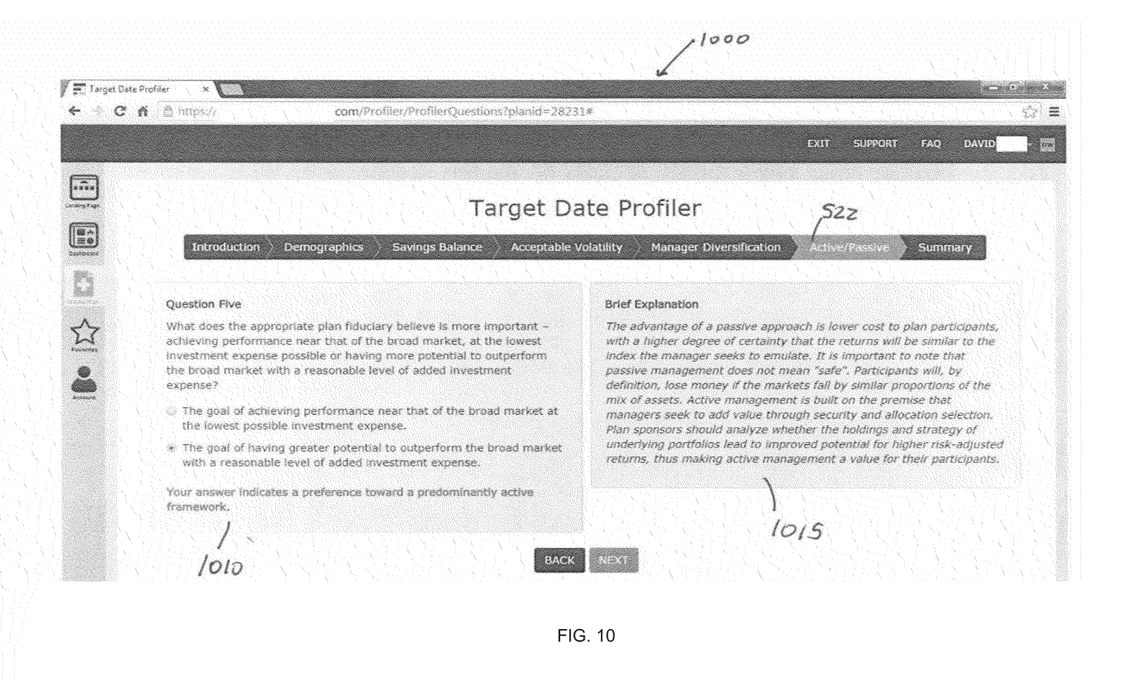

In some embodiments, the user can enter information related to a client's preference for active management, passive management, or mixtures thereof. For example, FIG. 10 illustrates an investment strategy screen 1000 generated by the target date analyzer server system and method in accordance with some embodiments of the invention. In some embodiments, the user can select one or more preferences related to one or more investment goals. For example, using the question window 1010, the user can enter or select an answer to a question related to a client's preference for achieving a desired performance within a retirement plan. In some embodiments, the window 1010 can display at least one question and at least one answer. In some embodiments, the question can comprise “What does the appropriate plan fiduciary believe is more important—achieving performance near that of the broad market, at the lowest investment expense possible or having more potential to outperform the broad market with a reasonable level of added investment expense”. In some embodiments, the window 910 can include an answer of “The goal of achieving performance near that of the broad market at the lowest possible investment expense”, and/or an answer of “The goal of having greater potential to outperform the broad market with a reasonable level of added investment expense”. Further, the user can receive at least some guidance or explanation using the explanation window 1015.

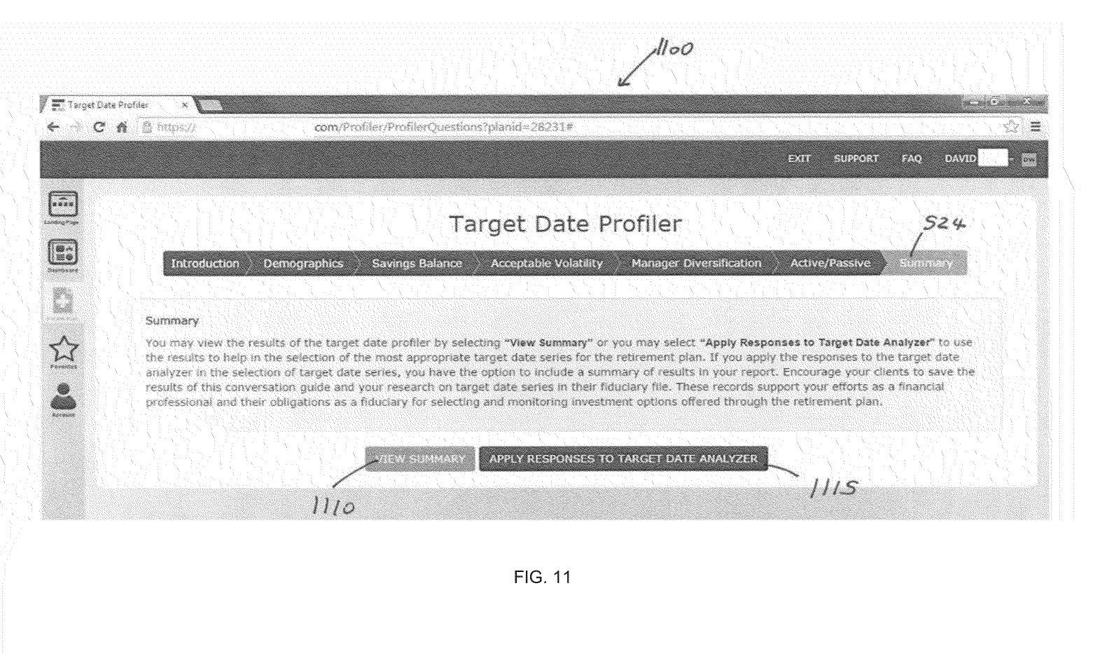

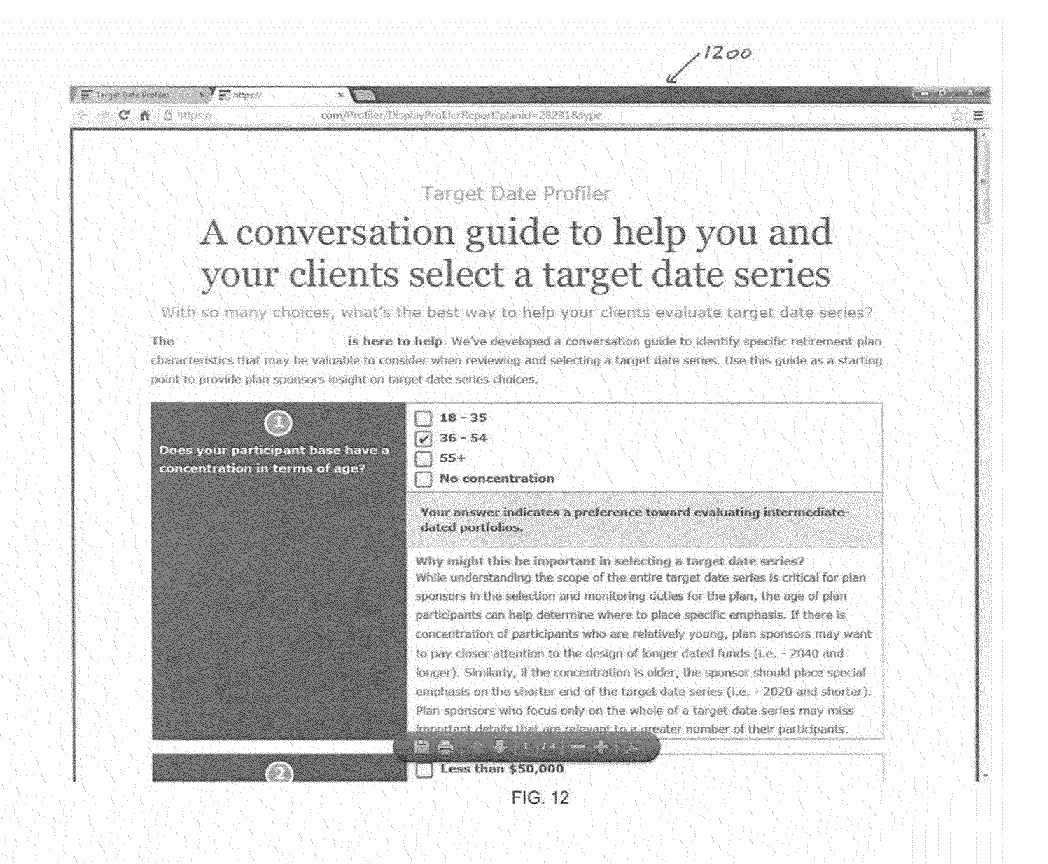

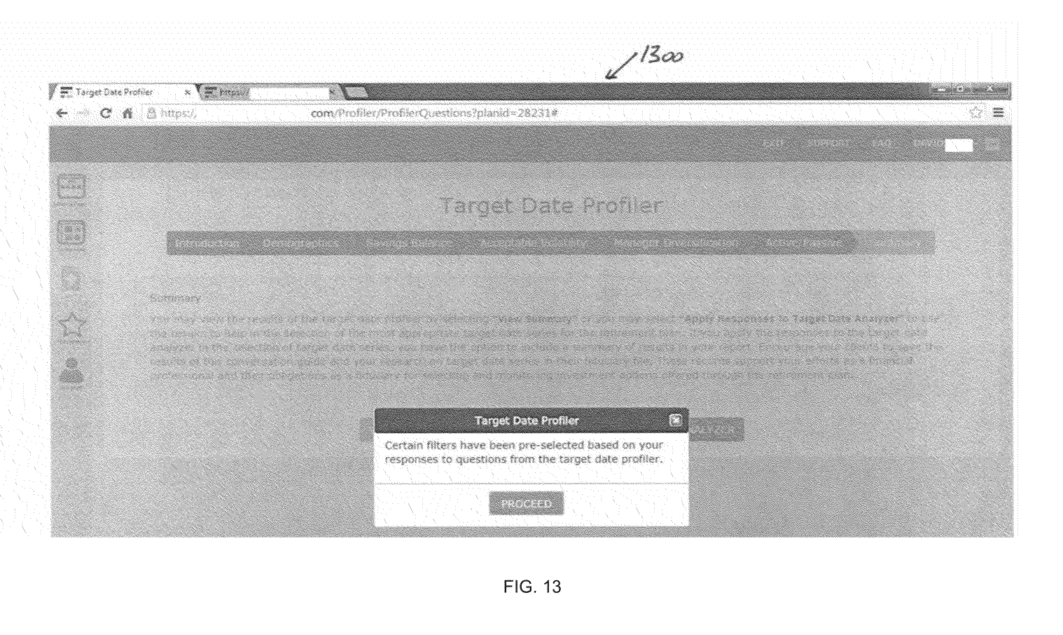

In some embodiments, the target date analyzer server system and method can enable a user to review results related to information provided as part of the target date profiler module of the target date analyzer server system and method. For example, FIG. 11 illustrates a summary access screen 1100 generated by the target date analyzer server system and method in accordance with some embodiments of the invention. In some embodiments, using this screen 1100, and view summary icon 1110, the user can view a summary of previously entered data. Further, in some embodiments, using the apply icon 1115, the user can apply one or more entered, selected or created data to at least one target date analysis performed by the target date analyzer server system and method. Further, in some embodiments, the user can view a profiler presentation or handout to assist the user with client interaction and target date planning. For example, FIG. 12 illustrates an example page 1200 from a target date profiler presentation or handout generated by the target date analyzer server system and method in accordance with some embodiments of the invention. Further, FIG. 13 illustrates a ‘status and proceed’ screen 1300 generated by the target date analyzer server system and method in accordance with some embodiments of the invention. In some embodiments, using this screen 1300, the user can proceed with at least one target date analysis for at least one client. In some embodiments, information related to the at least one target date analysis can be displayed in a booklet, presentation, or other informational format for review by the user as described above.

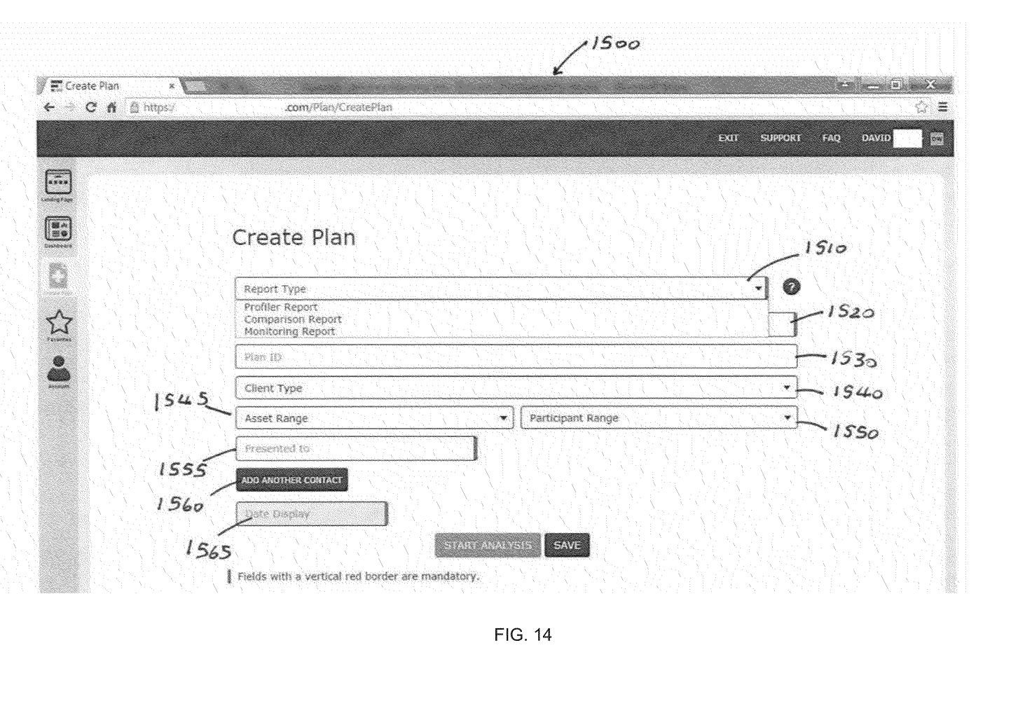

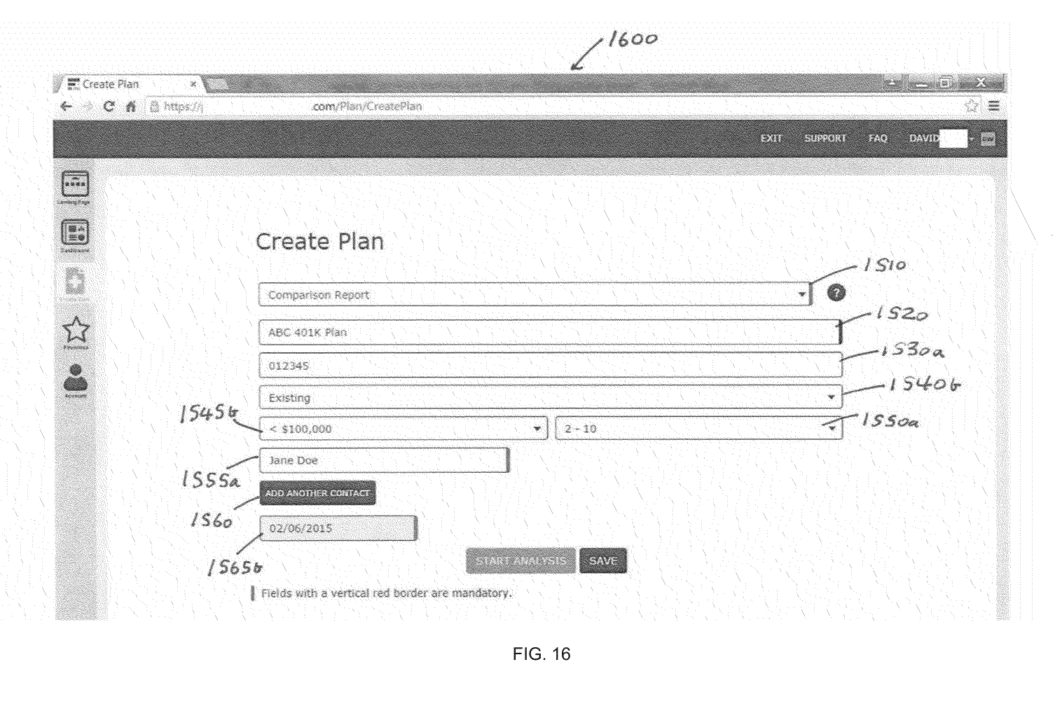

FIGS. 14, 15A-15D, and 16 illustrate examples of create plan screens generated by the target date analyzer server system and method in accordance with some embodiments of the invention. In some embodiments, a user can customize a plan and reporting of data from the plan using one or more drop-down menus. For example, in some embodiments, a report type menu 1510 can be used to select from a list of reports including a “Profiler Report”, and/or a “Comparison Report”, and/or a “Monitoring Report”. In some embodiments, a “plan name” menu 1520 can be used to select one or more plans, and a “plan ID” menu 1530 can be used to select from a list of plan IDs. In some embodiments, the “Client Type” menu 1540 can be used to select a type of client. FIG. 15A shows selection between an existing or prospective client (1540a). Further, in some embodiments, the “Asset Range” menu 1545 can be used to select a certain range for assets, and a “Participant Range” menu 1550 can be used to select participant ranges. Further, for example, FIG. 15B shows a selection menu 1545a from the menu 1545, and FIG. 15C shows a selection menu 1550a from the menu 1550. Other selectable menus can include a “Presented to” menu 1555 to define the audience or viewer, and “Date Display” 1565 can be used to select a date or date range for the plan or report. For example, FIG. 15D shows the drop-down calendar 1565a from menu 1565. Further, FIG. 16 shows date selection 1565b following a date selection from “Date Display” 1565. Other contacts for the plan or report can be selected from an “Add another contact” menu 1560.

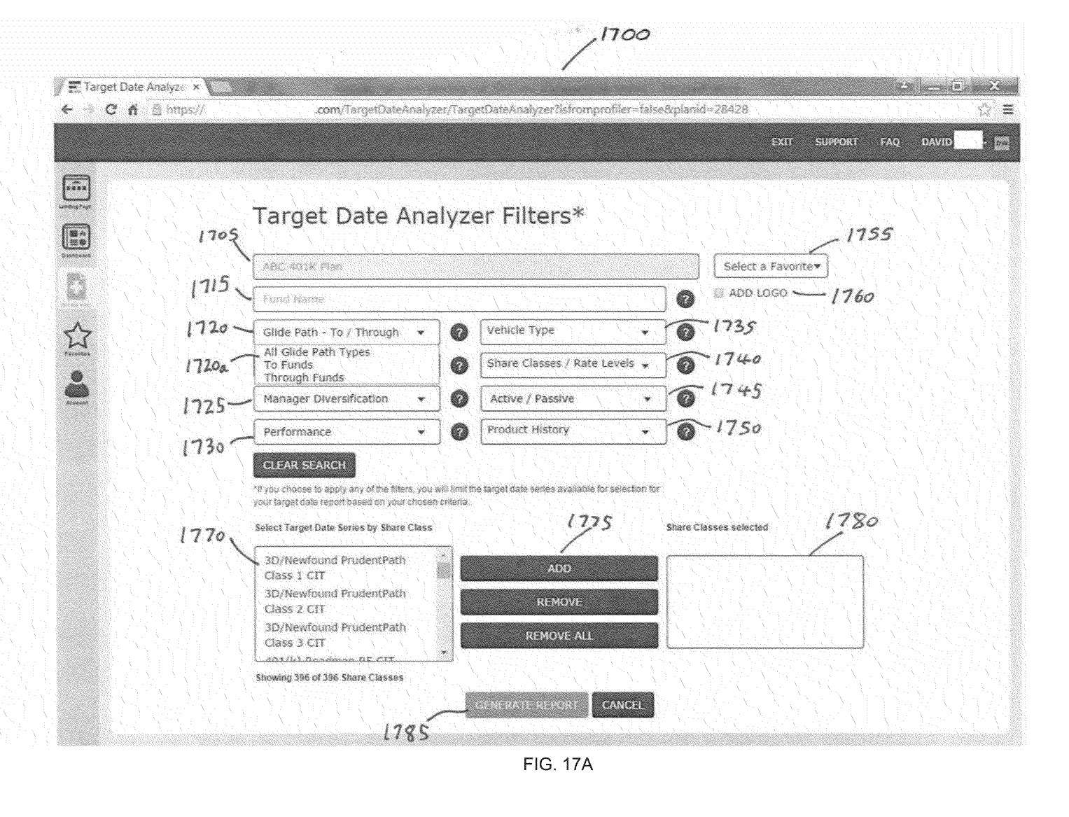

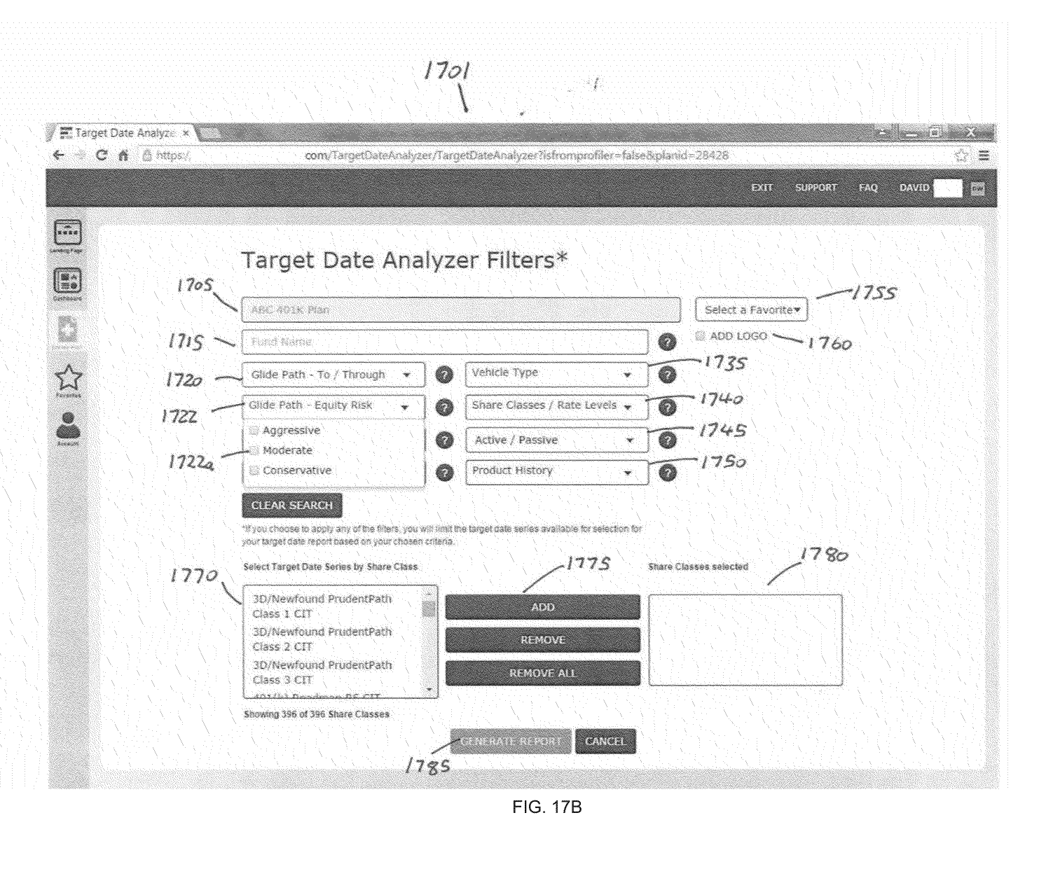

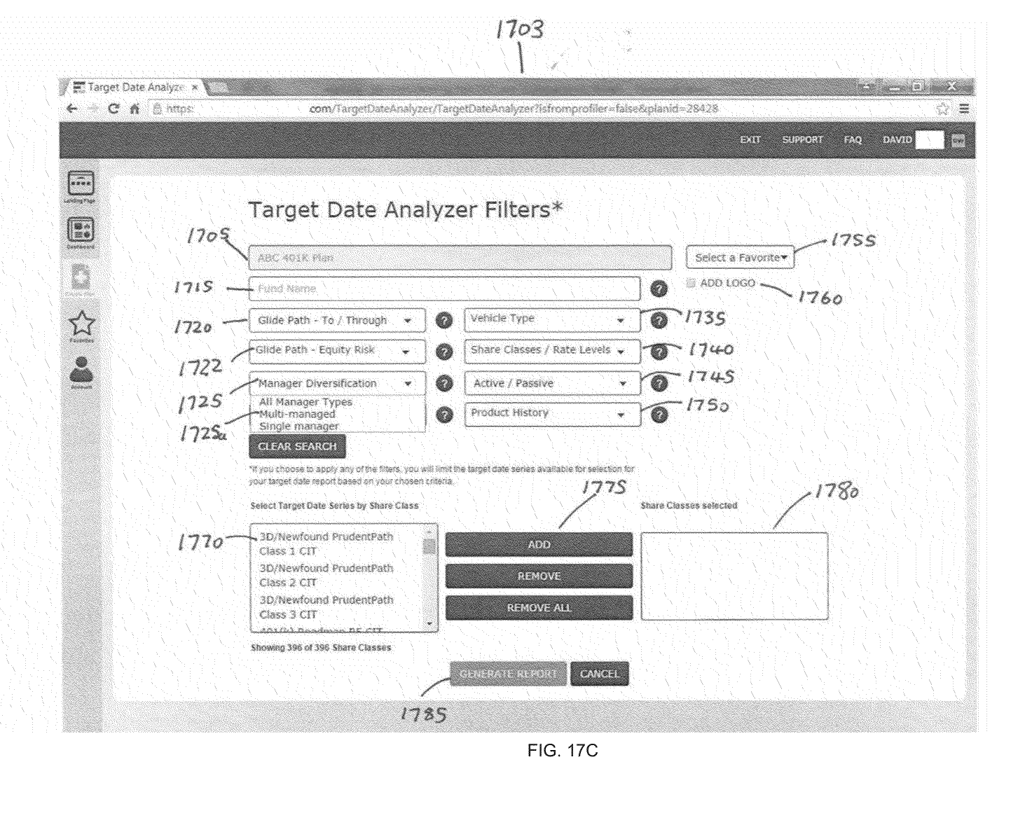

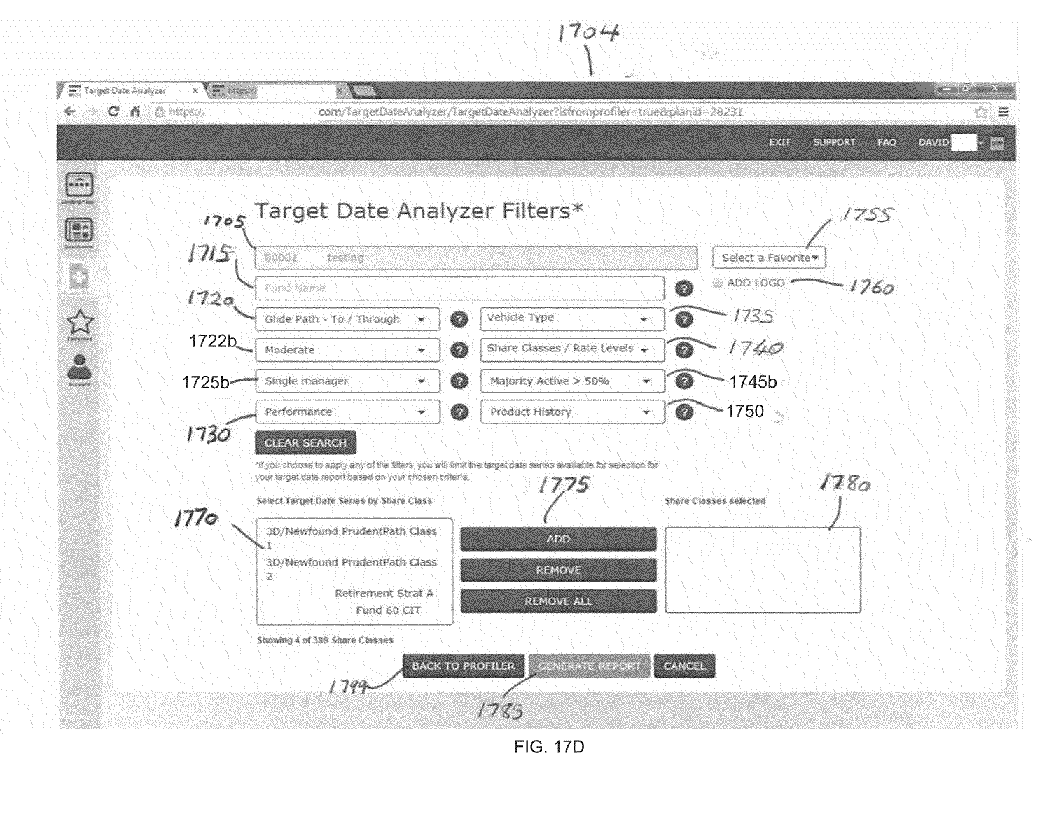

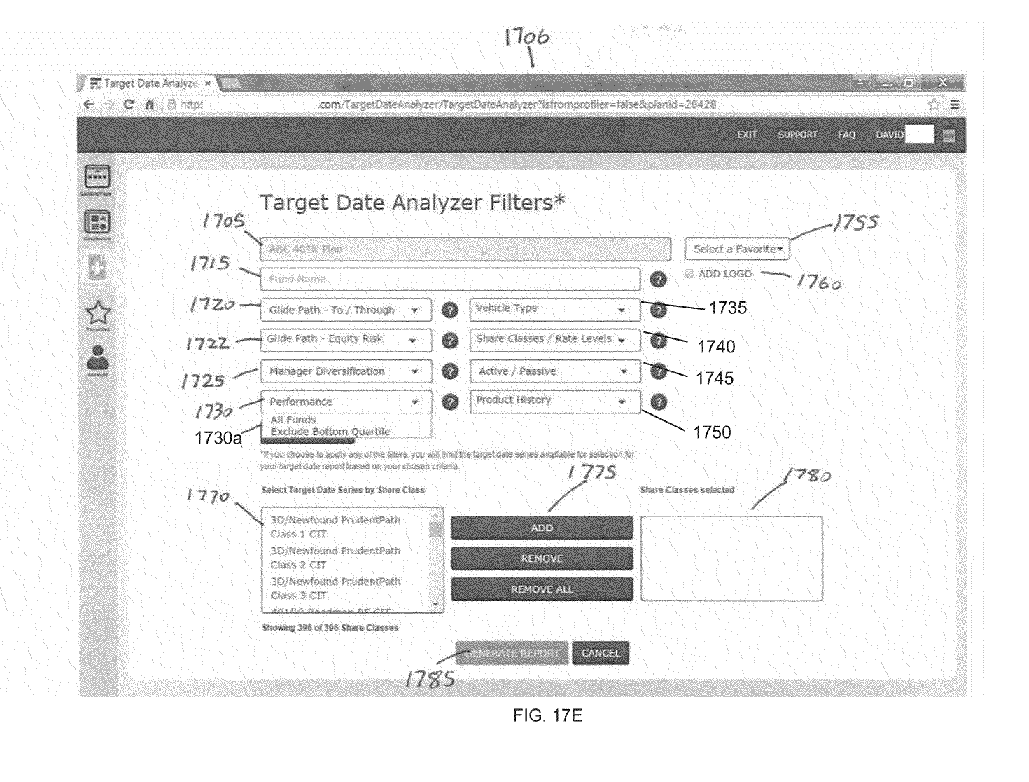

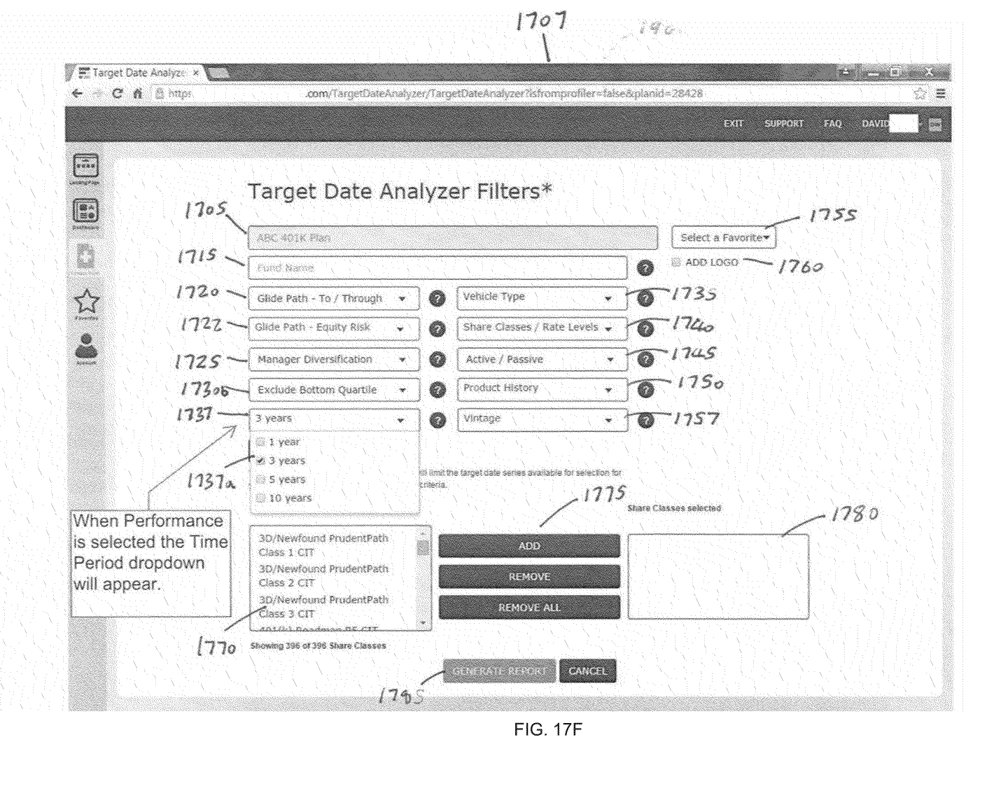

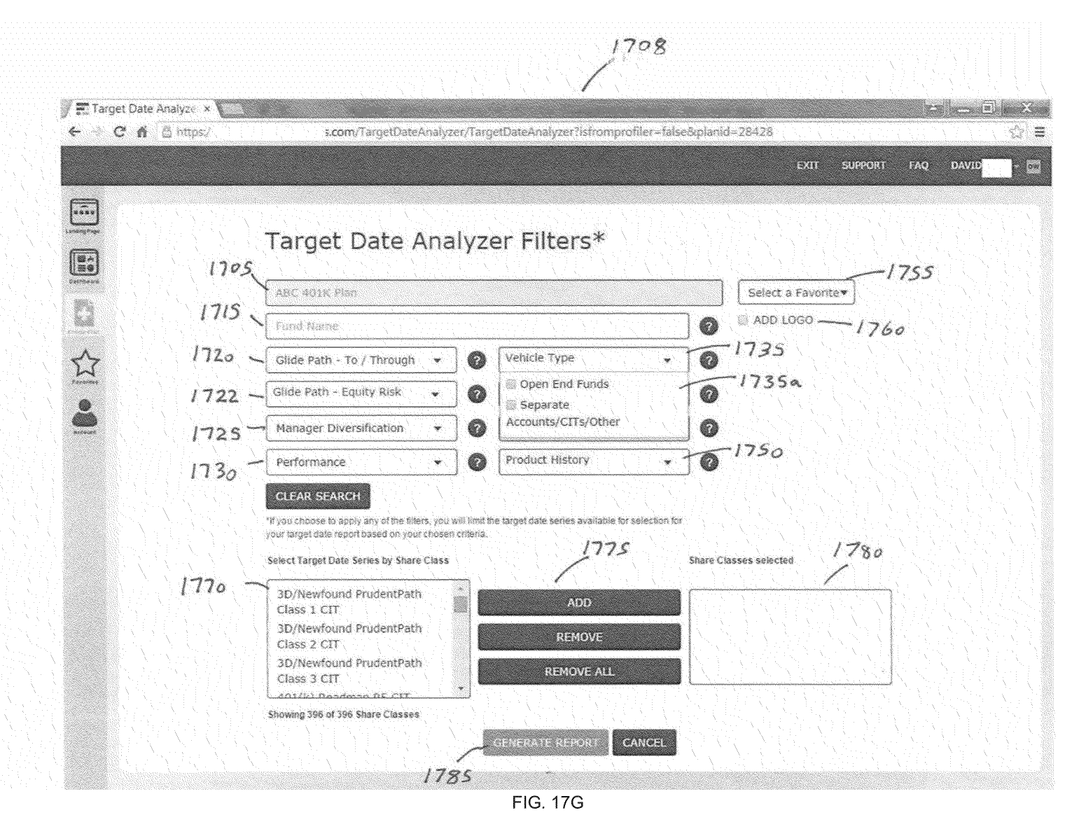

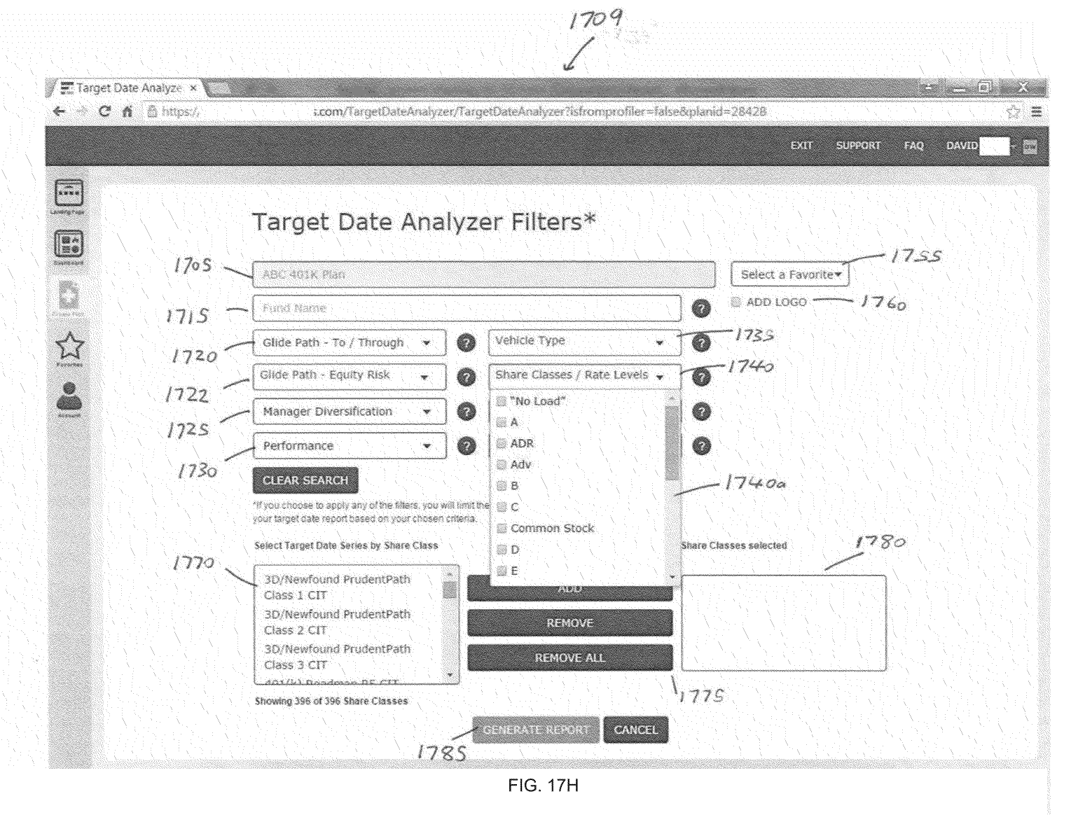

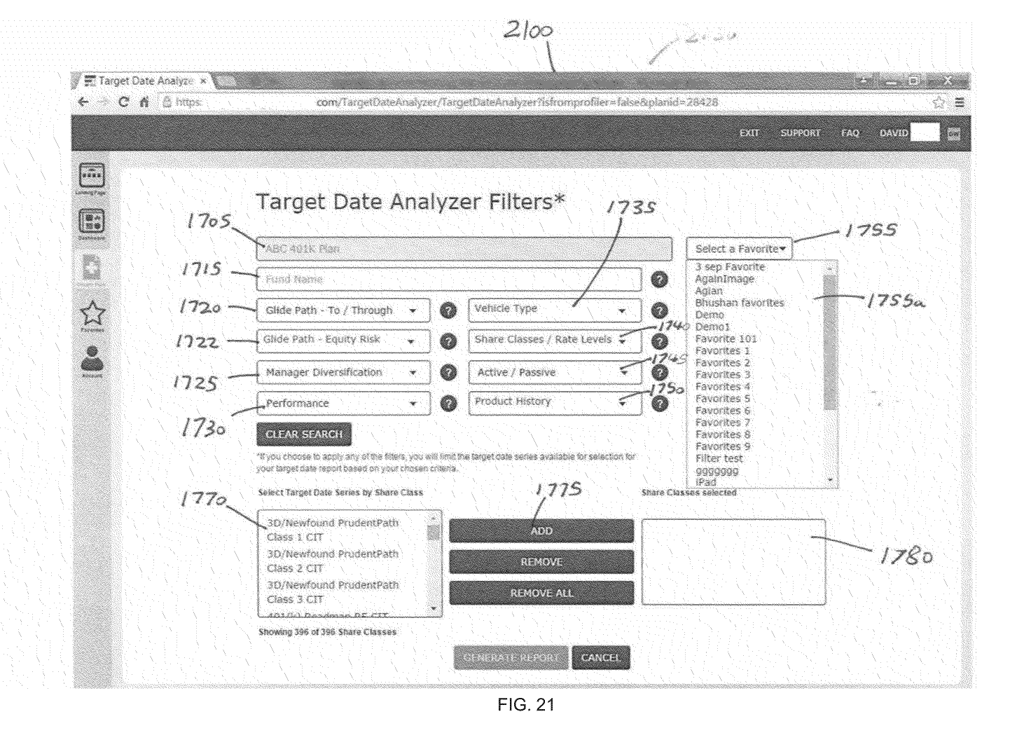

FIGS. 17A-17H, and FIGS. 18-21 illustrate examples of target date filter screens generated by the target date analyzer server system and method in accordance with some embodiments of the invention. In some embodiments, filters can provide the user with control over the target date fund series they wish to include in their report for analysis. In some embodiments, any information entered into the target date profiler 510 can be used or applied to one or more of the data filters (e.g., by entering information or selecting options and using the apply icon 1115 to apply one or more entered, selected or created data to at least one target date analysis performed by the target date analyzer server system and method.) In some embodiments of the invention, once the user has applied all applicable filters, the user can chose the fund series to compare. For example, in some embodiments, the user can compare a plurality of different fund series. Once the fund series are selected, the user can choose to customize the report. Some further optional choices can be provided to the user. In some embodiments, drop-down menus can be used to perform specific filter selections, although other conventional web-page selection methods can also be used. For example, referring at least to FIG. 17A, the target date filter screen 1700 can include a plan name field 1705 identifying a client's plan. In some embodiments, a favorite can be selected using the icon 1755, and a logo can be added using the “add logo” function 1760 (e.g., see FIG. 21, the display screen 2100, showing drop-down menu 1755a). Further, the fund name field 1715 can be used to select one or more funds. In some embodiments, target date fund filters can include fund name, type, and share class and/or rate level. In some embodiments, the target date analyzer can offer the ability to search for or limit target date funds to those found by typing a name. Further, as the user types, results can be automatically populated in the field. In some example embodiments, options can include: ‘All Fund Types’, ‘To Funds’, or ‘Through Funds’ (shown as menu 1720a) of the menu 1720. In some embodiments, using this option, the selected option can limit target date filters visible in the list to select from to those subject to the option chosen. In some embodiments, the options can be in a drop down menu selectable by the user, and the all fund types will be the default. Other user selectable menus include menu 1725 to select manager diversification, menu 1730 to select performance ranges, and menu 1735 for fund vehicle types. For the vehicle type, the options can include ‘select all’ (default option), ‘open end funds’, and ‘separate accounts/CITs (including separate accounts, CITs, GRPAs, and private funds), and more than one option can be selected by the user. In some embodiments, using a share class option (menu 1740), target date funds displayed can be limited to those specified by share class. All shares classes can be available in a drop down, and “Institutional Share Classes” can be the default. The user can select multiple share classes in the filter by clicking next to the desired share class. In some embodiments, share class discrepancies can be reviewed with the financial institution. In some other embodiments, other options include ‘active or passive’ (menu 1745). For the ‘active or passive’ option (available through a dropdown menu), options can be ‘all funds’, ‘majority active >50%’, and ‘majority passive >50%’. In some further embodiments, using menu 1750, the user can select ‘product history’ or ‘performance options’. By selecting the ‘product history’ option from a dropdown menu, the user can be provided with an option to select target date fund history over various time periods. In some embodiments, using the performance option, the user can apply filters to screen for fund performance over specific periods.

Referring to FIG. 17B, the display screen 1701 shows a drop-down menu 1722a from menu 1720 where a user can be enabled to select a risk tolerance level. Referring to FIG. 17C, the display screen 1703 shows the drop-down menu 1725a from the menu 1725, where a user can be enabled to select a preferred fund management. Referring to FIG. 17D, an example embodiment including some defined filters is shown in the display screen 1704, with a moderate risk selection 1722a and a single manager selection 1725b. A selection of majority active 1745b is also shown from the ‘active or passive’ menu 1745.

Referring to FIG. 17E, in some embodiments, the display screen 1706 can render a drop-down menu 1730a from the menu 1730 to enable a user to select performance ranges. Referring to FIG. 17F, the display screen 1707 can include an “Exclude from bottom Quartile” 1730b selection from the menu 1730a. Further, drop-down menu 1737a is shown from a time period menu 1737 that can be displayed when a user makes a performance selection from menu 1730. In this example embodiment, a user selection menu 1737a is displayed with a selection shown representing a performance period of three years. Referring to FIG. 17G, the display screen 1708 is shown from menu 1735 for fund vehicle types, the drop-down menu 1735a is shown where a user can select from vehicle types. Further, referring to FIG. 17H, the display screen 1709 can show a drop-down menu 1740a from share class menu 1740, where a user can select from a plurality of share classes as described earlier.

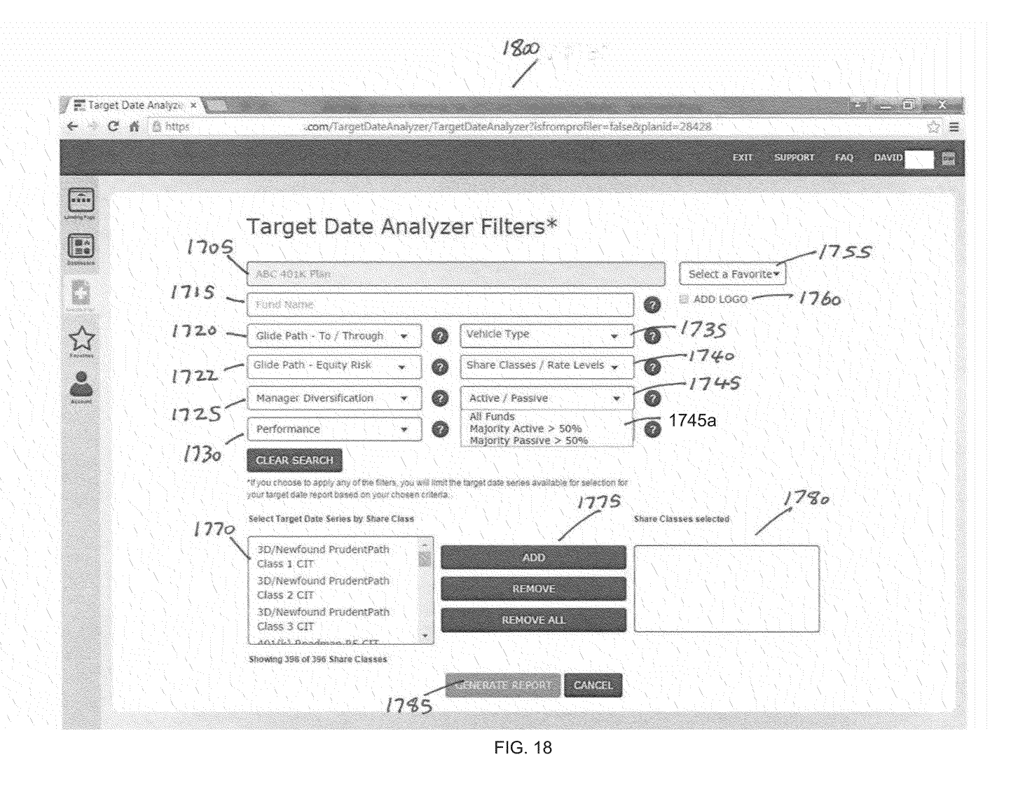

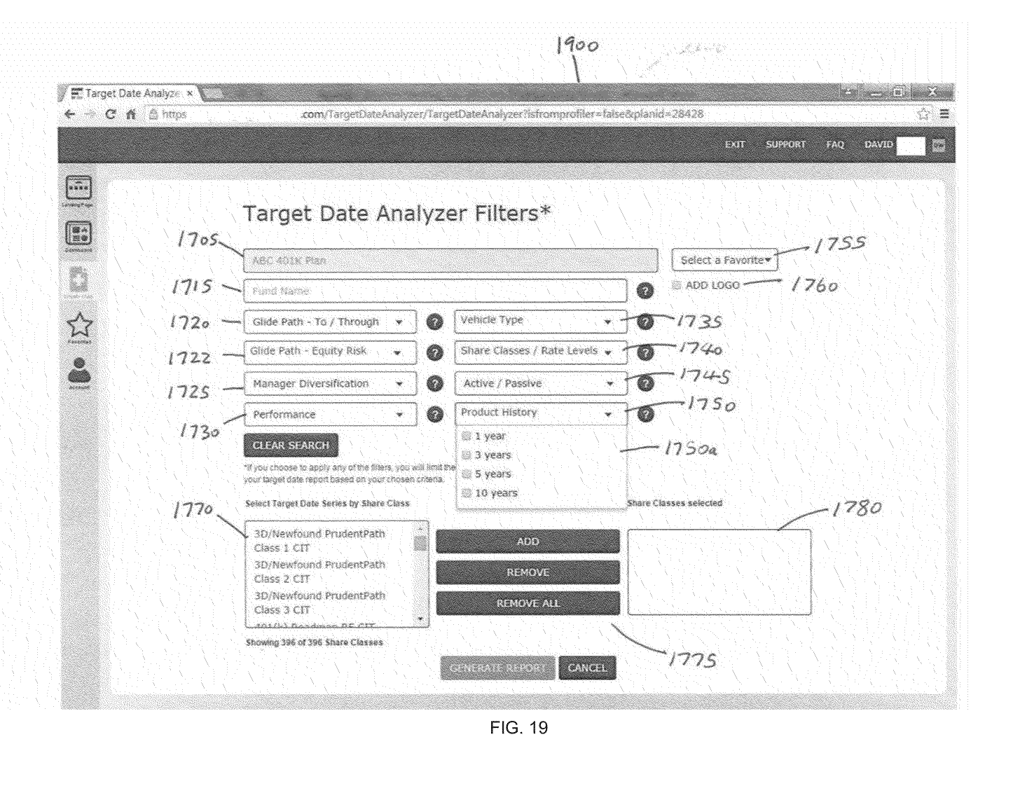

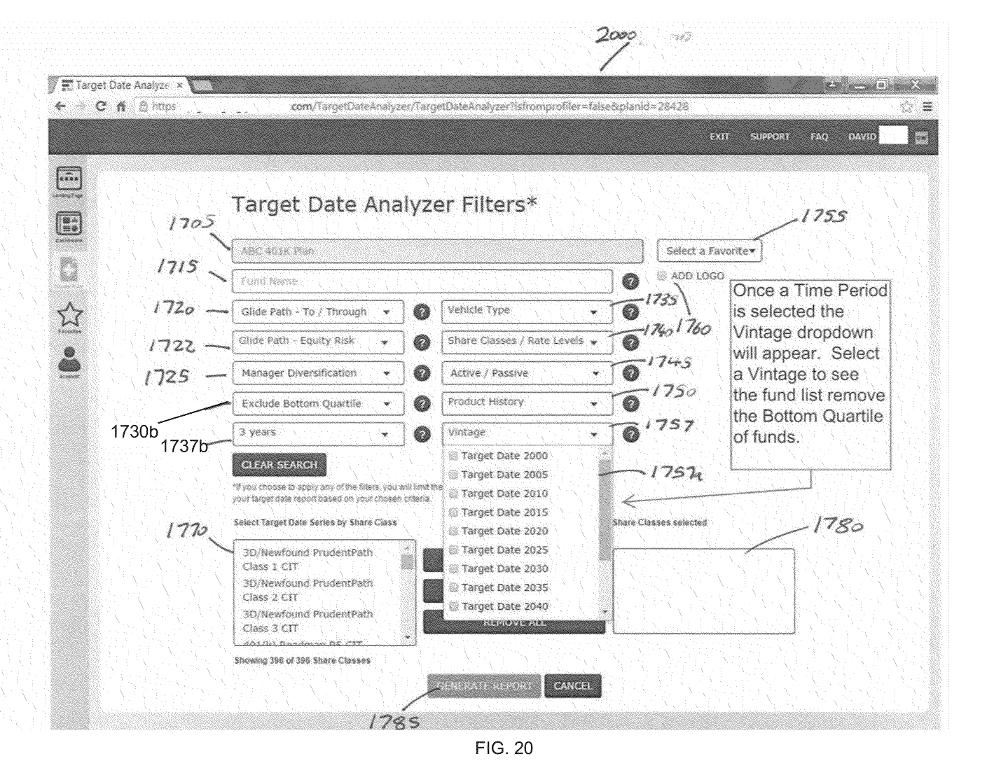

Referring to FIG. 18, in some embodiments, the display screen 1800 can include an embodiment with a drop-down menu 1745a from the active/passive style menu 1745 that can enable a user to define a fund or investing style. Further, referring to FIG. 19, the display screen 1900 can include an example embodiment of a drop-down menu 1750a from a menu 1750 for selecting a ‘product history’. Referring to FIG. 20, the display screen 2000 includes an example embodiment of a drop-down menu 1757a from a menu 1757 for a target fund vintage selection. The display screen 200 also shows a prior user selection 1737b of a three year performance date range (shown after selection from menu 1737a described above).

In some embodiments of the invention, the window 1770 can provide a list of one or more funds (such as select target date series funds) from which a user can select, add, remove, or remove all (using controls 1775). Selected share classes or rates can be shown in window 1780. Once selections are complete, the user can generate a report using data filtered by one or more of the previous selections using action icon 1785. In some embodiments, the user can exit the analyzer filter screens to go back to a profiler section at any time using icon 1799 (shown in FIG. 17D).

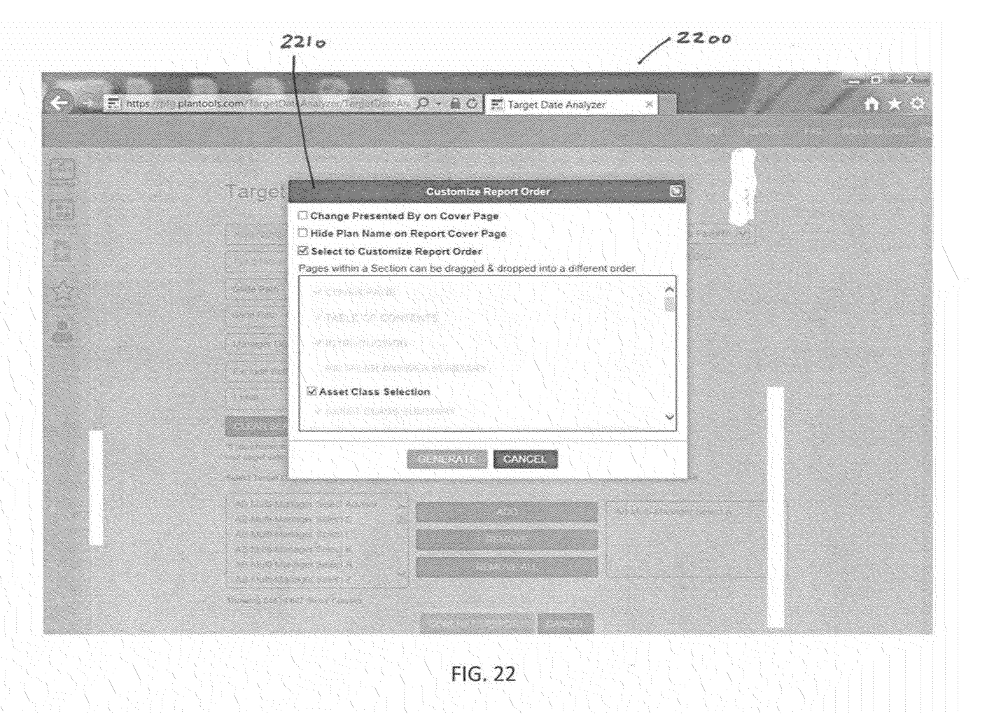

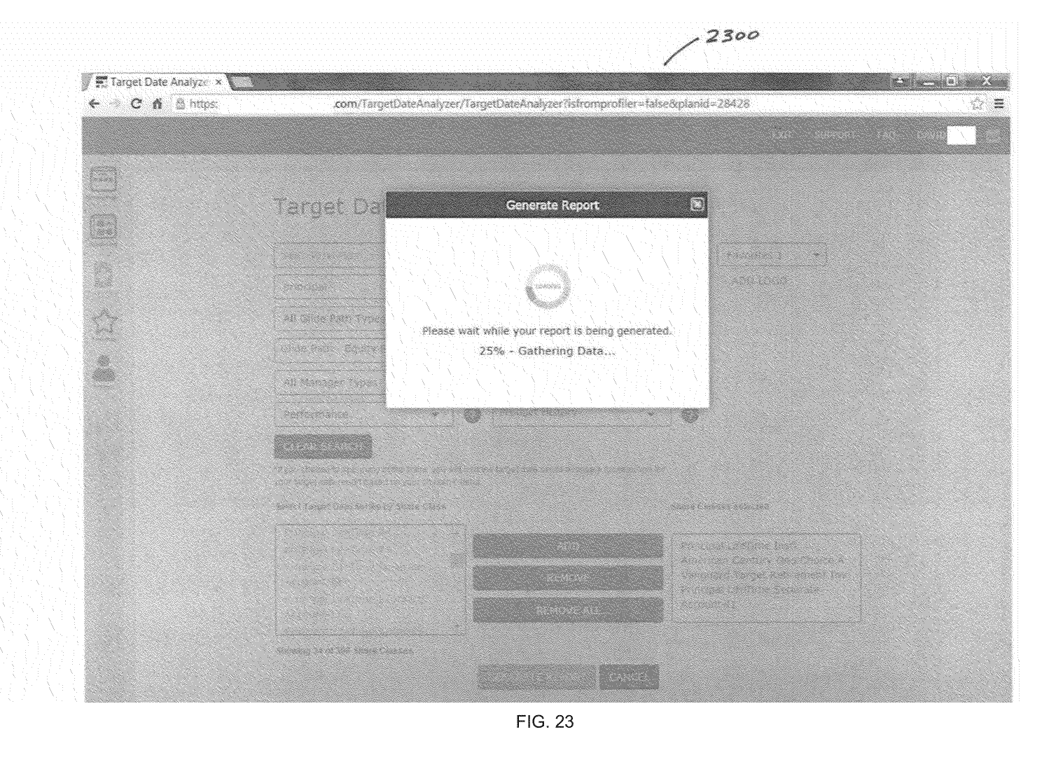

In some embodiments, the user can be provided with an option to create, download, and/or print customized reports. For example, FIG. 22 illustrates a report creation screen 2200 generated by the target date analyzer server system and method in accordance with some embodiments of the invention, and FIG. 23 illustrates an associated report download screen 2300 generated by the target date analyzer server system and method in accordance with some embodiments of the invention. Using this function, the user can be provided with the ability to customize reports by modifying various features or by creating and saving, in advance, scenarios to reuse at a later date for different clients (e.g., using customize report order window 2210 shown in FIG. 22).

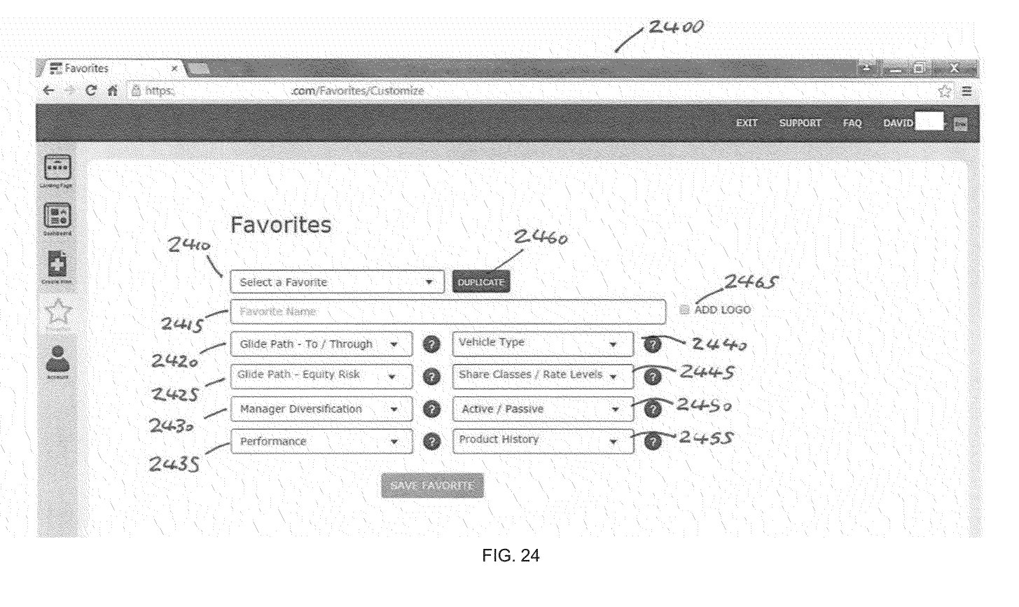

Some embodiments of the invention enable a user to create one or more scenarios. For example, FIG. 24 illustrates an example of a favorites selection screen generated by the target date analyzer server system and method in accordance with some embodiments of the invention. In some embodiments, the user can set up or define filters for favorites using selection menus similar to those described for target date analyzer filtering above. In some embodiments, the user can select a favorite from menu 2410, duplicate the favorite (selector 2460), and add a logo (selection function 2465). A favorite name can be defined using field 2415. Selection drop-down menus can include, but not be limited to, menu 2420 for selection of a preferred glide path (“to/through”), and/or menu 2425 for a selection of glide path (“equity risk”), and/or menu 2430 (for manager diversification), and/or menu 2435 (for fund or investment vehicle type), and/or menu 2440 (for vehicle type), and/or menu 2445, and/or menu 2450 (for active or passive investment preference), and/or menu 2455 (for share class or rate select). In some embodiments, any selected or defined favorite can be saved for later access, or duplicated for reuse for modification. In some embodiments, the glide path can comprise a retirement asset composition as a function of time. In some embodiments, the composition can change based on the time before and/or after a plan participant's expected retirement age. In some embodiments, the glide path can be calculated up to a specified retirement age of a plan participant. In other embodiments, the glide path can be calculated through and after the plan participant expects to retire. The calculated glide path will usually change over time before and after a plan participant's expected retirement date. Further, in general, the asset allocation (e.g., percentage of equity versus fixed income or bonds) will be higher in the glide path before the plan participant's projected or specified retirement age, and lower in the portion of the glide path after before and after the plan participants projected or specified retirement age.

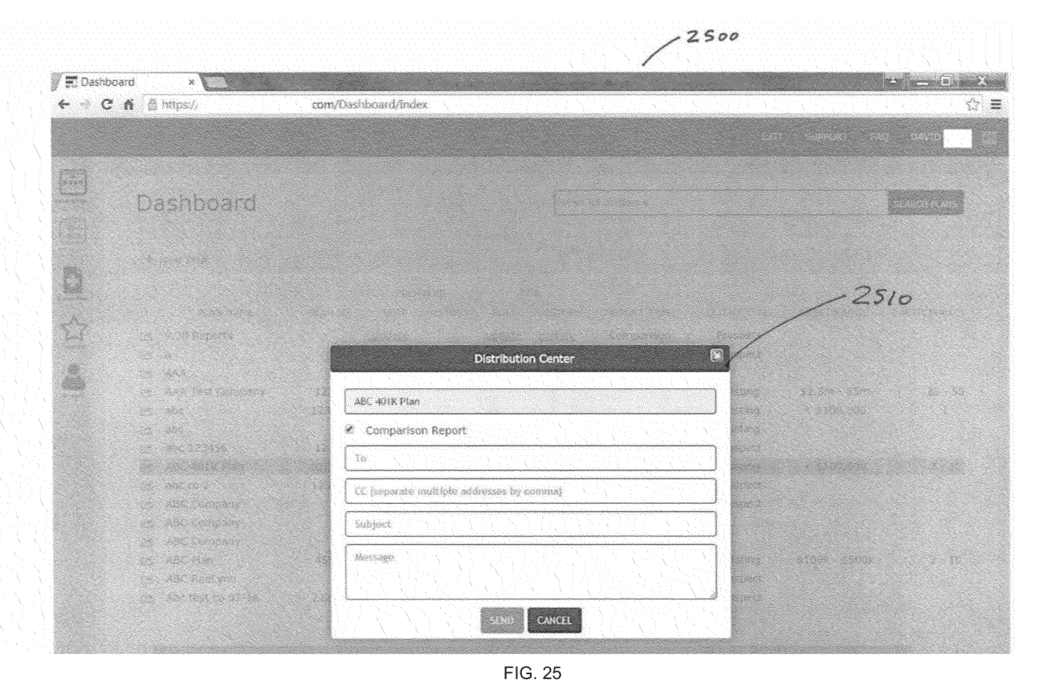

In some embodiments, the user can distribute one or more reports to contacts within the financial institution. For example, FIG. 25 illustrates a distribution screen 2500 generated by the target date analyzer server system and method in accordance with some embodiments of the invention. Using this feature, the user can be enabled with an option to email one or more reports. For example, using the window 2510, the user can select a distribution tab to proceed with the report distribution process.

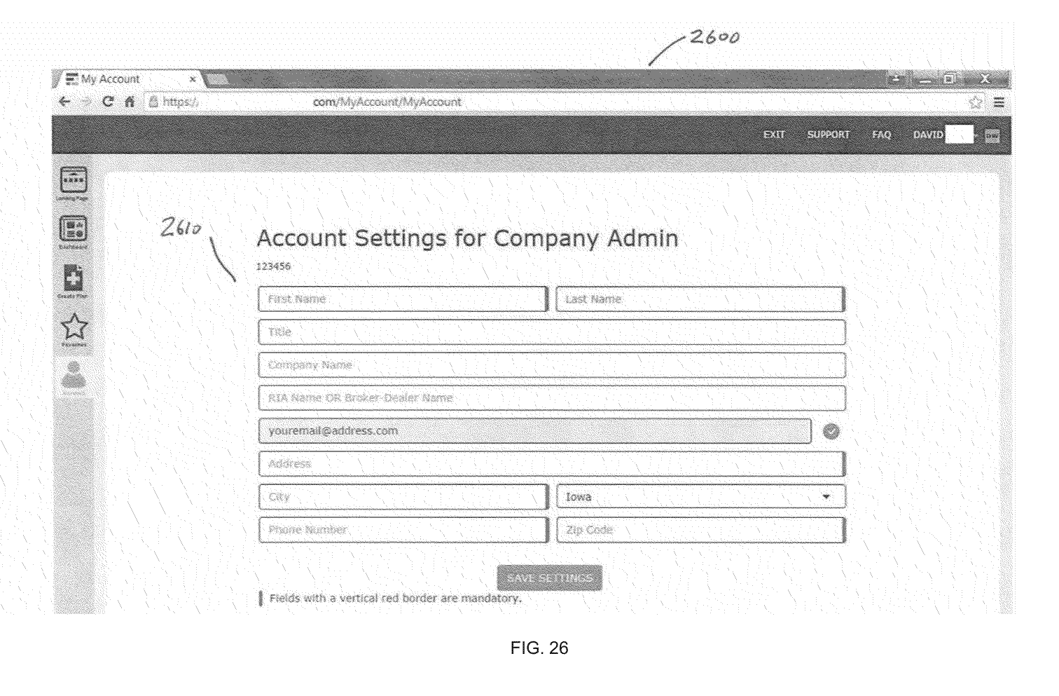

Some embodiments of the invention include the ability for the user to update account information. For example, FIG. 26 illustrates an account screen 2600 generated by the target date analyzer server system and method in accordance with some embodiments of the invention. From screen 2600, the user can be enabled to change and update name, address, and contact information using a plurality of account setting fields 2610.

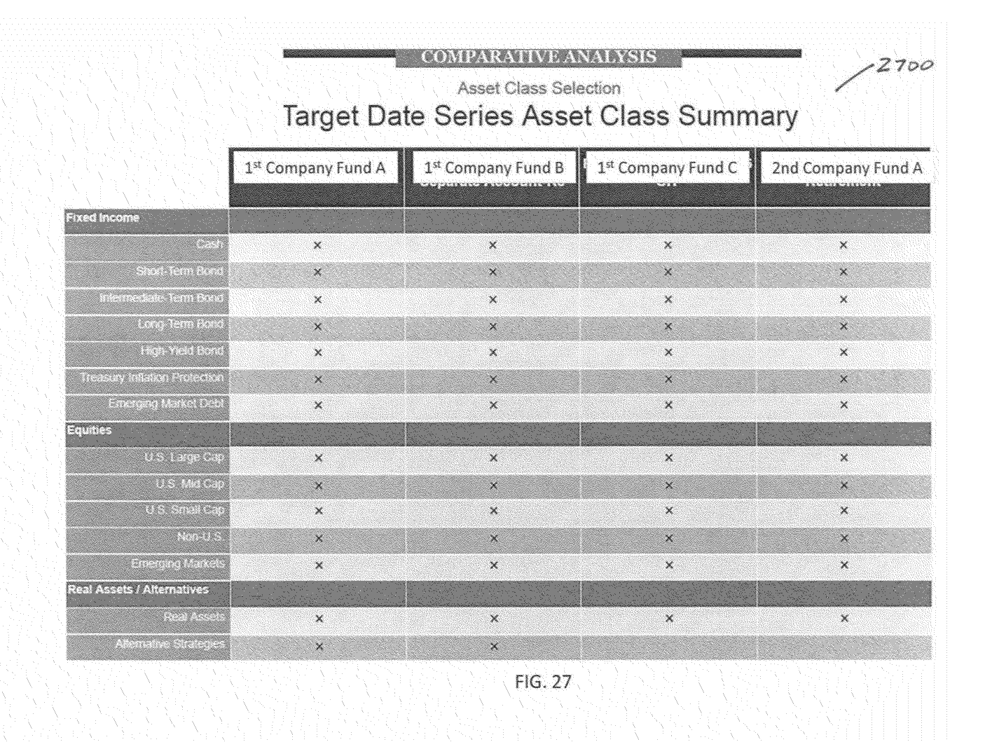

In some embodiments, the target date analyzer server system and method can create one or more target date comparison or investment analysis reports which can be stored in a non-transitory computer readable medium and/or printed or electronically shared. In some embodiments of the invention, the target date analyzer server system and method can calculate using at least one computer processor and display asset class reports as a function of asset class. The reports can include competitive analysis for prospecting, final presentations, or for evaluating new investment alternatives and/or for providing a monitoring report for an existing client or prospective client. In some embodiments, the user can use the target date analyzer to display charts showing asset class information for one or more competitor funds. As an example, in some embodiments of the invention, the target date analyzer server system and method can display an overall summary of at least one asset class selection. For example, FIG. 27 illustrates an asset class selection summary display screen 2700 generated by the target date analyzer server system and method in accordance with some embodiments of the invention. In some embodiments, where the user has selected a comparative analysis, the target date analyzer server system and method can display an overall summary comprising a legal name of a plurality of funds from one or more fund companies. As shown, the display screen can include a list of asset classes and asset sub-classes, with assets ticked if the specific fund holds the asset class or asset sub-class.

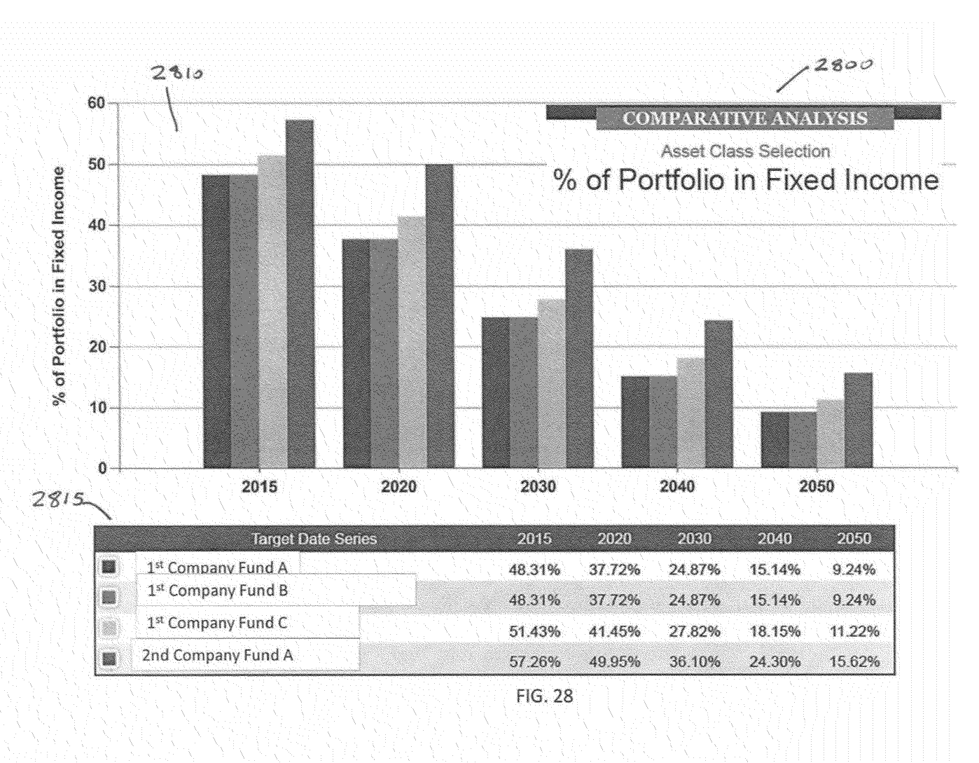

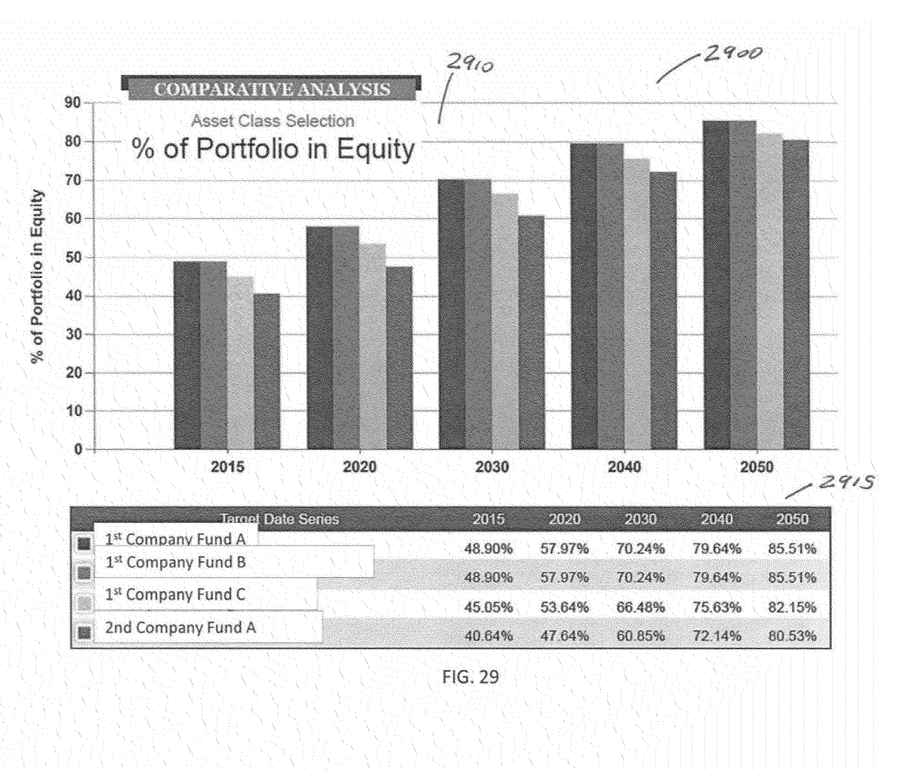

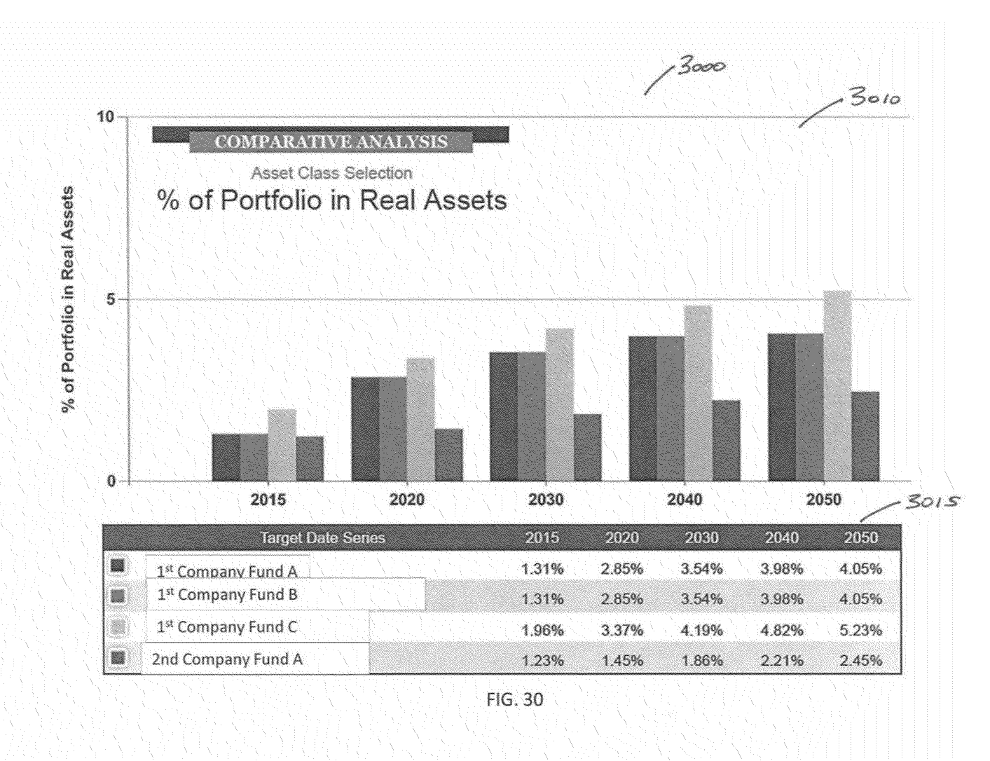

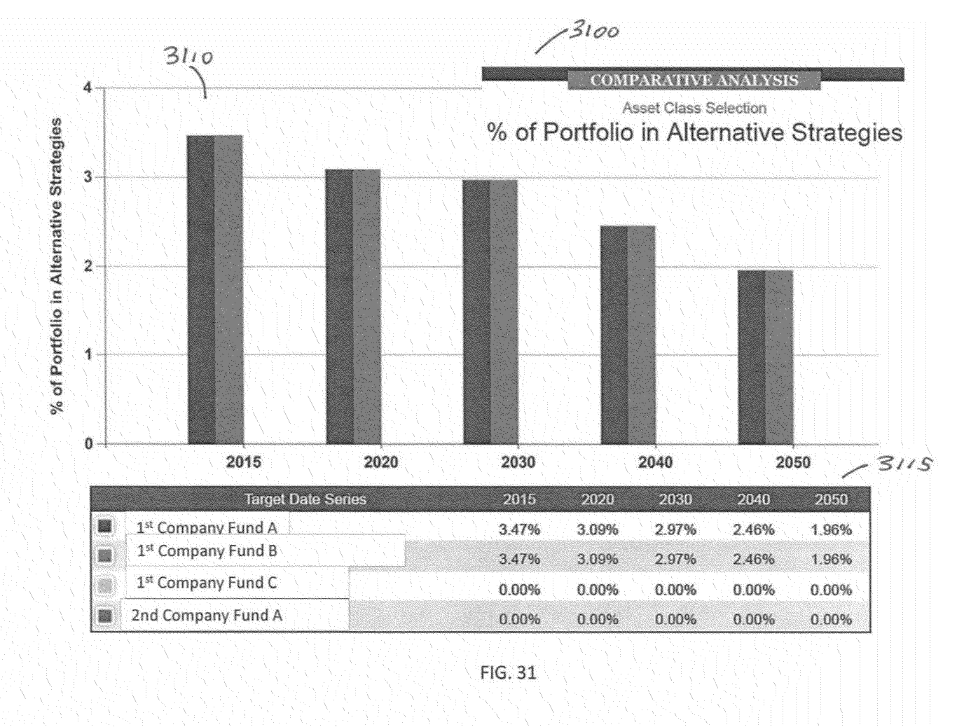

In some embodiments, the asset class information can display charts showing asset class information displayed as a fixed income percentage (FIG. 28). For example, comparative analysis screen 2800 illustrates a plot 2810 of the asset class selection as a percentage of the portfolio in fixed income versus target date, with table 2815 showing the data in a tabulated format. In some further embodiments, the asset class information can display charts showing asset class information displayed as an equity portfolio percentage (FIG. 29). For example, comparative analysis screen 2900 illustrates a plot 2910 of the asset class selection as a percentage of the portfolio in equity versus target date, with table 2915 showing the data in a tabulated format. In some other embodiments of the invention, the asset class information can display charts showing asset class information displayed as a real assets percentage (FIG. 30). For example, comparative analysis screen 3000 illustrates a plot 3010 of the asset class selection as a percentage of the portfolio in real assets versus target date, with table 3015 showing the data in a tabulated format. In some other embodiments, the asset class information can display charts showing asset class information displayed as percentage of the portfolio in alternative strategies (FIG. 31). For example, comparative analysis screen 3100 illustrates a plot 3110 of the asset class selection as a percentage of the portfolio in alternative strategies versus target date, with table 3115 showing the data in a tabulated format.

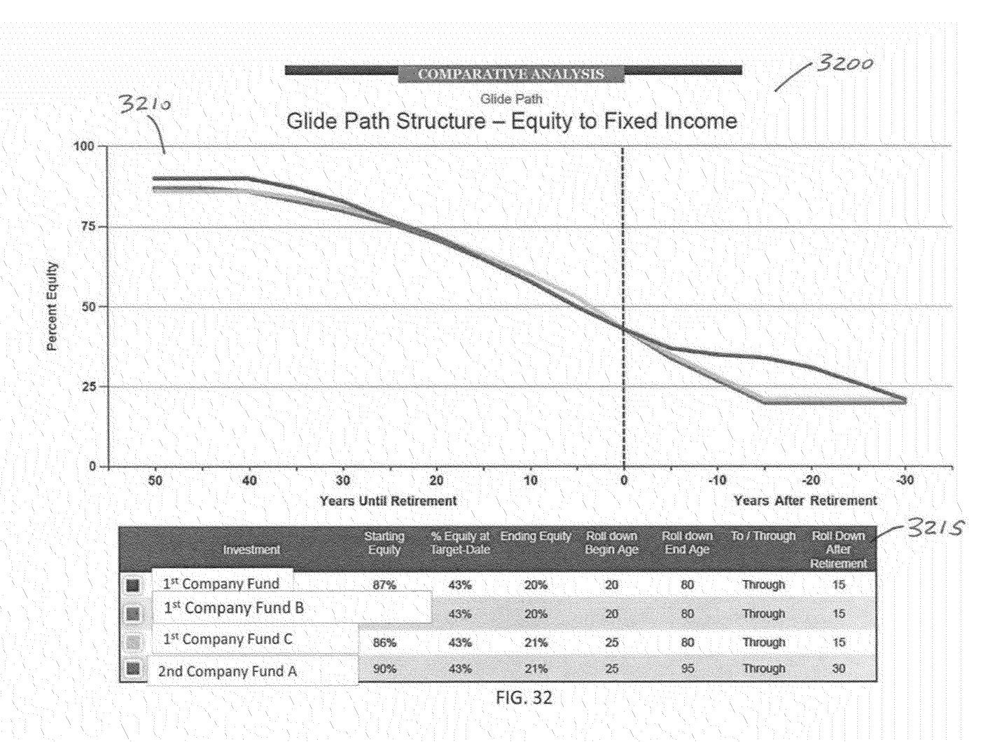

In some embodiments of the invention, the target date analysis can calculate using at least one computer processor and display a retirement glide path showing asset fund allocation as a function of years to retirement and/or years after retirement. For example, in some embodiments, the target date analyzer server system and method can calculate and display a glide path comprising a plot of asset classes over a period of time, and can save data relevant to the glide path display in a non-transitory computer readable medium and/or prepare and distribute the information to a display, or to a physical file or report. In some embodiments, the period of time can cover at least a period covering a client's number of years to retirement (i.e., years until retirement) and/or years after retirement. For example, FIG. 32 illustrates a glide path structure display 3200 generated by the target date analyzer server system and method, with plot 3210 showing the blend of fixed income to equity for a series of target date funds covering a period in years until retirement and a period covering years after retirement. In some embodiments, the data can also be displayed and viewed in a tabulated format using table 3215.

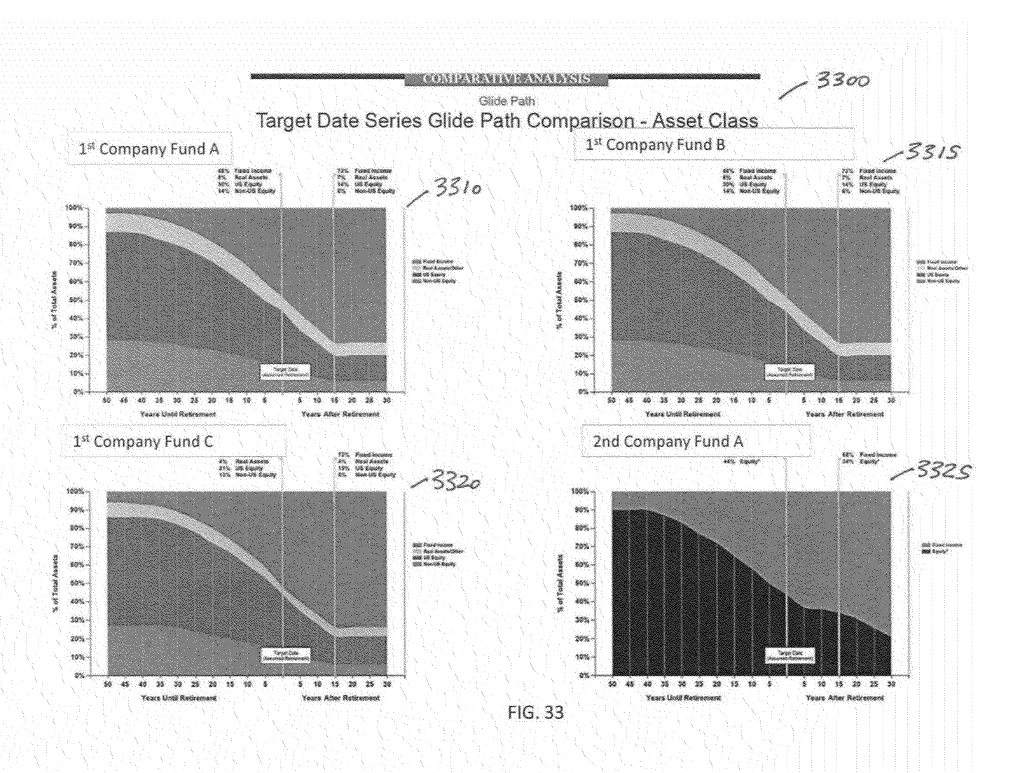

In some embodiments, the glide paths for multiple competitors can be viewed on separate charts or tables within the analysis and/or report within a single or multiple display screens. For example, FIG. 33 illustrates target date series glide path comparison display screen 3300 generated by the target date analyzer server system and method in accordance with some embodiments of the invention. As shown, in some embodiments, glide paths for four competitor target date funds can be compared on the same display screen (shown as plots 3310, 3315, 3320, and 3325). In some embodiments, this can enable a user to compare glide path approaches, enabling differences and similarities to be shown and compared, including differences in various asset class weightings such as US equity, non-US equity, fixed income, and real assets.

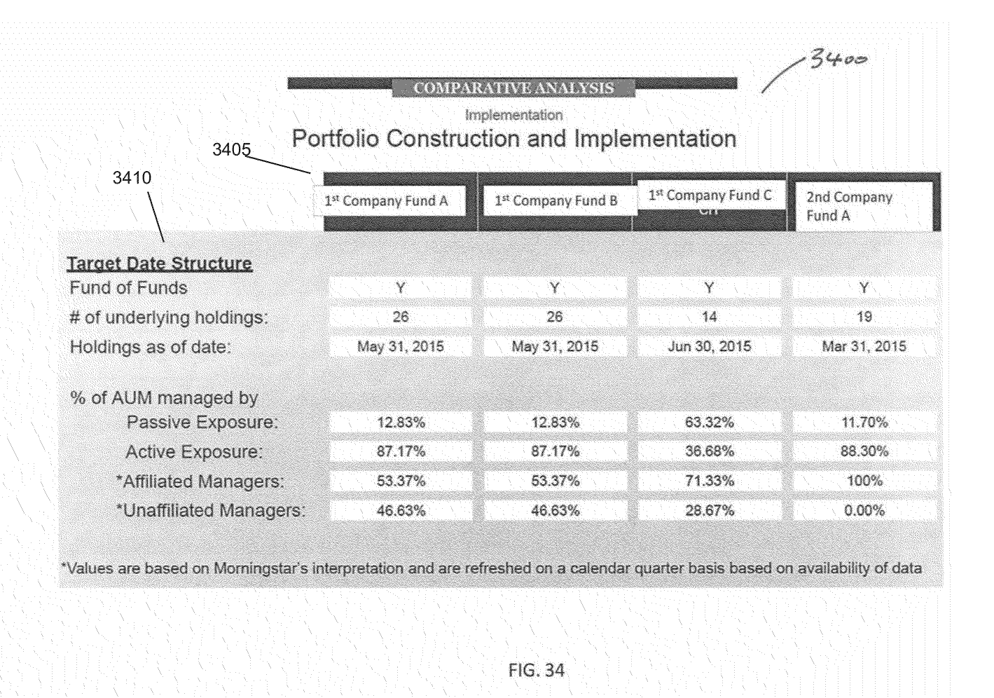

In some embodiments of the invention, the target date analyzer server system and method can display a portfolio construction and implementation summary of one or more competitor target date funds. For example, FIG. 34 illustrates a portfolio construction and implementation summary screen 3400 generated by the target date analyzer server system and method in accordance with some embodiments of the invention. In some embodiments, for one or more funds 3405, the target date analyzer can display the details of one or more target date fund structures (shown as 3410) including, but not limited to the number of underlying holdings, the percentage of passive exposure, the percentage of active exposure, the percentage of funds managed by affiliated managers, and the percentage of funds managed by unaffiliated managers.

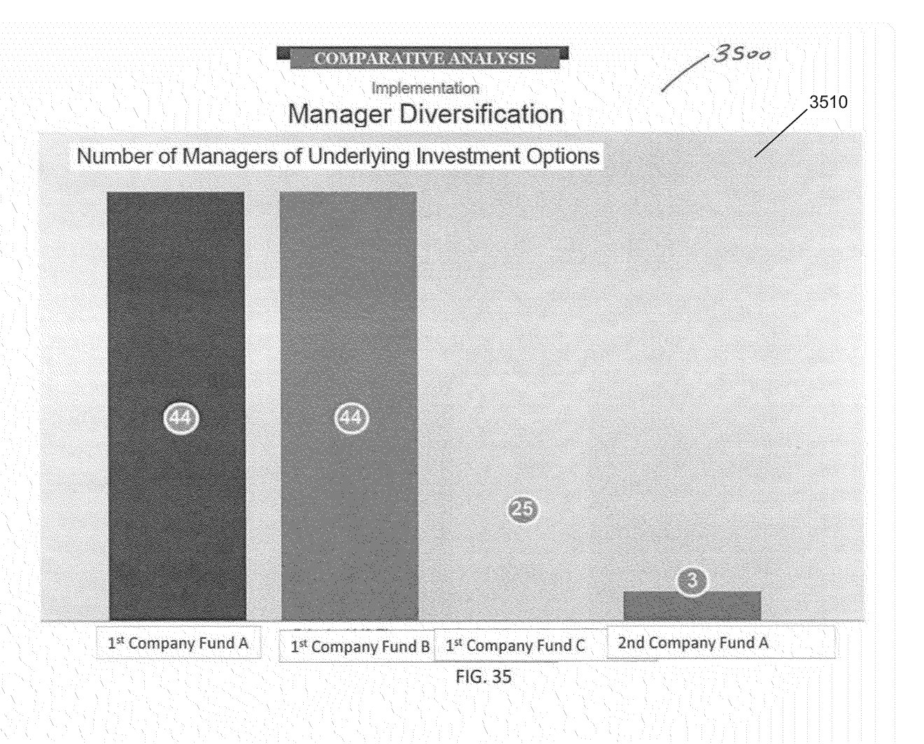

In some embodiments of the invention, the target date analyzer system and method can provide an analysis of fund manager diversification for one or more target date funds under consideration for a client's portfolio. For example, FIG. 35 illustrates a manager diversification display screen 3500 generated by the target date analyzer server system and method in accordance with some embodiments of the invention. In some embodiments, the target date analyzer system and method can display the number of managers of underlying investment options of one or more competitor funds (shown as plot 3510 as a function of fund).

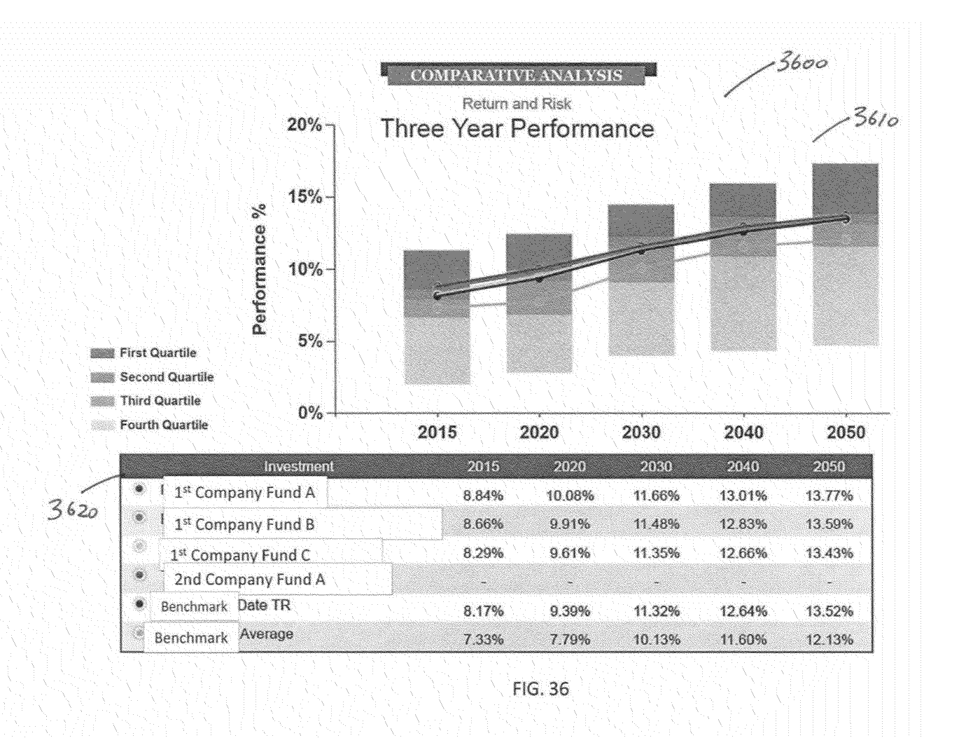

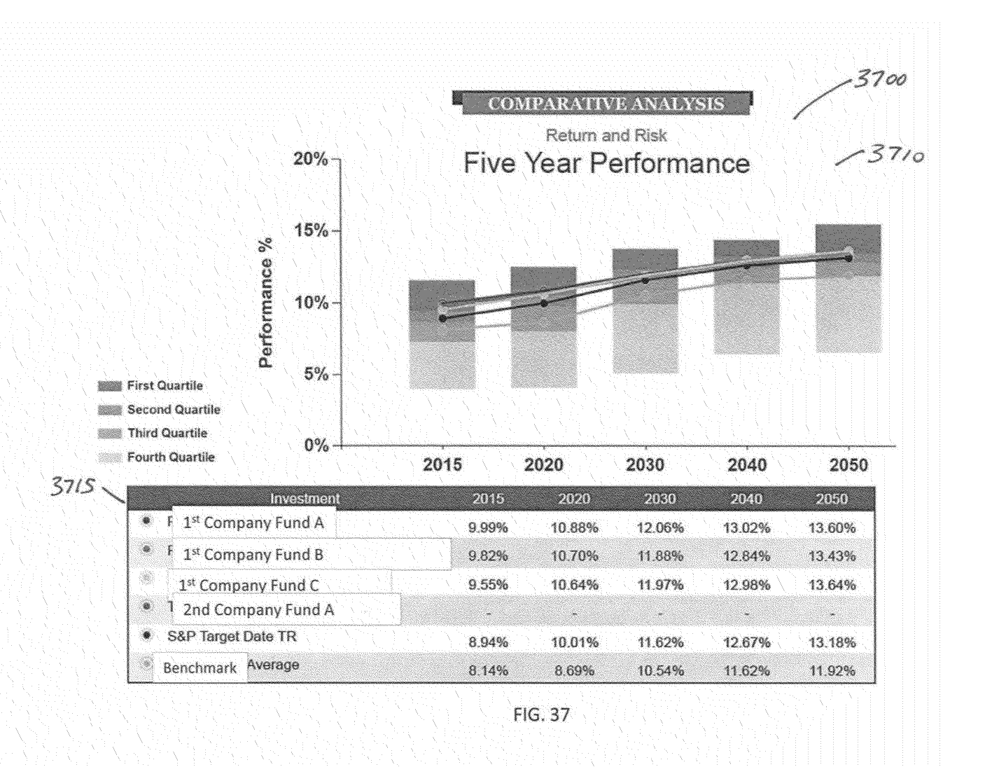

In some embodiments of the invention, the target date analyzer server system and method can display performance information for one or more competitor funds. For example, in some embodiments, the target date analyzer server system and method can display information comparing the investment return performance of one or more target date funds as a function of time and compared with an investment benchmark. In some embodiments, the investment benchmark can comprise one or more index return benchmarks. In other embodiments, the benchmark can comprise the investment return performance of one or more peer funds, or a group of peer funds. For example, FIG. 36 illustrates an example of a three year performance display screen 3600 generated by the target date analyzer server system and method, and FIG. 37 illustrates a five year performance display screen 3700 generated by the target date analyzer server system and method in accordance with some embodiments of the invention. As shown, in some embodiments, the target date analyzer server system and method can display a comparison of a plurality of target date series funds comparing percentage performance over various time periods. Further, the comparison can include financial data comprising a comparison of index target and a peer group target provided by a third party. For example, plot 3610 in the example embodiments of FIG. 36 includes a three year percentage performance as a function of time, and plot 3710 in the example embodiment of FIG. 37 includes a five year percentage performance. Further, tabulated data for performance is shown in tables 3620, 3715 in FIGS. 36, and 37 respectively.

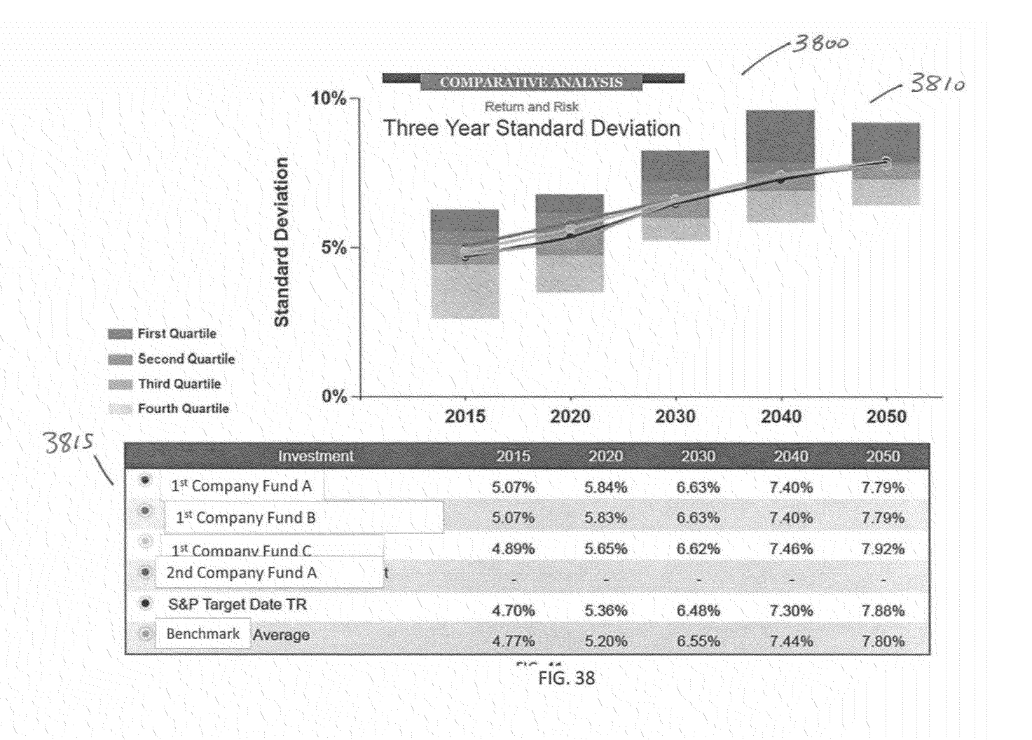

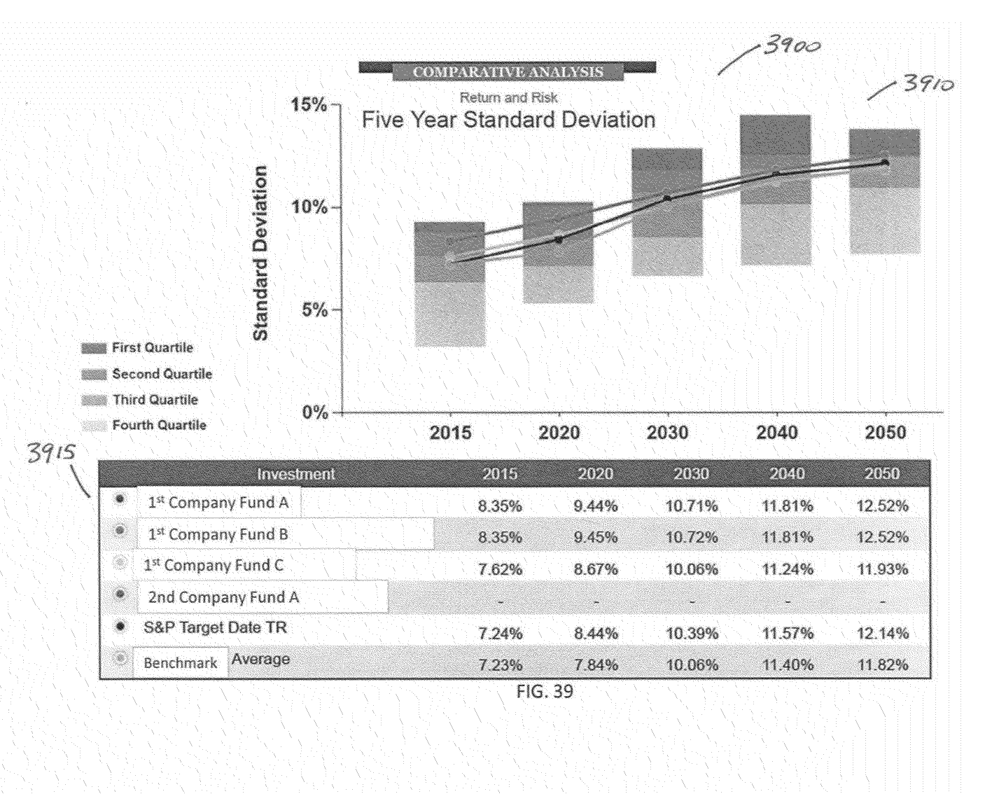

In some embodiments of the invention, the target date analyzer server system and method can display return and risk information for one or more competitor funds with comparisons to benchmarks. For example, in some embodiments, the target date analyzer server system and method can display information comparing the investment risk of one or more target date funds as a function of time and compared with an investment benchmark. In some embodiments, the investment benchmark can comprise one or more index return benchmarks. In other embodiments, the benchmark can comprise the total investment risk of one or more peer funds, or a group of peer funds. For example, FIG. 38 illustrates a three year standard deviation display screen 3800 generated by the target date analyzer server system and method, and FIG. 37 illustrates a five year standard deviation display screen 3900 generated by the target date analyzer server system and method in accordance with some embodiments of the invention. As shown, in some embodiments, the target date analyzer server system and method can display a comparison of a plurality of funds comparing percentage performance over various time periods. Further, the comparison can include a comparison of financial data including index target and a peer group target provided by a third party. For example, plot 3810 includes three year standard deviation performance as a function of time, and plot 3910 includes a five year standard deviation, while tabulated standard deviation data is shown in tables 3815, 3915. In some embodiments, the standard deviation can be defined as, “A statistical measurement of dispersion about an average, which, for a mutual fund, depicts how widely the returns varied over the past three years. Investors use the standard deviation of historical performance to try to predict the range of returns that are most likely for a given fund. When a fund has a high standard deviation, the predicted range of performance is wide, implying greater volatility. Standard deviation is most appropriate for measuring risk if it is for a fund that is an investor's only holding. The figure cannot be combined for more than one fund because the standard deviation for a portfolio of multiple funds is a function of not only the individual standard deviations, but also of the degree of correlation among the funds' returns. If a fund's returns follow a normal distribution, then approximately 68 percent of the time they will fall within one standard deviation of the mean return for the fund, and 95 percent of the time within two standard deviations. Morningstar® computes standard deviation using the trailing monthly total returns for the appropriate time period. All of the monthly standard deviations are then annualized.”

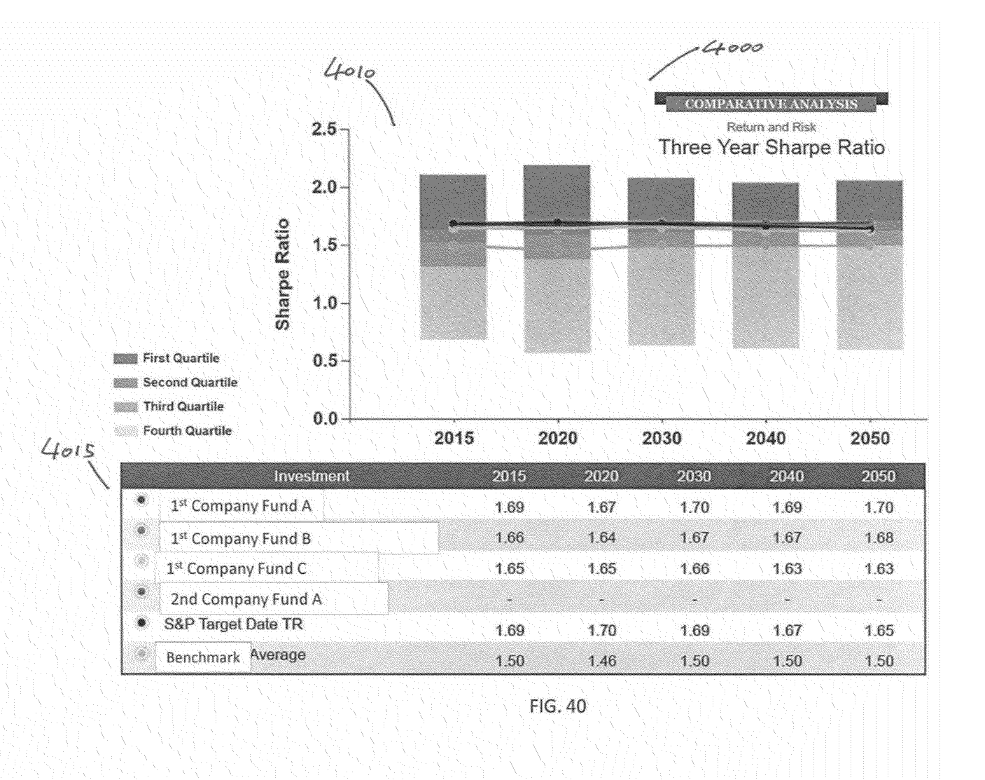

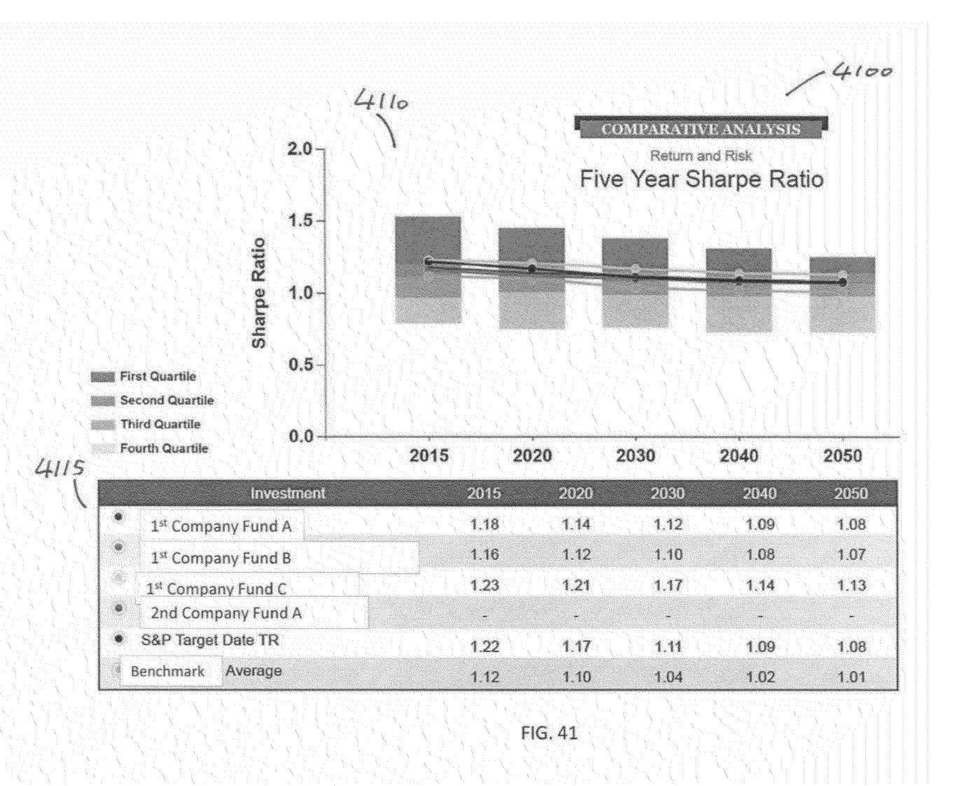

In other embodiments of the invention, the benchmark can comprise the total investment risk of one or more peer funds, or a group of peer funds defining a Sharpe ratio analysis. In some embodiments, the Sharpe ratio can be defined as calculated by using standard deviation and excess return to determine reward per unit of risk. The higher the Sharpe ratio, the better the fund's historical risk-adjusted performance. The Sharpe ratio can be calculated for the past 12-month period by dividing a fund's annualized excess returns by the standard deviation of a fund's annualized excess returns. Since this ratio uses standard deviation as its risk measure, it is most appropriately applied when analyzing a fund that is an investor's sole holding. The Sharpe Ratio can be used to compare two funds directly on how much risk a fund had to bear to earn excess return over the risk-free rate. For example, FIG. 40 illustrates a three year standard deviation display screen 4000 generated by the target date analyzer server system and method, and FIG. 41 illustrates a five year standard deviation display screen 4100 generated by the target date analyzer server system and method in accordance with some embodiments of the invention. As shown, in some embodiments, the target date analyzer server system and method can display a comparison of a plurality of funds comparing percentage performance over various time periods. Further, the comparison can include a comparison of financial data including index target and a peer group target provided by a third party. For example, plot 4010 includes three year standard deviation performance as a function of time, and plot 4110 includes a five year standard deviation, while tabulated data standard deviation data is shown in tables 4015, 4015.

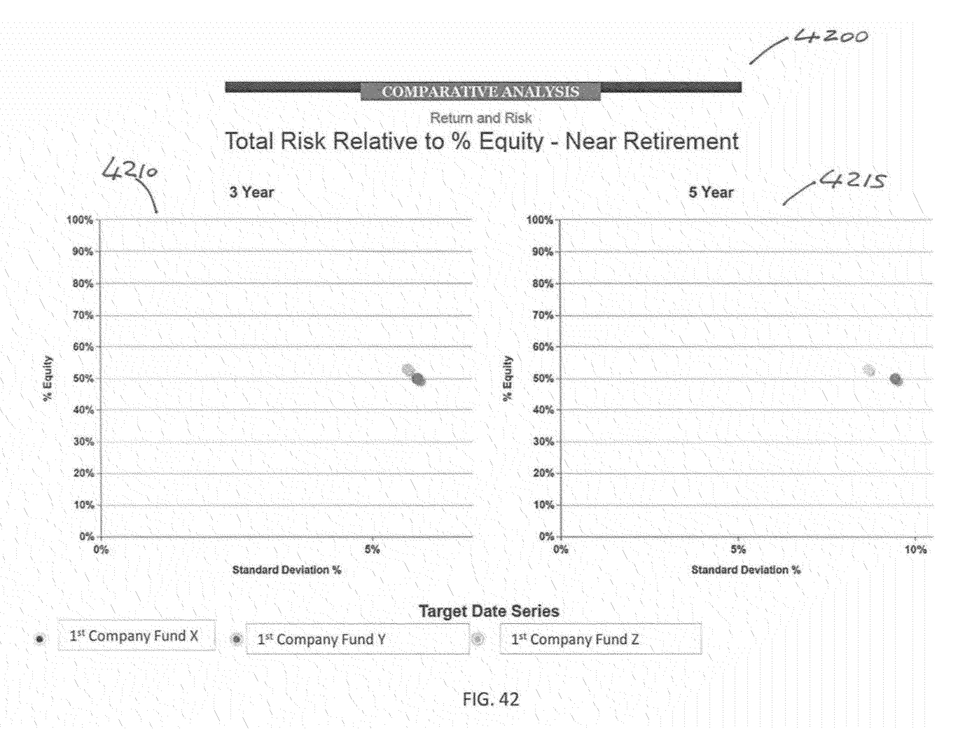

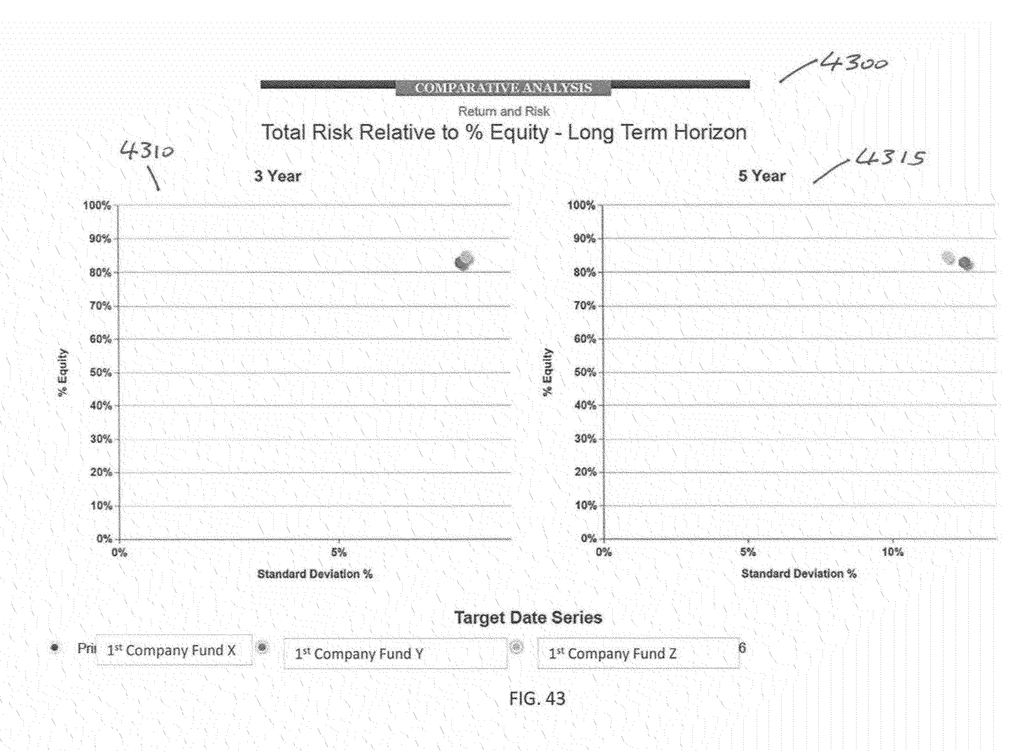

FIGS. 42-43 show display screens generated by the target date analyzer server system and method that illustrate total risk data comparisons in accordance with some embodiments of the invention. As shown, in some embodiments, the target date analyzer server system and method can display a comparison of the total risk of a plurality of target date series funds comparing total risk over various time periods. Further, the comparison can include a comparison of financial data including index target risk provided by a third party. In some further embodiments of the invention, the target date analyzer server system and method can calculate (using at least one computer processor) and store and/or display a total risk relative to percentage of equity of one or more target date funds. For example, as shown in the display screen 4200 of FIG. 42, in some embodiments, the target date analyzer server system and method can display total risk as a standard deviation as a function of a plurality of funds for three year (plot 4210) and five year (plot 4215) periods, using one or more funds representing a ‘near retirement’ period for one or more clients. In some further embodiments, the fund analysis can comprise a longer term retirement horizon analysis (shown in the display screen 4300 of FIG. 43 illustrating plot 4310 for three years and plot 4315 for five years.)

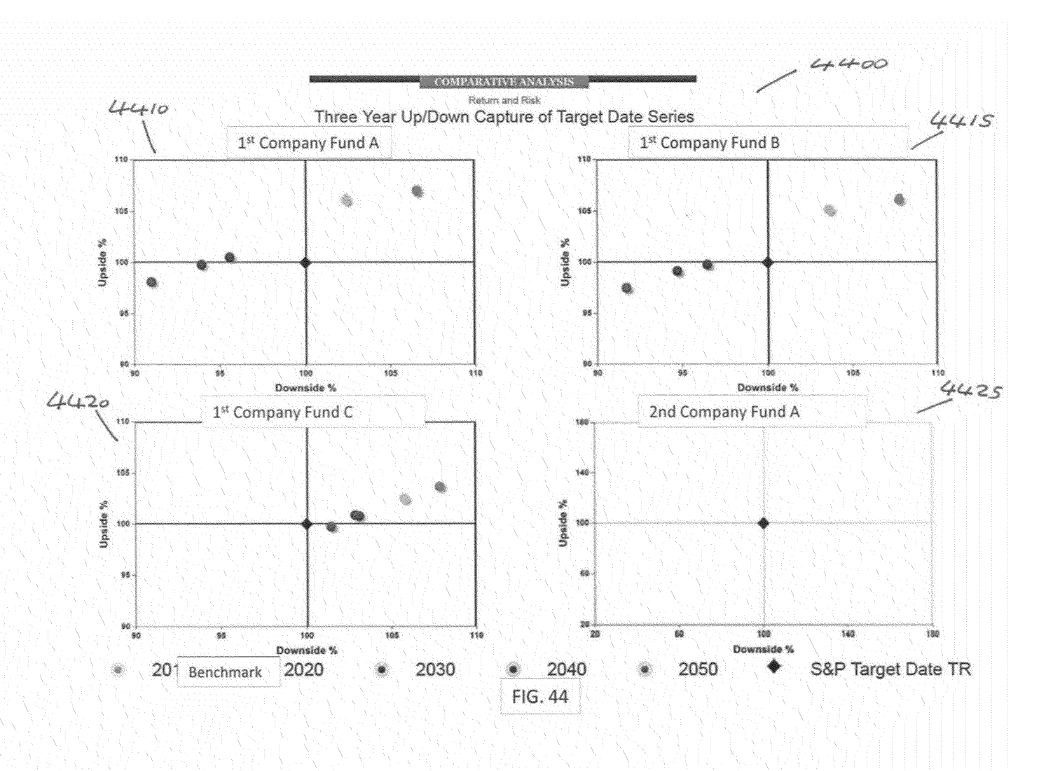

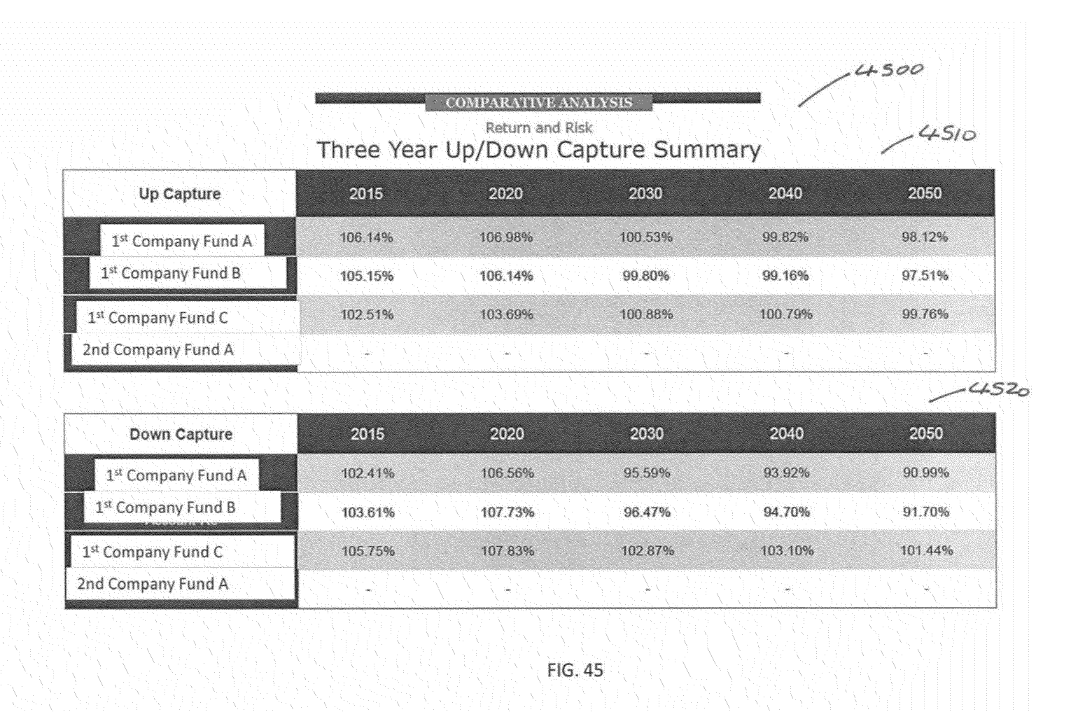

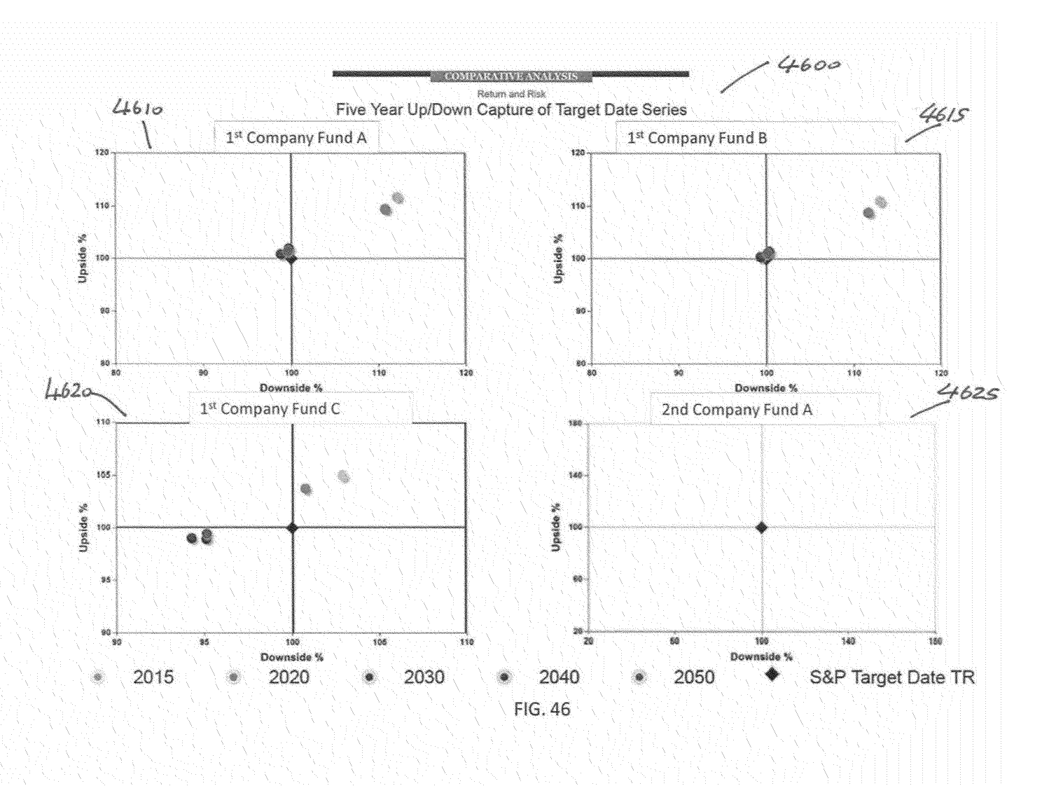

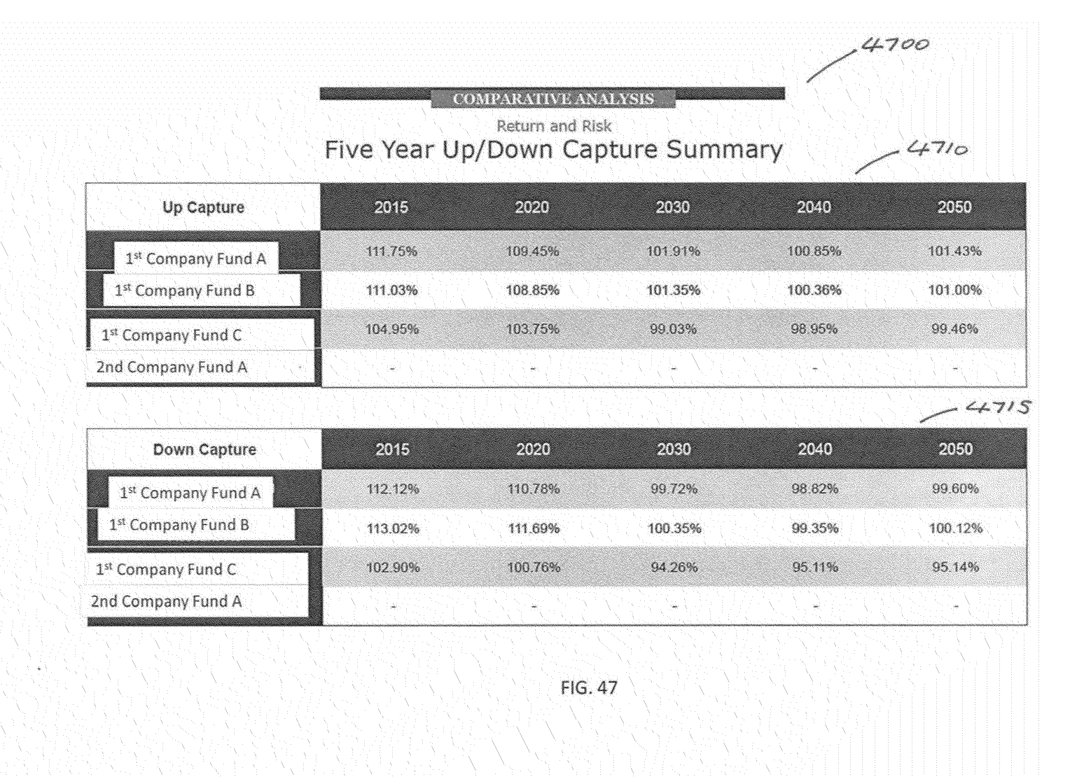

In some embodiments, the target date analyzer server system and method can calculate and display an up/down capture analysis of at least one target date fund. In some embodiments, the target date analyzer server system and method can calculate and display an up/down capture analysis plot of one or more target date funds as a function of time. In some embodiments, the up/down analysis can comprise a downside percentage and upside percentage analysis of one or more funds with specific target retirement dates. For example, FIG. 44 illustrates a display screen 4400 generated by the target date analyzer server system and method showing plots 4410, 4415, 4420, 4425 of three year up/down capture of a plurality of target date investment funds in accordance with some embodiments of the invention. The return and risk three year up/down capture summary is shown in FIG. 45, with table 4510 showing up capture data for a plurality of funds, and table 4520 showing down capture data for a plurality of funds. Further, FIG. 46 illustrates a display screen 4600 generated by the target date analyzer server system and method, and shows plots 4610, 4615, 4620, 4625 of five year up/down capture of target date investment funds in accordance with some embodiments of the invention. The return and risk five year up/down capture summary is shown in FIG. 47, with table 4710 showing up capture data for a plurality of funds, and table 4720 showing down capture data for a plurality of funds.

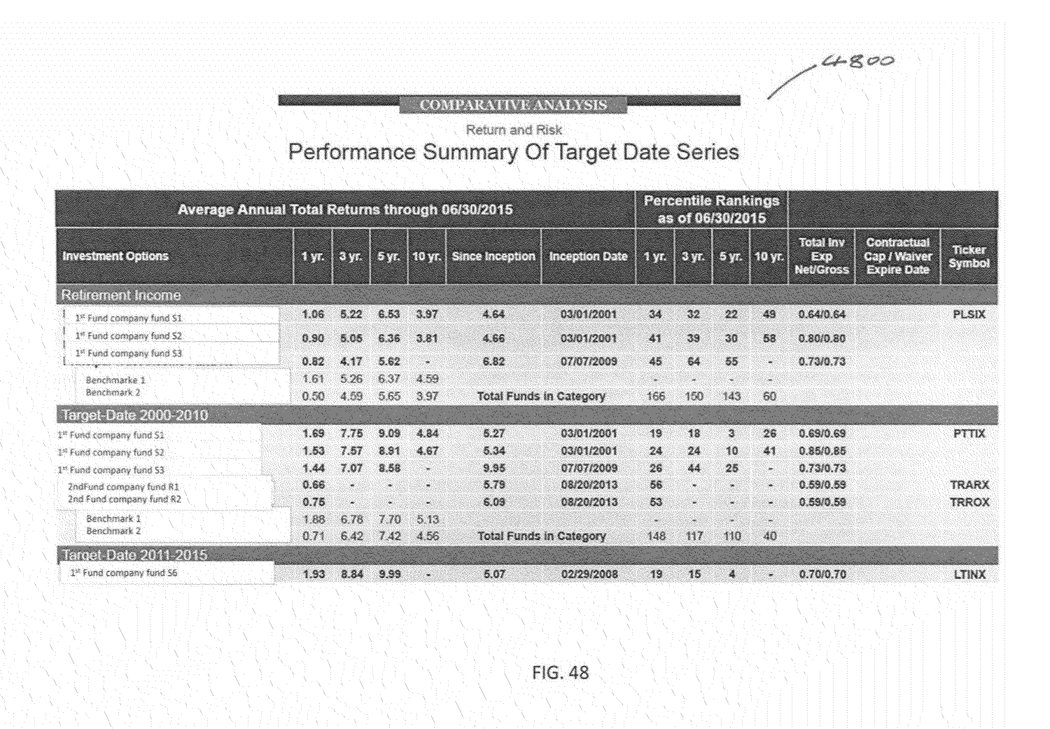

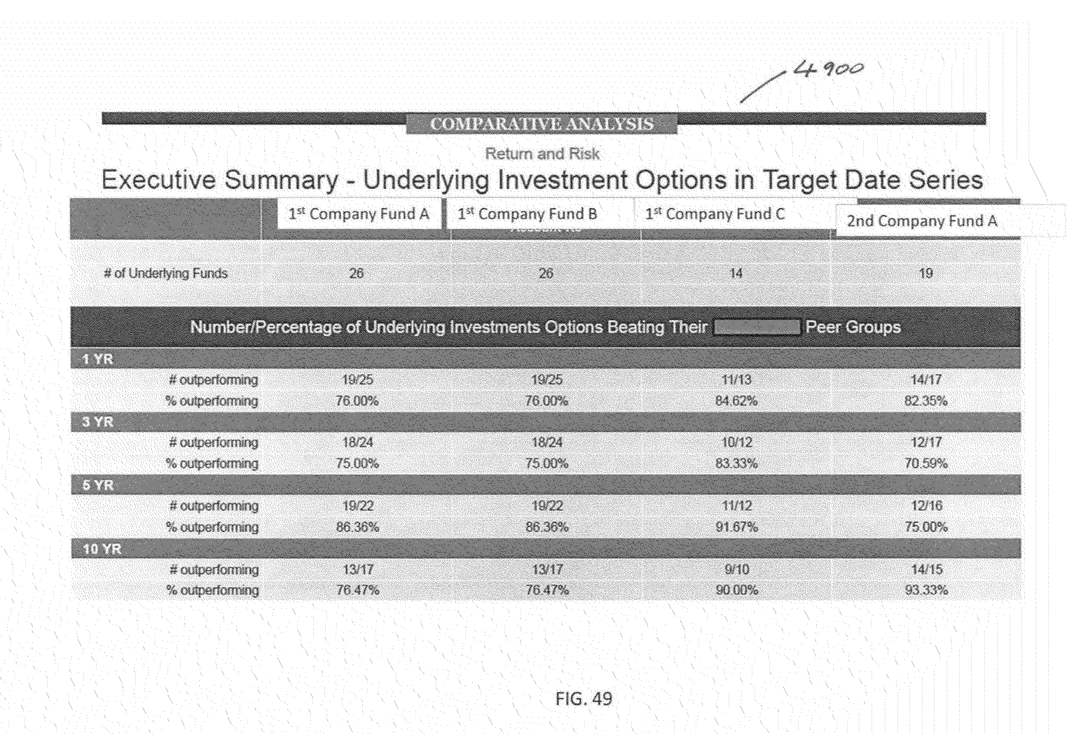

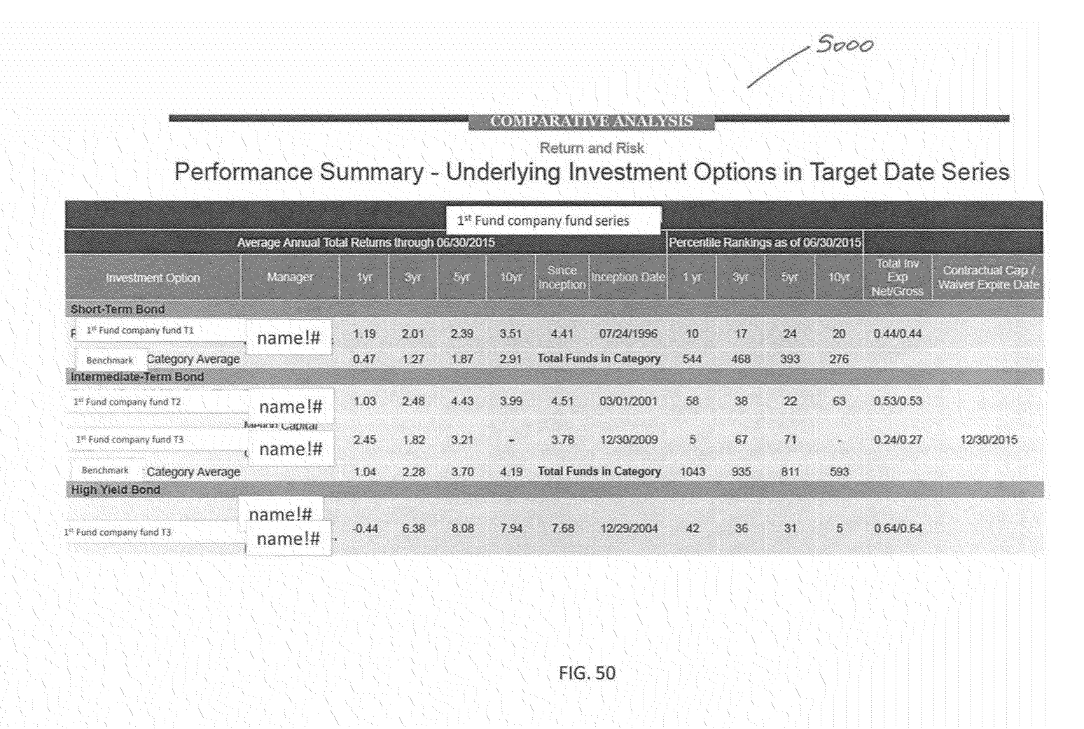

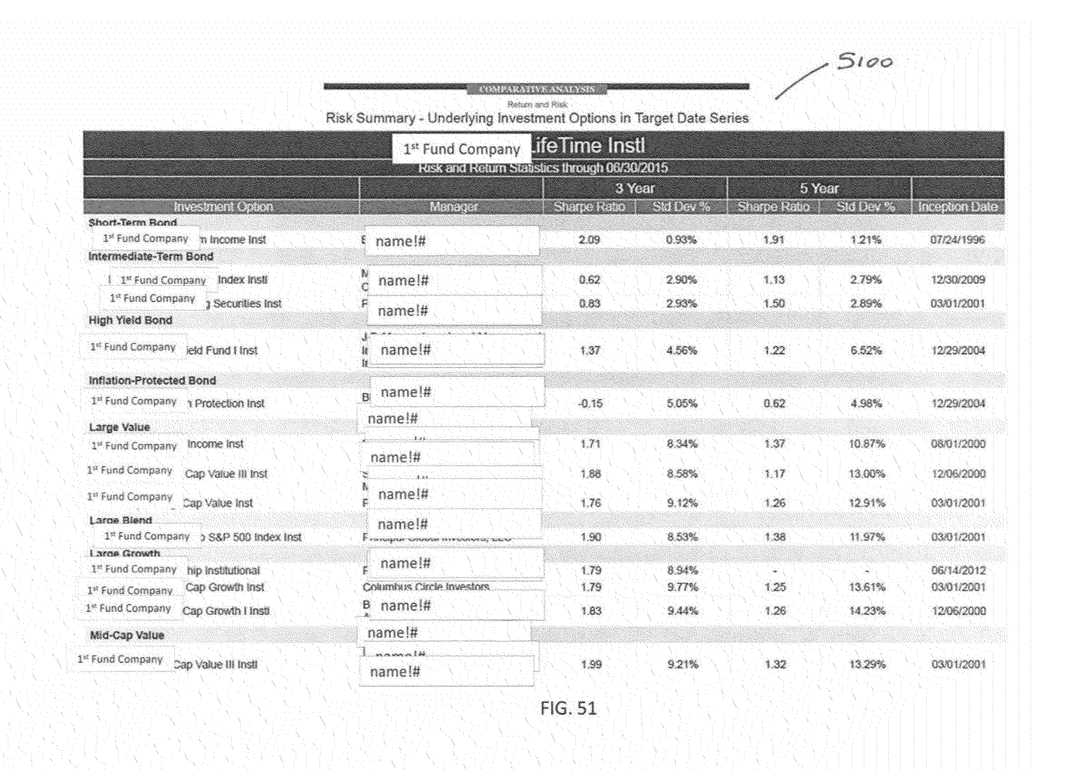

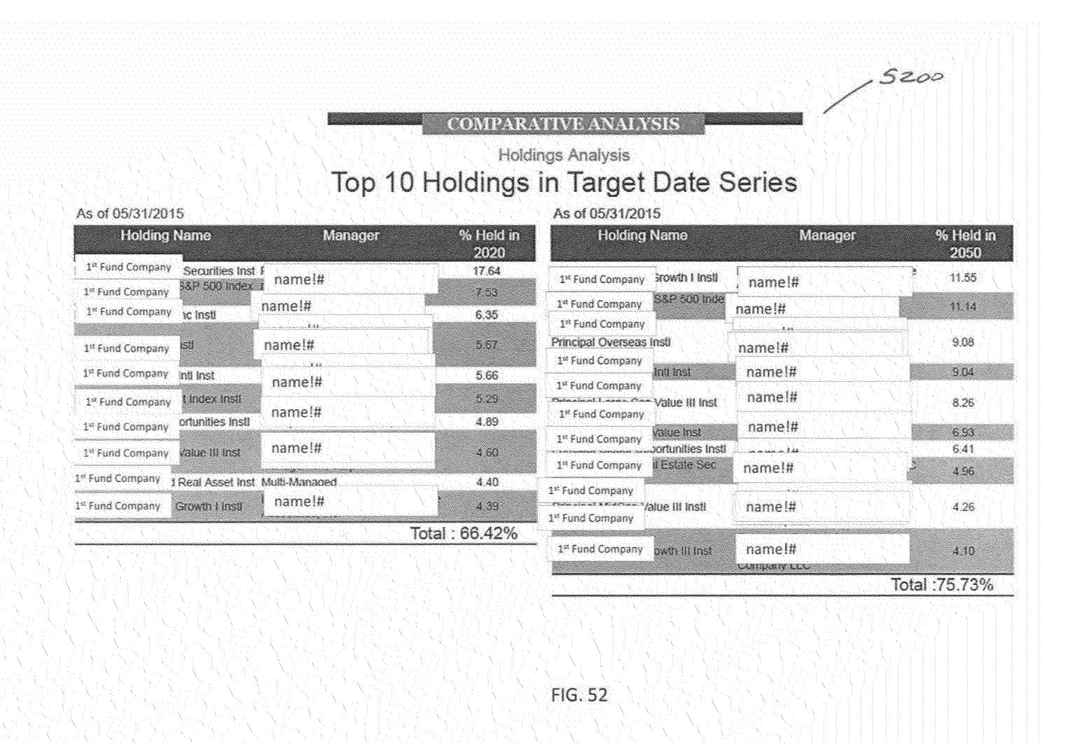

Some embodiments include a comparative risk and return analysis of target data funds and performance of the underlying investment options in a target date series of funds. FIG. 48 illustrates a performance summary screen 4800 of target date investments generated by the target date analyzer server system and method in accordance with some embodiments of the invention. In some embodiments, the performance summary display in screen 4800 can include performance data for a plurality of funds including target date funds. The analysis can display return information based on the funds target retirement date, with performance over 1 year, 3 year, 5 year, 10 year, and since inception date. In some other embodiments of the invention, the target date analyzer server system and method can calculate and display an executive summary of one or more funds including target date funds. For example, FIG. 49 illustrates an executive summary screen 4900 of fund investments generated by the target date analyzer server system and method in accordance with some embodiments of the invention. In some further embodiments, the screen 4900 can include the number and/or percentage of underlying investment options and their performance related to a peer group of other funds, including client funds. In some further embodiments, the executive summary can comprise risk and return statistics over a period of time including Sharpe ratio and standard deviation over at least one time period (e.g., over a three year and/or five year period). In some embodiments of the invention, the target date analyzer can display information related to one or more assets of one or more of the aforementioned fund options. For example, FIGS. 50-51 illustrate further examples of underlying investment analysis screens 5000, 5100 generated by the target date analyzer server system and method in accordance with some embodiments of the invention. In some embodiments, the analysis can comprise data showing the performance of the underlying investment options (FIG. 50). Further, in some embodiments, the display can comprise a risk summary of a fund comparing the Sharpe ratio and the standard deviation of the fund (FIG. 51). Further, in some embodiments, the asset analysis can include an analysis of individual holdings. In some embodiments, the display screen can comprise information detailing the top ten holdings of one or more funds in a target date series. For example, FIG. 52 shows a display screen 5200 generated by the target date analyzer server system and method, and includes a top ten holdings analysis of target date series funds. This information can include the holding name, the manager of the holding, and the percentage at a specific target date.

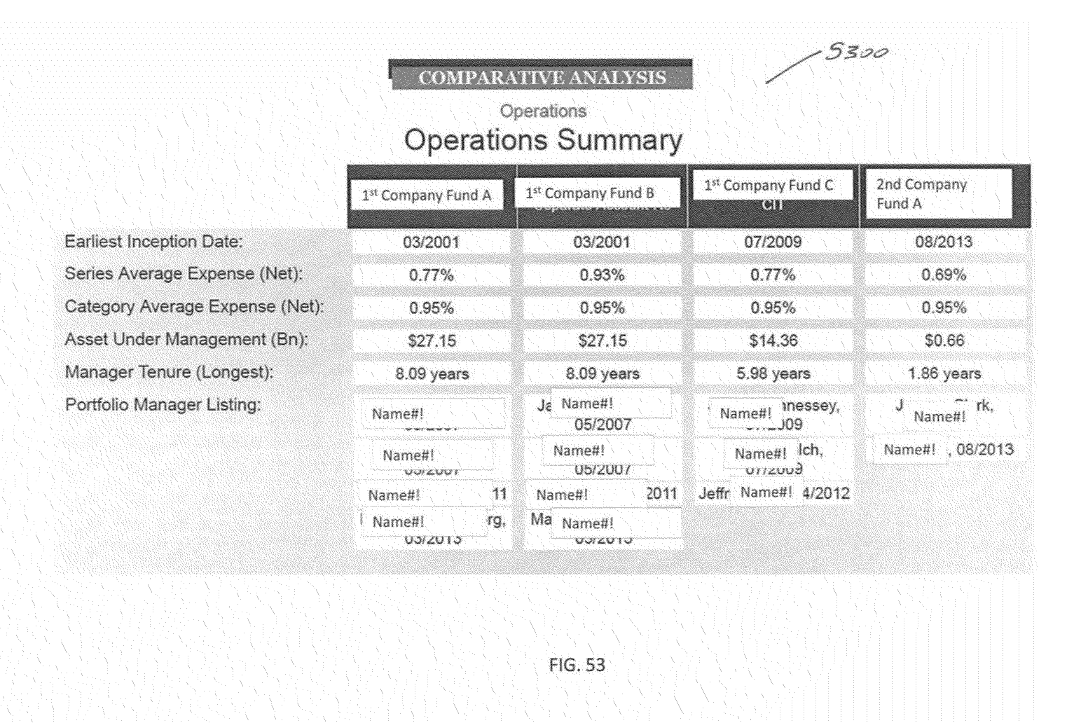

Some embodiments include a fund operations summary analysis. For example, FIG. 53 illustrates an operations summary display screen 5300 generated by the target date analyzer server system and method in accordance with some embodiments of the invention. As shown, in some embodiments, the operations summary of display screen 5300 can comprise information including inception date, average expense, category expense, assets under management, and manager information. In some embodiments, the manager information can comprise portfolio manager, manager tenure. Further, in some embodiments, the long-term objective can be displayed.

In some embodiments, any of the asset classes and types that can be used by the target date analyzer server system and method in any of the processes, analysis, reports and displays described herein can include fixed income type assets and/or cash, and can include short term bonds, United States taxable bonds, short/high quality funds, United States taxable bond (short and/or medium quality bonds or bond funds), intermediate term bonds, United States taxable bond (intermediate and/or medium quality bonds or bond funds), long term bonds, United States taxable bond (long/high quality bonds or bond funds), high yield bonds, United States taxable bond (short/low quality bonds or bond funds), United States taxable bond (intermediate and/or low quality bonds or bond funds), United States taxable bond (long/low quality bonds or bond funds), United States taxable bond (unclassified style bonds or bond funds), treasury inflation protected securities, United States inflation protected bonds (short/high quality), United States inflation protected bonds or bond funds (intermediate and/or high quality), United States inflation protected bonds or bond funds (long/high quality), United States inflation protected bonds or bond funds (unclassified style), global bonds or bond funds).

In some further embodiments, any of the asset classes and types that can be used by the target date analyzer server system and method in any of the processes, analysis, reports and displays described herein can include non-United States or foreign fixed income as reflected in the following sub-asset classes; United States non-taxable bonds or bond funds (intermediate and/or high quality), United States non-taxable bonds or bond funds (long/high quality), United States non-taxable bonds or bond funds (short and/or medium quality), United States non-taxable bonds or bond funds (intermediate and/or medium quality), United States non-taxable bonds or bond funds (long/med quality), United States non-taxable bonds or bond funds (short/low quality), United States non-taxable bonds or bond funds (intermediate and/or low quality), United States non-taxable bonds or bond funds (long/low quality), United States non-taxable bonds or bond funds (unclassified style), emerging market bonds or bond funds, non-United States or foreign emerging bonds or bond funds (short/high quality), non-United States or foreign emerging bonds or bond funds(intermediate and/or high quality), non-United States or foreign emerging bonds or bond funds (long/high quality), non-United States or foreign emerging bonds or bond funds (short and/or medium quality), non-United States or foreign emerging bonds or bond funds (intermediate and/or medium quality), non-United States or foreign emerging bonds or bond funds (long/med quality), non-United States or foreign emerging bonds or bond funds (short/low quality), non-United States or foreign emerging bonds or bond funds (intermediate and/or low quality), non-United States or foreign emerging bonds or bond funds (long/low quality), non-United States or foreign emerging bonds or bond funds (unclassified style).

Some further embodiments include any of the asset classes and types that can be used by the target date analyzer server system and method in any of the processes, analysis, reports and displays described herein can include equity or equity funds comprising United States stock large cap value, United States stock large cap value/core, United States stock large cap core/growth, United States stock large cap growth, United States stock mid cap value, United States stock mid cap value/core, United States stock mid cap core/growth, United States stock mid cap growth, United States stock small cap value, United States stock small cap value/core, United States stock small cap core/growth, and United States stock small cap growth.

In some embodiments, any of the asset classes and types that can be used by the target date analyzer server system and method in any of the processes, analysis, reports and displays described herein can include non-United States or foreign equities (developed), non-United States or foreign developed stock large cap value, non-United States or foreign developed stock large cap value/core, non-United States or foreign developed stock large cap core/growth, non-United States or foreign developed stock large cap growth, non-United States or foreign developed stock mid cap value stock, non-United States or foreign developed stock mid cap value/core, non-United States or foreign developed stock mid cap core/growth, non-United States or foreign developed stock mid cap growth, non-United States or foreign developed stock small cap value, non-United States or foreign developed stock small cap value/core, non-United States or foreign developed stock small cap core/growth, non-United States or foreign developed stock small cap growth.

In some further embodiments of the invention, any of the asset classes and types that can be used by the target date analyzer server system and method in any of the processes, analysis, reports and displays described herein can include non-United States or foreign developed stock style (unclassified), emerging markets, non-United States or foreign emerging stock large cap value, non-United States or foreign emerging stock large cap value/core, non-United States or foreign emerging stock large cap core/growth, non-United States or foreign emerging stock large cap growth, non-United States or foreign emerging stock mid cap value, non-United States or foreign emerging stock mid cap value/core, non-United States or foreign emerging stock mid cap core/growth, non-United States or foreign emerging stock mid cap growth, non-United States or foreign emerging stock small cap value, non-United States or foreign emerging stock small cap value/core, non-United States or foreign emerging stock small cap core/growth, non-United States or foreign emerging stock small cap growth, non-United States or foreign emerging stock style unclassified.

In some other embodiments, any of the asset classes and types that can be used by the target date analyzer server system and method in any of the processes, analysis, reports and displays described herein can include, real assets/alternatives, real-estate investment trusts, United States real estate stock large cap value, United States real estate stock large cap value/core, United States real estate stock large cap core/growth, United States real estate stock large cap growth, United States real estate stock mid cap value, United States real estate stock mid cap value/core, United States real estate stock mid cap core/growth, United States real estate stock mid cap growth, United States real estate stock small cap value, United States real estate stock small cap value/core, United States real estate stock small cap core/growth, United States real estate stock small cap growth, United States real estate stock style unclassified, and commodities. In some embodiments, alternatives can include bear market trades, multicurrency trades, single currency trades, long/short equity trading, market neutral trading, mult-alternative type trading, managed futures trading, volatility trading, trading leveraged commodities, trading inverse commodities, trading leveraged debt, trading inverse debt, trading leveraged equity, trading inverse equity, or various combinations thereof.

In some embodiments, any of the asset classes and types that can be used by the target date analyzer server system and method in any of the processes, analysis, reports and displays described herein can include open or closed architectures. Funds and fund series with open architecture are those that include at least some sub-advisors or management teams that are not owned or controlled by the series' advisor. Conversely, the series that include managers and funds run solely by the advisor or its affiliates have some or all of the assets in a closed architecture. To determine the percentage of the series' assets run by the advisor's managers, the target date analyzer server system and method looks at the target date funds' underlying holdings. In most cases, these underlying holdings are mutual funds. If all of those underlying holdings are run by managers owned or controlled by the series' advisor, the target date analyzer server system and method designates the series as 100% closed architecture. If a portion of the assets are run by sub-advisors or managers not owned or controlled by the series' advisor, the target date analyzer server system and method sums the assets under such management across all of the funds in the series and divides by the series' total assets to determine the percentage of assets earmarked for open architecture.

FIG. 54 illustrates a computer system 5400 useful for performing operations of the target date analyzer system and method in accordance with some embodiments of the invention. For example, in some embodiments, using one or more software modules, the computer system 5400 can display information related to target date investments within a graphical user interface including investment research and analysis, investment plan management, investment plans creation, plan report creation, or administrative and/or account updates processes. In do so, the computer system 5400 can interact with and exchange information with at least one user using at least one peripheral or input/output device such as a mouse, keyboard, display, and/or touch-screen. Further, in some embodiments, at least some of the display screens shown in the various figures described herein can be included in one or more target date investment reports for review by one or more clients. As shown, the system 5430 can include at least one computing device, including at least one processor 5432. Some processors can include processors 5432 residing in one or more conventional server platforms. The system 5400 can include a network interface 5435a and an application interface 5435b coupled to at least one processors 5432 capable of running at least one operating system 5434. Further, the system 5400 can include a network interface 5435a and an application interface 5435b coupled to at least one processors 5432 capable of running one or more of the software modules 5438 (e.g., such as enterprise applications). In some embodiments, the software modules 5438 can include server-based software platform that can include target date analyzer software modules suitable for hosting at least one user account and at least one client account, as well as transferring data between one or more accounts, at least one user display of a user device, and/or at least one database 180. In some embodiments, the database 180 can reside on or comprise a third-party server separate from but coupled to the user device and the system 5400 using a conventional wired or wireless network.

Some embodiments of the invention also relate to a device or an apparatus for performing these operations. The apparatus can be specially constructed for the required purpose, such as a special purpose computer. When defined as a special purpose computer, the computer can also perform other processing, program execution or routines that are not part of the special purpose, while still being capable of operating for the special purpose. Alternatively, the operations can be processed by a general purpose computer selectively activated or configured by one or more computer programs stored in the computer memory, cache, or obtained over a network. When data are obtained over a network the data can be processed by other computers on the network, e.g. a cloud of computing resources.

With the above embodiments in mind, it should be understood that the invention can employ various computer-implemented operations involving target date analyzer data stored in computer systems. Moreover, the above-described databases and models throughout the target date analyzer can store analytical models and other data on computer-readable storage media within the system 5400 and on computer-readable storage media coupled to the system 5400. In addition, the above-described applications of the target date analyzer server system can be stored on computer-readable storage media within the system 5400 and on computer-readable storage media coupled to the system 5400. These operations are those requiring physical manipulation of physical quantities. Usually, though not necessarily, these quantities take the form of electrical, electromagnetic, or magnetic signals, optical or magneto-optical form capable of being stored, transferred, combined, compared and otherwise manipulated.

Some embodiments include the system 5400 comprising at least one computer readable medium 5436 coupled to at least one data storage device 5437b, and/or at least one data source 5437a, and/or at least one input/output device 5437c. In some embodiments, the invention embodied by the target date analyzer server system can also be embodied as computer readable code on a computer readable medium 5436. The computer readable medium 5436 can be any data storage device that can store data, which can thereafter be read by a computer system (such as the system 5400). Examples of the computer readable medium 5436 can include hard drives, network attached storage (NAS), read-only memory, random-access memory, FLASH based memory, CD-ROMs, CD-Rs, CD-RWs, DVDs, magnetic tapes, other optical and non-optical data storage devices, or any other physical or material medium which can be used to tangibly store the desired information or data or instructions and which can be accessed by a computer or processor (including processors 5432).

In some embodiments of the invention, the computer readable medium 5436 can also be distributed over a conventional computer network via the network interface 5435a so that the target date analyzer server system embodied by the computer readable code can be stored and executed in a distributed fashion. For example, in some embodiments, one or more components of the system 5400 can be tethered to send and/or receive data through a local area network (“LAN”) 5439a. In some further embodiments, one or more components of the system 5400 can be tethered to send or receive data through an internet 5439b (e.g., a wireless internet). In some embodiments, at least one software application 5438 running on one or more processors 5432 can be configured to be coupled for communication over a network 5439a, 5439b. In some embodiments, one or more components of the network 5439a, 5439b can include one or more resources for data storage, including any other form of computer readable media beyond the media 5436 for storing information and including any form of computer readable media for communicating information from one electronic device to another electronic device.

In some embodiments, the network 5439a, 5439b can include wide area networks (“WAN”), direct connections (e.g., through a universal serial bus port) or other forms of computer-readable media 5436, or any combination thereof. Further, in some embodiments, one or more components of the network 5439a, 5439b can include a number of user devices which can be any number of local or consumer devices including one or more computers and/or displays 5440. In some embodiments, the computers and/or displays 5440 can be desktop computers 5440d, laptop computers 5440a, 5440e, digital assistants and/or personal digital assistants (shown as 5440c), cellular phones or mobile phones or smart phones (shown as 5440b), pagers, digital tablets, internet appliances, and other processor-based devices. In general, the user device can be any type of external or internal devices such as a mouse, a CD-ROM, DVD, a keyboard, a display, or other input or output devices 5437c. In some embodiments, various other forms of computer-readable media 5436 can transmit or carry instructions to a computer 5440, including a router, private or public network, or other transmission device or channel, both wired and wireless. The software modules 5438 can be configured to send and receive data from a database (e.g., from a computer readable medium 5436 including data sources 5437a and data storage 5437b that can comprise a database), and data can be received by the software modules 5438 from at least one other source. In some embodiments, at least one of the software modules 5438 can be configured within the system to output data to a user 5431 via at least one digital display (e.g., to a computer 5440 comprising a digital display).

In some embodiments, the system 5400 as described can enable one or more users 5431 to receive, analyze, input, modify, create and send data to and from the system 5400, including to and from one or more enterprise applications 5438 running on the system 5400. Some embodiments include at least one user 5431 coupled to a computer 5440 accessing one or more modules of the target date analyzer server system including at least one enterprise applications 5438 via a stationary I/O device 5437c through a LAN 5439a. In some other embodiments, the system 5400 can enable at least one user 5431 (through computer 5440) accessing enterprise applications 5438 via a stationary or mobile I/O device 5437c through an internet 5439a.

Any of the operations described herein that form part of the invention are useful machine operations. The invention also relates to a device or an apparatus for performing these operations. The apparatus can be specially constructed for the required purpose, such as a special purpose computer. When defined as a special purpose computer, the computer can also perform other processing, program execution or routines that are not part of the special purpose, while still being capable of operating for the special purpose. Alternatively, the operations can be processed by a general purpose computer selectively activated or configured by one or more computer programs stored in the computer memory, cache, or obtained over a network. When data is obtained over a network the data can be processed by other computers on the network, e.g. a cloud of computing resources.

The embodiments of the present invention can also be defined as a machine that transforms data from one state to another state. The data can represent an article, that can be represented as an electronic signal and electronically manipulate data. The transformed data can, in some cases, be visually depicted on a display, representing the physical object that results from the transformation of data. The transformed data can be saved to storage generally, or in particular formats that enable the construction or depiction of a physical and tangible object. In some embodiments, the manipulation can be performed by a processor. In such an example, the processor thus transforms the data from one thing to another. Still further, the methods can be processed by one or more machines or processors that can be connected over a network. Each machine can transform data from one state or thing to another, and can also process data, save data to storage, transmit data over a network, display the result, or communicate the result to another machine. Computer-readable storage media, as used herein, refers to physical or tangible storage (as opposed to signals) and includes without limitation volatile and non-volatile, removable and non-removable storage media implemented in any method or technology for the tangible storage of information such as computer-readable instructions, data structures, program modules or other data.

Although method operations can be described in a specific order, it should be understood that other housekeeping operations can be performed in between operations, or operations can be adjusted so that they occur at slightly different times, or can be distributed in a system which allows the occurrence of the processing operations at various intervals associated with the processing, as long as the processing of the overlay operations are performed in the desired way.

It will be appreciated by those skilled in the art that while the invention has been described above in connection with particular embodiments and examples, the invention is not necessarily so limited, and that numerous other embodiments, examples, uses, modifications and departures from the embodiments, examples and uses are intended to be encompassed by the claims attached hereto. The entire disclosure of each patent and publication cited herein is incorporated by reference, as if each such patent or publication were individually incorporated by reference herein. Various features and advantages of the invention are set forth in the following claims.

1. An investment plan analysis server system comprising:
a computing device comprising at least one processor;
a non-transitory computer readable medium, having stored thereon, instructions that when executed by the computing device, cause the computing device to perform at least some operations within a local or consumer device, the operations comprising at least:
associating the local or consumer device with a provider device;
execution of a browser program to deliver personalized content within a website rendered on the local or consumer device, the personalized content comprising at least one investment comparison derived at least in part from information from the provider device for use in the investment plan;
receiving at least a first selection input from a user through the local or consumer device;
enabling a first retrieval of at least a portion of a first plurality of information using at least one of a wireless communication interface and a wired communication interface, the first plurality of information comprising at least one of a client's asset range and participant profile, participant demographics, participant's average savings balance, tolerance for risk, manager diversification, and active or passive investment preference; and
creating the personalized content by processing at least a portion of the first plurality of information by a processor to form a target date profile, wherein at least a portion of the target date profile is displayed as the personalized content on the local or consumer device;
receiving at least a second selection input from a user through the local or consumer device;
based at least in part on the second selection, enabling a second retrieval of at least a portion of a second plurality of information using at least one of a wireless communication interface and a wired communication interface, the second plurality of information comprising at least one of a retirement glide path type, retirement glide path risk, manager diversification, fund performance, investment vehicle type, share class or investment return rate, active or passive investment preference, investment product history, investment product vintage; and
causing a target date analysis server to perform a target date analysis by processing of at least a portion of the second plurality of information by a processor;
causing the target date analysis server to process and calculate a third plurality of information by at least in part retrieving financial data from a remote server system based at least in part on at least a portion of the second plurality of information; and
displaying the personalized content by processing at least a portion of the third plurality of information by a processor based at least in part on a user's interaction with the website through the local or consumer device.

2. The server system of claim 1, wherein at least a portion of the second plurality of information includes the first plurality of information.

3. The server system of claim 1, wherein the personalized content includes at least one investment or investment plan structured or defined by a specified target date.

4. The server system of claim 1, wherein the displayed personalized content includes a display including at least one user-selectable or user-removeable investment option.

5. The server system of claim 4, wherein the at least one user-selectable investment option includes at least one investment or investment plan structured or defined by a specified retirement target date.

6. The server system of claim 1, wherein at least a portion of the second plurality of information comprises at least one plan name, the at least one plan name configured and arranged to be defined or selected as a favorite plan.

7. The server system of claim 6, the at least one plan name or favorite plan is displayed or selectable from a user dashboard.

8. The server system of claim 1, wherein the user's interaction comprises selection of a report option, and the personalized content is configured and displayed as a report including at least one asset comparison analysis, the at least one asset comparison analysis comprising at least one of a data chart and a data table.

9. The server system of claim 1, wherein the personalized content includes data displayed as a retirement glide path.

10. The server system of claim 9, wherein the retirement glide path comprises an equity to fixed-income investment glide path.

11. The server system of claim 1, wherein the personalized content comprises at least one asset comparison analysis, the at least one asset comparison analysis comprising at least one of a data chart and a data table.

12. The server system of claim 11, wherein the at least one asset comparison analysis comprises an asset return and risk analysis as a function of time period, the time period extending to at least one of a three year or a five year period.

13. The server system of claim 11, wherein the at least one asset comparison analysis comprises a standard deviation risk analysis as a function of time period, the time period extending to at least one of a three year or a five year period.

14. The server system of claim 11, wherein the at least one asset comparison analysis comprises a Sharpe Ratio risk analysis as a function of time period, the time period extending to at least one of a three year or a five year period.

15. The server system of claim 11, wherein the at least one asset comparison analysis comprises a total risk to percentage equity analysis.

16. The server system of claim 11, wherein the at least one asset comparison comprises an up/down capture of investment return.

17. The server system of claim 11, wherein the at least one asset comparison comprises a performance summary of at least one investment vehicle.

18. The server system of claim 11, wherein the at least one asset comparison comprises at least one of a summary of underlying investments of at least one investment vehicle and a display of the top ten holdings of at least one investment vehicle.

19. The server system of claim 11, wherein the at least one asset comparison analysis comprises data from the remote server system comparing at least two different investment vehicles.

20. The server system of claim 11, wherein the at least one asset comparison analysis comprises data from the remote server system comprises investment vehicles from at least two different providers.
